(19) United States
(12) Patent Application Publication
(10) Pub. No.: US 2026/0062305 A1
(43) Pub. Date: Mar. 5, 2026

(54) LITHIUM PRODUCTION COUPLED TO ACID AND BASE PRODUCTION

(71) Applicant: Eleryc, Inc., Campbell, CA (US)

(72) Inventors: Ian Robinson, San Jose, CA (US); David Koshy, San Mateo, CA (US); Sahag Voskian, Cambridge, MA (US)

(73) Assignee: Eleryc, Inc., Campbell, CA (US)

(21) Appl. No.: 19/310,378

(22) Filed: Aug. 26, 2025

Related U.S. Application Data
(60) Provisional application No. 63/687,669, filed on Aug. 27, 2024.

(51) Int. Cl. C01D 15/08; C01D 15/02; C25B 1/16; H01M 10/54

(52) U.S. Cl. CPC C01D 15/08; C01D 15/02; C25B 1/16; H01M 10/54

(57) ABSTRACT

Systems and methods for obtaining lithium-containing materials from liquid streams are generally described. In some instances, aqueous streams are treated with a lithium selective agent prior to and/or following electrolysis of the stream to produce basic species such as hydroxide ions. In some cases, the lithium selective agent is a solids-forming agent such as a precipitant (e.g., phosphoric acid/phosphate) or a solid sorbent (e.g., aluminum hydroxide). The electrogenerated basic species may induce carbon dioxide capture to form carbonate and/or bicarbonate anions. Coupling of the electrolytic processes and/or carbon dioxide capture processes to the lithium selective separation processes may promote efficient generation of value-added lithium-containing materials such as lithium hydroxide and/or lithium carbonate. Some embodiments involve the electrolytic and/or thermal regeneration of the lithium selective agent, and/or the recycling of electrogenerated acidic species, which can also contribute to an efficient, cost-effective system for obtaining lithium-containing materials.

### RELATED APPLICATIONS

This application claims priority under 35 U.S.C. § 119(e) to U.S. Provisional Patent Application No. 63/687,669, filed Aug. 27, 2024, and entitled “Lithium Production Coupled to Acid and Base Production,” which is incorporated herein by reference in its entirety for all purposes.

### TECHNICAL FIELD

Systems and methods for obtaining lithium-containing materials from liquid streams are generally described.

### BACKGROUND

Lithium is present in numerous sources. It can be desirable to obtain lithium-containing materials from these sources, in some instances. Accordingly, improved methods and systems for obtaining lithium-containing materials are desirable.

### SUMMARY

Systems and methods for obtaining lithium-containing materials from liquid streams are generally described. The subject matter of the present invention involves, in some cases, interrelated products, alternative solutions to a particular problem, and/or a plurality of different uses of one or more systems and/or articles.

In one aspect, methods for obtaining a lithium-containing material are provided. In some embodiments, the method comprises exposing at least some lithium cations from an aqueous lithium source stream to a lithium selective agent to generate a lithium-enrichment output comprising a lithium-rich phase comprising at least some of the lithium cations, wherein the aqueous lithium source stream comprises dissolved lithium cations, dissolved non-lithium metal cations, and dissolved anions; removing at least some of the lithium-rich phase from the lithium-enrichment output to produce a lithium depleted stream; transporting an aqueous electrolysis input stream to an electrolytic cell, the aqueous electrolysis input stream comprising at least some of the dissolved non-lithium metal cations and at least some of the dissolved anions from the aqueous lithium source stream; applying an electrical potential difference across the electrolytic cell and performing one or more reactions to produce: a base-rich product solution comprising electrogenerated basic species and at least some of the non-lithium metal cations; and an acid-rich product solution comprising electrogenerated acidic species and at least some of the anions; and exposing at least some of the electrogenerated basic species from the base-rich product solution to carbon dioxide from an input gas stream to generate: a carbon dioxide-lean output gas stream having a lower concentration of carbon dioxide than the input gas stream; and a capture stream comprising: at least some of the non-lithium metal cations, and dissolved carbonate anions and/or dissolved bicarbonate anions formed from the dissolved carbon dioxide.

In some embodiments, the method comprises exposing at least some lithium ions from an aqueous lithium source stream to a lithium selective agent to generate a lithium-enrichment output comprising a lithium-rich phase comprising at least some of the lithium cations, wherein the aqueous lithium source stream comprises dissolved lithium cations, dissolved non-lithium metal cations, and dissolved anions; removing at least some of the lithium-rich phase from the lithium-enrichment output to produce a lithium depleted stream; performing one or more reactions with the removed lithium-rich phase to produce (a) dissolved lithium cations and (b) regenerated lithium selective agent, wherein at least some of the lithium selective agent used to generate the lithium-enrichment stream is regenerated lithium selective agent.

In some embodiments, the method comprises transporting an aqueous electrolysis input stream to an electrolytic cell, the aqueous electrolysis input stream comprising at least a portion of an aqueous lithium source stream comprising lithium cations and non-hydroxide anions; and applying an electrical potential difference across the electrolytic cell and performing one or more reactions to produce: a base-rich product solution comprising electrogenerated basic species and at least some of the lithium metal cations from the aqueous lithium source stream; and an acid-rich product solution produced by a hydrogen oxidation half-reaction, the acid-rich product solution comprising electrogenerated acidic species and at least some of the non-hydroxide anions from the aqueous lithium source stream.

In another aspect, systems for obtaining a lithium-containing material are provided. In some embodiments, the system comprises an electrolytic cell comprising an anode and a cathode; one or more electrolysis assembly liquid inlets configured to supply dissolved ions to the anode and/or the cathode; a first electrolysis assembly liquid outlet; and a second electrolysis assembly liquid outlet; wherein: the anode comprises a hydrogen depolarization anode; and the one or more electrolysis assembly liquid inlets is fluidically connected to a source of an aqueous lithium source stream.

In some embodiments, a system configured to perform a method as described in this disclosure is described. Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows a schematic diagram of an example of a system for obtaining a lithium-containing material, according to some embodiments;

FIG. 1B shows a schematic diagram of an example of a system for obtaining a lithium-containing material involving first and second electrolytic cells, according to some embodiments:

FIG. 1C shows a schematic diagram of an example of a system for obtaining a lithium-containing material involving first and second electrolytic cells and a second gas-liquid contact vessel for generating lithium carbonate, according to some embodiments;

FIG. 1D shows a schematic diagram of an example of a system for obtaining a lithium-containing material involving first and second electrolytic cells and a second gas-liquid contact vessel for generating lithium carbonate, as well as a metal cation impurity precipitation stream, according to some embodiments;

FIG. 2A shows a schematic cross-sectional diagram of an electrolytic cell in which an aqueous electrolysis input stream is transported to a catholyte chamber, according to some embodiments;

FIG. 2B shows a schematic cross-sectional diagram of an electrolytic cell in which an aqueous electrolysis input stream is transported to an anolyte chamber, according to some embodiments;

FIG. 2C shows a schematic cross-sectional diagram of an electrolytic cell in which an aqueous electrolysis input stream is transported to an electrolyte chamber, according to some embodiments;

FIG. 2D shows a schematic cross-sectional diagram of an electrolytic cell configured as an electrodialysis cell and comprising a bipolar membrane, according to some embodiments;

FIG. 2E shows a schematic cross-sectional diagram of an electrolytic cell configured as an electrodialysis cell and comprising a bipolar membrane, according to some embodiments;

FIGS. 3A-3B shows schematic diagrams of examples of systems for obtaining a lithium-containing material employing phosphoric acid as a lithium selective agent, according to some embodiments;

FIGS. 4A-4B shows schematic diagrams of examples of systems for obtaining a lithium-containing material employing phosphoric acid as a lithium selective agent. where the product collected is lithium dihydrogen phosphate (FIG. 4A) or tri-lithium phosphate (FIG. 4B), according to some embodiments;

FIG. 5 shows a schematic diagram of an example of a system for obtaining a lithium-containing material employing phosphoric acid as a lithium selective agent, where the product collected is lithium carbonate, according to some embodiments;

FIG. 6 shows a schematic diagram of an example of a system for obtaining a lithium-containing material employing dissolved alkali orthophosphate as a lithium selective agent, according to some embodiments;

FIG. 7 shows a schematic diagram of an example of a system for obtaining a lithium-containing material employing dissolved alkali orthophosphate as a lithium selective agent, according to some embodiments;

FIGS. 8A-8B show schematic diagrams of examples of systems for obtaining a lithium-containing material employing thermally regenerated phosphoric acid as a lithium selective agent, according to some embodiments;

FIG. 9 shows a schematic diagram of an example of a non-electrochemical system for obtaining a lithium-containing material employing thermally regenerated phosphoric acid as a lithium selective agent, according to some embodiments;

FIG. 10 shows a schematic diagram of an example of system for obtaining a lithium-containing material employing an organic liquid as a lithium selective agent. according to some embodiments;

FIG. 11 shows a schematic diagram of an example of system for obtaining a lithium-containing material employing aluminum hydroxide as a solid sorbent lithium selective agent, according to some embodiments;

FIG. 12 shows a schematic diagram of an example of system for obtaining a lithium-containing material employing aluminum hydroxide as a solid sorbent lithium selective agent, according to some embodiments;

FIG. 13 shows a schematic diagram of an example of system for obtaining a lithium-containing material employing aluminum hydroxide as a solid sorbent lithium selective agent, according to some embodiments;

FIG. 14A shows a schematic diagram of an example of system for obtaining a lithium-containing material comprising an electrolytic cell that receives an aqueous electrolysis input stream comprising lithium cations and non-hydroxide anions from an aqueous lithium source stream, according to some embodiments;

FIG. 14B shows a schematic diagram of an example of system for obtaining a lithium-containing material comprising an electrolytic cell that receives an aqueous electrolysis input stream comprising lithium cations and non-hydroxide anions from an aqueous lithium source stream, according to some embodiments; and

FIG. 15 shows a schematic diagram of an example of system for obtaining a lithium-containing material comprising an electrolytic cell that receives an aqueous electrolysis source stream comprising lithium cations from a lithium source stream generated by dissolving a solid lithium salt comprising lithium cations and non-hydroxide anions, according to some embodiments.

### DETAILED DESCRIPTION

Systems and methods for obtaining lithium-containing materials from liquid streams are generally described. In some instances, aqueous streams are treated with a lithium selective agent prior to and/or following electrolysis of the stream to produce basic species such as hydroxide ions. In some cases, the lithium selective agent is a solids-forming agent such as a precipitant (e.g., phosphoric acid/phosphate) or a solid sorbent (e.g., aluminum hydroxide). The electrogenerated basic species may induce carbon dioxide capture to form carbonate and/or bicarbonate anions. Coupling of the electrolytic processes and/or carbon dioxide capture processes to the lithium selective separation processes may promote efficient generation of value-added lithium-containing materials such as lithium hydroxide and/or lithium carbonate. Some embodiments involve the electrolytic and/or thermal regeneration of the lithium selective agent, and/or the recycling of electrogenerated acidic species, which can also contribute to an efficient, cost-effective system for obtaining lithium-containing materials.

Lithium extraction from liquid sources (e.g., dilute brines) and/or solid sources (e.g., in minerals such as hard rock) using certain existing technologies can be inefficient and resource-intensive. For example, some techniques involve the frequent or even continuous input of fresh commodity chemicals. As one specific example, some techniques involve the input of fresh base (e.g., for generating lithium hydroxide and/or removing other cations such as alkaline earth metals from brines). As another example, some techniques involve the input of fresh acid (e.g., for selective precipitation of lithium solid salts and/or leaching lithium salts from lithium solids such as lithium oxide). It has been found in the context of this disclosure that the use of lithium selective agents (e.g., precipitants, solid sorbents, and/or organic extractants), certain electrolyzer technologies (e.g., base and/or acid-producing electrolyzers), and/or certain process configurations can address these potential fallbacks in existing technologies. Moreover, it has been found that the lithium selective agents and/or electrolyzer systems described in this disclosure can be coupled to certain recirculation (e.g., acid recirculation), regeneration (e.g., lithium selective agent regeneration), and/or carbon capture techniques to efficiently obtain lithium-containing materials (e.g., lithium hydroxide and/or lithium carbonate) while, in some instances reducing or avoiding the need for significant commodity chemical (e.g., acid and/or base) inputs and/or extra intermediate steps (e.g., as in the case with certain technologies such as chloralkali processes and/or Solvay processes).

Aspects of this disclosure are directed to systems and methods for obtaining a lithium-containing material. The lithium-containing material may comprise lithium ions in a liquid form (e.g., as dissolved lithium cations) and/or in a solid form (e.g., as a solid lithium-containing salt such as solid lithium hydroxide and/or solid lithium carbonate). The system may be configured to obtain the lithium-containing material at least in part by exposing lithium cations from an aqueous lithium source stream to a lithium selective agent. The aqueous lithium source stream may be exposed to the lithium selective agent directly, or the lithium ions from the aqueous lithium stream may be transferred to one or more intermediate streams prior to their exposure to the lithium selective agent (e.g., involving one or more electrolysis steps), as discussed in more detail below. The lithium selective agent may, upon exposure to the lithium cations, induce generation of a lithium-enrichment output comprising a lithium-rich phase (e.g, a lithium-containing precipitate, lithium-adsorbed solid sorbent, lithium-rich extract stream), which may then be removed to form a lithium depleted stream. Additionally or alternatively, some embodiments involve inclusion of the lithium cations in an aqueous electrolysis input stream, where electrolysis may produce a base-rich product solution comprising at least some of the lithium cations. In some instances, the lithium-rich phase and/or the lithium-containing base-rich product solution comprise or are further treated to comprise the lithium-containing material (e.g., lithium hydroxide and/or lithium carbonate).

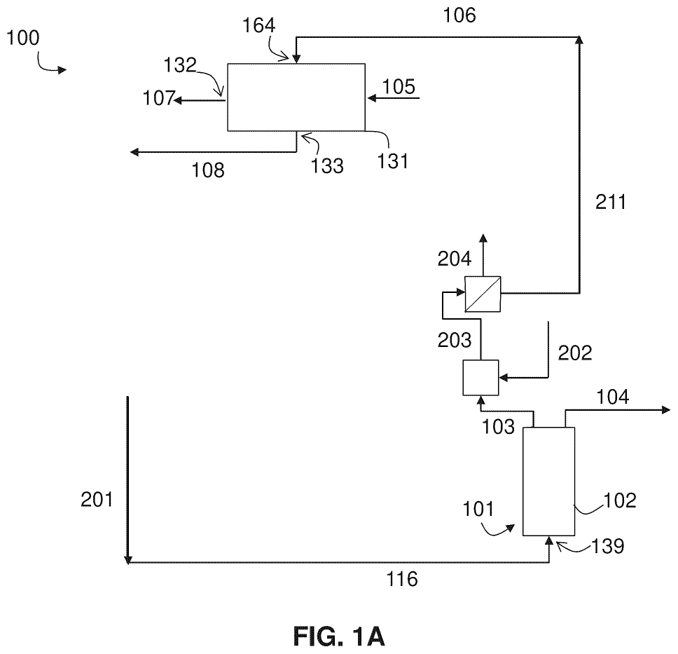

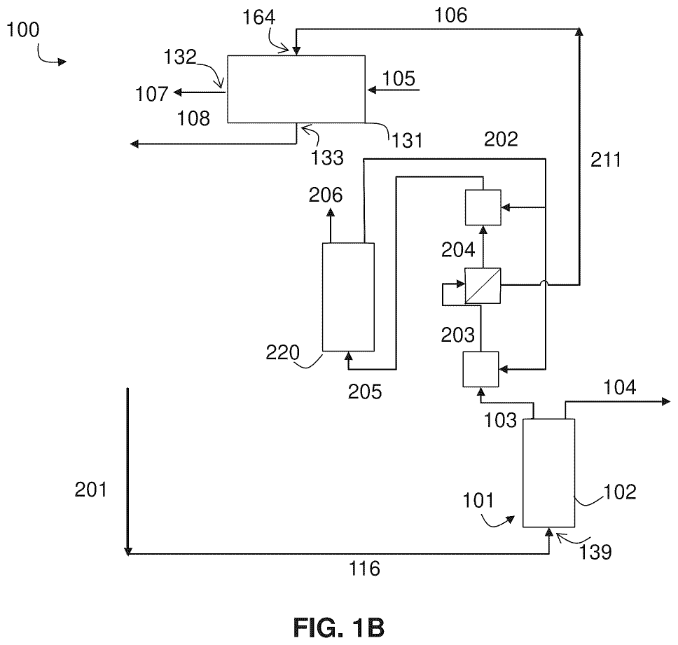

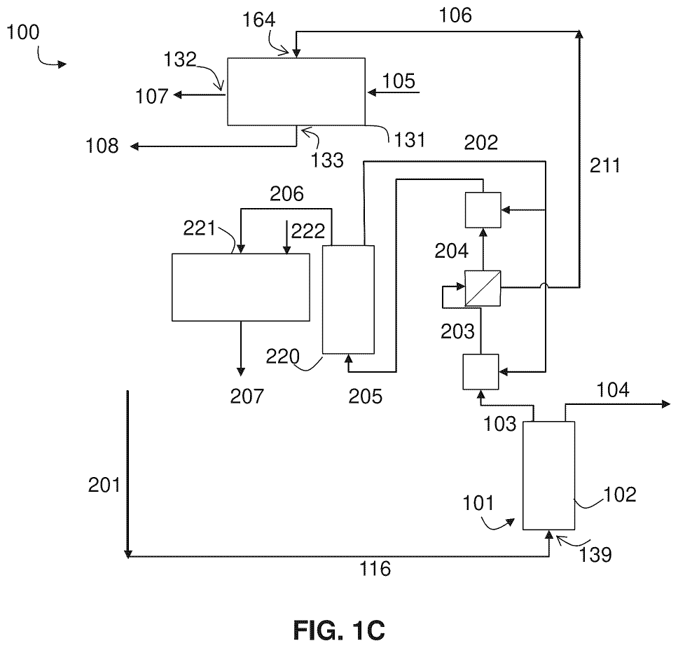

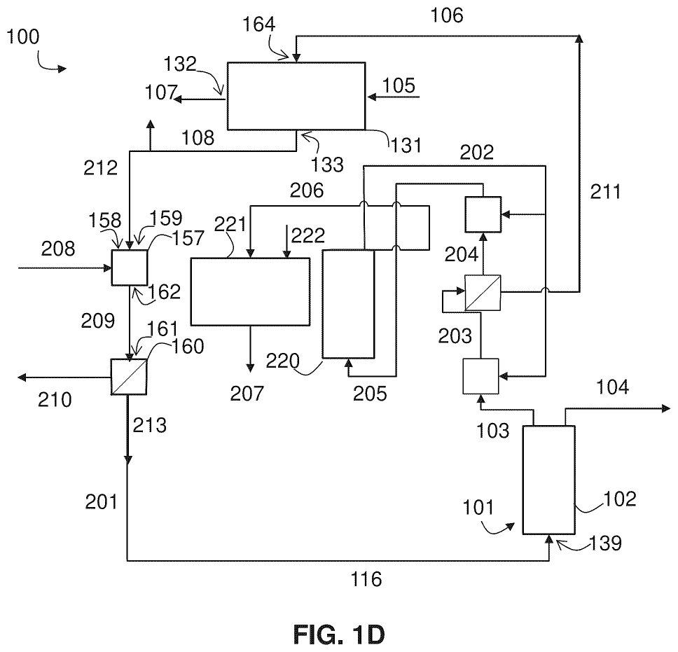

As non-limiting examples, FIGS. 1A-1D show schematic diagrams of various embodiments of system 100. System 100 comprises electrolysis assembly 101 configured to receive aqueous electrolysis input stream 116 (e.g., via one or more inlets), which comprises at least a portion of aqueous lithium source stream 201. Electrolysis assembly 101 may be fluidically connected (e.g., directly or indirectly) to gas-liquid contact vessel 131 configured to receive input gas stream 105 (e.g., a carbon dioxide-containing gas stream). Further, stream 103 comprising base-rich product solution comprising at least some of the lithium cations may be exposed to lithium selective agent in stream 202. Details of the components, connectivity, operation, and related chemistries of various embodiments are described in more detail below.

As noted above, in some embodiments, an aqueous lithium source stream is treated. The aqueous lithium source stream may be or be derived from any of a variety of streams, such as, but not limited to a brine (e.g., a natural brine, a geothermal brine, an oil-field brine), wastewater (e.g., industrial wastewater, oil-field wastewater), streams for recycling materials (e.g., battery material recycling streams), mining effluent, groundwater, sewage, seawater, acidulated/digested minerals, salt flats, and/or industrial process streams. For example, the methods of this disclosure may be employed to obtain value-added lithium materials (e.g., lithium hydroxide and/or lithium carbonate) in liquid and/or solid form from brines, such as dilute brines. As another example, the methods of this disclosure may be employed to obtain value-added lithium materials (e.g., lithium hydroxide and/or lithium carbonate) in liquid and/or solid form from dissolved lithium in solutions from processed lithium-containing minerals (e.g., hard rock). As a specific example, the lithium-containing mineral (e.g., hard rock) may be processed (e.g., via a high-temperature sulfuric acid roast) to produce a solid lithium-containing material (e.g., lithium sulfate). The solid lithium-containing material (e.g., lithium sulfate) may then be dissolved in an aqueous solution to form the aqueous lithium source stream (or a preliminary aqueous lithium source stream for further treatment such as for metal cation impurity removal in some instances where metal cation impurities are present).

The aqueous lithium source stream may comprise liquid water in an amount of greater than or equal to 40 weight percent (wt %), greater than or equal to 50 wt %, greater than or equal to 75 wt %, greater than or equal to 90 wt %, greater than or equal to 95 wt %, greater than or equal to 98 wt %, greater than or equal to 99 wt %, greater than or equal to 99.9 wt %, or more by weight of liquid in the aqueous lithium source stream.

The aqueous lithium source stream may include one or more dissolved lithium-containing salts. When a salt is dissolved, its constituents (e.g., a cation and an anion) may each be solvated (e.g., by solvent molecules such as water molecules) such that the constituents are no longer ionically bonded to each other. Accordingly, when referring to a dissolved or aqueous salt, the reference corresponds to the collection of dissolved constituents.

In some embodiments, the aqueous lithium source stream comprises dissolved cations. Any of a variety of cations may be present. The cations may comprise monovalent cations (carrying a single positive charge). In some embodiments, the cations comprise metal cations. For example, the metal cations may comprises alkali metal ions. In some embodiments, the aqueous lithium source stream comprises dissolved lithium cations and dissolved non-lithium cations. In some embodiments, the dissolved non-lithium cations comprise non-lithium metal cations. As one example, the metal cations may comprise lithium (Li⁺) ions and also comprise sodium ions (Na⁺), and/or potassium ions (K⁺). In some embodiments, the cations comprise ammonium cations (e.g., NH₄⁺ or a derivative thereof such as an alkylammonium). In some, but not necessarily all embodiments, the cations comprise divalent cations such as alkaline earth metal cations (e.g., magnesium cations, calcium cations, strontium cations, barium cations). In some embodiments, the metal cations comprise spectator ions with respect to the chemistries employed in the method, such as by the electrolysis assembly and/or other reactions performed in the methods and systems of this disclosure.

In some embodiments, at least 0.0005 mol %, at least 0.001 mol %, at least 0.01 mol %, at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol %, at least 99.9 mol %, at least 99.99 mol %) or all of the cations in the aqueous lithium source stream are lithium ions.

In some embodiments, some (e.g., at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol % at least 99.9 mol %,) or all of the cations in the aqueous lithium source stream are alkali metal ions.

In some embodiments, some (e.g., at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol % at least 99.9 mol %,) or all of the non-lithium metal cations in the aqueous lithium source stream are non-lithium alkali metal cations.

In some embodiments, some (e.g., at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol % at least 99.9 mol %,) or all of the cations in the aqueous lithium source stream are lithium ions, sodium ions, and/or potassium ions.

In some embodiments, some (e.g., at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol % at least 99.9 mol %,) or all of the non-lithium metal cations in the aqueous lithium source stream are sodium ions and/or potassium ions.

In some embodiments, some (e.g., at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol % at least 99.9 mol %,) or all of the non-lithium metal cations in the aqueous lithium source stream are sodium ions.

In some embodiments, some (e.g., at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol % at least 99.9 mol %,) or all of the non-lithium metal cations in the aqueous lithium source stream are potassium ions.

In some embodiments, some (e.g., at least 0.1 mol %, at least 0.2 mol %, at least 0.3 mol %, at least 1 mol %, at least 2 mol %, at least 5 mol % at least 10 mol %, at least 25 mol %, at least 50 mol %, at least 75 mol %, at least 95 mol %, at least 98 mol %, at least 99 mol %, at least 99.9 mol %) or all of the non-lithium metal cations in the aqueous lithium source stream are alkaline earth metal cations.

In some embodiments, some (e.g., at least 0.1 mol %, at least 0.2 mol %, at least 0.3 mol %, at least 1 mol %, at least 2 mol %, at least 5 mol % at least 10 mol %, at least 25 mol %, at least 50 mol %, at least 75 mol %, at least 95 mol %, at least 98 mol %, at least 99 mol %, at least 99.9 mol %) or all of the non-lithium metal cations in the aqueous lithium source stream are magnesium cations (Mg²⁺), calcium cations (Ca²⁺), strontium cations (Sr²⁺), and/or barium cations (Ba²⁺).

In some embodiments, some (e.g., at least 0.1 mol %, at least 0.2 mol %, at least 0.3 mol %, at least I mol %, at least 2 mol %, at least 5 mol % at least 10 mol %, at least 25 mol %, at least 50 mol %, at least 75 mol %, at least 95 mol %, at least 98 mol %, at least 99 mol %, at least 99.9 mol %) or all of the non-lithium metal cations in the aqueous lithium source stream are magnesium cations (Mg²⁺) and/calcium cations (Ca²⁺).

In some embodiments, some (e.g., at least 0.1 mol %, at least 0.2 mol %, at least 0.3 mol %, at least 1 mol %, at least 2 mol %, at least 5 mol % at least 10 mol %, at least 25 mol %, at least 50 mol %, at least 75 mol %, at least 95 mol %, at least 98 mol %, at least 99 mol %, at least 99.9 mol %) or all of the non-lithium metal cations in the aqueous lithium source stream are magnesium cations (Mg²⁺).

In some embodiments, some (e.g., at least 0.1 mol %, at least 0.2 mol %, at least 0.3 mol %, at least 1 mol %, at least 2 mol %, at least 5 mol % at least 10 mol %, at least 25 mol %, at least 50 mol %, at least 75 mol %, at least 95 mol %, at least 98 mol %, at least 99 mol %, at least 99.9 molf %) or all of the non-lithium metal cations in the aqueous lithium source stream are calcium cations (Ca²⁺).

As noted above, the lithium cations may be present in the aqueous lithium source stream at a relatively high concentration. In some embodiments, the dissolved lithium cations are present in the aqueous lithium source stream at a concentration of greater than or equal to 0.00002, greater than or equal to 0.00005, greater than or equal to 0.0001 moles per liter (M), greater than or equal to 0.001 M, greater than or equal to 0.01 M, greater than or equal to 0.1 M, greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 7 M, up to 8 M, up to 10 M, up to 20 M, or greater. Combinations of these ranges (e.g., greater than or equal to 0.1 M and up to 20 M, greater than or equal to 0.1 M and up to 8 M, greater than or equal to 0.1 M and up to 6 M, greater than or equal to 1 M and up to 6 M) are possible.

In some embodiments, the non-lithium metal cations may be present in the aqueous lithium source stream at a relatively high concentration. In some embodiments, the dissolved non-lithium metal cations are present in the aqueous lithium source stream at a concentration of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 7 M, up to 8 M, up to 10 M, up to 20 M, or greater. Combinations of these ranges (e.g., greater than or equal to 0.1 M and up to 20 M, greater than or equal to 0.1 M and up to 8 M, greater than or equal to 0.1 M and up to 6 M, greater than or equal to 1 M and up to 6 M) are possible.

In some embodiments, the aqueous lithium source stream comprises dissolved anions. Any of a variety of anions may be present. In some embodiments, at least some of the anions are non-hydroxide anions. The anions may comprise monovalent anions (carrying a single negative charge). For example, the anions may comprise halide ions. As a more specific example, the anions may comprise chloride ions (Cl⁻), bromide ions (Br⁻), and/or iodide ions (I⁻). Other examples of monovalent anions include, but are not limited to, nitrates, nitrites, perchlorates, and hydrogen sulfate anions (HSO⁴⁻). In some embodiments, the anions comprise oxyanions. In some embodiments, the anions comprise divalent ions (carrying a charge of −2). For example, the anions may comprise sulfate ions (SO₄²⁻). In some embodiments, the anions comprise trivalent anions (carrying a charge of −3), such as orthophosphate anions (PO₄³⁻). In some embodiments, the anions comprise phosphate ions (e.g., orthophosphate ions (PO₄³⁻), monohydrogen phosphate ions (HPO₄²⁻), and/or dihydrogen phosphate ions (H₂PO₄)). In some embodiments, the anions comprise borate ions (e.g., orthoborate ions (BO₃³⁻), tetrahydroxyborates (B(OH)₄⁻), tetraborates (B₄O₇²⁻), and/or polyborates). In some embodiments, the anions include the conjugate base of an organic acid (e.g., a carboxylate-containing organic compound). Examples of conjugate bases of organic acids include, but are not limited to, formate, acetate, lactate, oxalate, and/or citrate. Another example of an organic acid is benzoic acid. In some embodiments, the anions referenced here do not include carbonate ions and/or bicarbonate ions (though one or both of carbonate anions and bicarbonate anions may also be present in the aqueous lithium source stream in some embodiments). In some embodiments, the anions are conjugate bases of strong acids. However, in some embodiments, the anions are conjugate bases of weak acids. In some embodiments, the anions are spectator ions with respect to the chemistries employed by the electrolysis assembly and/or other reactions performed in the methods and systems of this disclosure.

In some embodiments, some (e.g., at least 1 mole percent (mol %), at least 10 mol %, at least 20 mol %, at least 50 mol %, at least 75 mol %, at least 95 mol %, at least 98 mol %, at least 99 mol %) or all of the anions in the aqueous lithium source stream are chloride ions.

In some embodiments, some (e.g., at least 1 mol %, at least 10 mol %, at least 20 mol %, at least 50 mol %, at least 75 mol %, at least 95 mol %, at least 98 mol %, at least 99 mol %) or all of the anions in the aqueous lithium source stream are phosphate ions (e.g., monohydrogen phosphate ions, dihydrogen phosphate ions, and/or dihydrogen phosphate ions).

In some embodiments, some (e.g., at least 1 mole percent (mol %), at least 10 mol %, at least 20 mol %, at least 50 mol %, at least 75 mol %, at least 95 mol %, at least 98 mol %, at least 99 mol %) or all of the anions in the aqueous lithium source stream are sulfate ions and/or hydrogen sulfate (HSO₄⁻) ions.

In some embodiments, some (e.g., at least 1 mole percent (mol %), at least 10 mol %, at least 20 mol %, at least 50 mol %, at least 75 mol %, at least 95 mol %, at least 98 mol %, at least 99 mol %) or all of the anions in the aqueous lithium source stream are sulfate ions.

As noted above, the anions (e.g., non-hydroxide anions) may be present in the aqueous lithium source stream in a relatively high concentration. In some embodiments. the dissolved anions are present in the aqueous lithium source stream at a concentration of greater than or equal to 0.1 moles per liter (M), greater than or equal to 0.3 M, greater than or equal to 0.2 M, greater than or equal to 0.5 M, greater than or equal to 1 M, greater than or equal to 1.5 M, greater than or equal to 2 M, and/or up to 3 M, up to 5 M, up to 6, M, up to 7 M, up to 8 M, up to 10 M, up to 20 M, or greater. Combinations of these ranges (e.g., greater than or equal to 0.1 M and up to 20 M, greater than or equal to 0.1 M and up to 10 M, greater than or equal to 0.3 M and up to 6 M) are possible.

In some embodiments, a dissolved alkali metal chloride is present in the aqueous lithium source stream. For example, the aqueous lithium source stream may comprise a dissolved alkali metal chloride in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, up to 20 M, or greater. Combinations of these ranges are possible.

In some embodiments, dissolved lithium chloride is present in the aqueous lithium source stream. For example, the aqueous lithium source stream may comprise dissolved lithium chloride in an amount of greater than or equal to 0.00002 M, greater than or equal to 0.00005 M, greater than or equal to 0.0001 M, greater than or equal to 0.001 M, greater than or equal to 0.01 M, 0.1 moles per M, greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 8 M, or greater. Combinations of these ranges (e.g., greater than or equal to 0.1 M and less than or equal to 8 M, greater than or equal to 1 M and less than or equal to 5 M) are possible.

In some embodiments, dissolved sodium chloride is present in the aqueous lithium source stream. For example, the aqueous lithium source stream may comprise dissolved sodium chloride in an amount of greater than or equal to 0.1 M, greater than or equal to 0.2 M, greater than or equal to 0.5 M, greater than or equal to 1 M, greater than or equal to 1.5 M, greater than or equal to 2 M, and/or up to 3 M, up to 5 M, up to 6 M. up to 7 M, or greater. Combinations of these ranges (e.g., greater than or equal to 0.1 M and less than or equal to 7 M, greater than or equal to 1 M and less than or equal to 6 M) are possible.

In some embodiments, dissolved potassium chloride is present in the aqueous lithium source stream. For example, the aqueous lithium source stream may comprise dissolved potassium chloride in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 8 M, or greater. Combinations of these ranges (e.g., greater than or equal to 0.1 M and less than or equal to 8 M, greater than or equal to 1 M and less than or equal to 5 M) are possible.

In some embodiments, a dissolved alkali orthophosphate (e.g., potassium orthophosphate and/or sodium orthophosphate) is present in the aqueous lithium source stream. For example, the aqueous lithium source stream may comprise dissolved alkali orthophosphate in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M. up to 10 M, or greater. Combinations of these ranges (e.g., greater than or equal to 0.1 M and less than or equal to 10 M, greater than or equal to 0.3 M and less than or equal to 6 M) are possible. In some embodiments, a dissolved alkali monohydrogen phosphate (e.g., potassium monohydrogen phosphate and/or sodium monohydrogen phosphate) is present in the aqueous lithium source stream. For example, the aqueous lithium source stream may comprise dissolved alkali monohydrogen phosphate in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, or greater. Combinations of these ranges (e.g., greater than or equal to 0.1 M and less than or equal to 10 M, greater than or equal to 0.3 M and less than or equal to 6 M) are possible. In some embodiments, a dissolved alkali dihydrogen phosphate (e.g., potassium dihydrogen phosphate and/or sodium dihydrogen phosphate) is present in the aqueous lithium source stream. For example, the aqueous lithium source stream may comprise dissolved alkali dihydrogen phosphate in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, or greater. Combinations of these ranges (e.g., greater than or equal to 0.1 M and less than or equal to 10 M, greater than or equal to 0.3 M and less than or equal to 6 M) are possible.

The aqueous lithium source stream may have any of a variety of pH values, depending on the composition of the stream and the configuration of the system. The aqueous lithium source stream may have a relatively low pH (e.g., in instances where acid (electrogenerated or otherwise) is present). In some embodiments, the aqueous lithium source stream has a pH of less than or equal to 14, less than or equal to 12, less than or equal to 10, less than or equal to 8, less than or equal to 7, less than or equal to 6, less than or equal to 5, less than or equal to 4, less than or equal to 3, less than or equal to 2, or less. The aqueous lithium source stream may have a relatively high pH (e.g., in instances where base (electrogenerated or otherwise) is present). In some embodiments, the aqueous lithium source stream has a pH of greater than or equal to 1, greater than or equal to 3, greater than or equal to 5, greater than or equal to 7, greater than or equal to 8, greater than or equal to 9, greater than or equal to 10, greater than or equal to 11, greater than or equal to 12, or greater. Combinations of these ranges are possible.

As noted above, in some embodiments, at least some of the lithium cations from the aqueous lithium source stream are exposed to the lithium selective agent. Any of a variety of lithium selective agents may be employed. The lithium selective agent may be an entity capable of at least partially separating dissolved lithium cations from other dissolved species in a liquid solution. In some embodiments, the lithium selective agent comprises a chemical species such as a dissolved molecule or ion (e.g., anion). In some embodiments, the lithium selective agent comprises a solid species to which lithium may adsorb (e.g., via physisorption and/or specific or non-specific chemisorption). In some embodiments, the lithium selective agent comprises a liquid (e.g., in which lithium has a greater solubility than in water and/or a greater solubility as compared to other species present in the aqueous lithium source stream such as the non-lithium metal cations).

As an example, in the non-limiting embodiments shown in FIGS. 1A-1D, lithium selective agent in stream 202 is exposed to lithium cations in the base-rich product solution in stream 103 output by electrolysis assembly 101, which had treated aqueous electrolysis input stream 116 comprising at least a portion of aqueous lithium source stream 201.

In some embodiments, the lithium selective agent comprises a lithium solid-forming agent. The lithium solid-forming agent may be an entity (e.g., chemical, solid material, and the like) that can, upon exposure to the dissolved lithium cations, induce formation of a solid species comprising lithium cations.

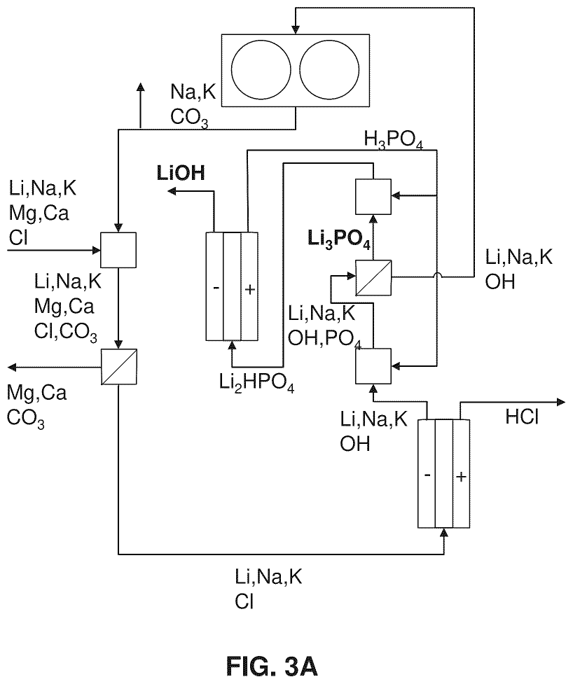

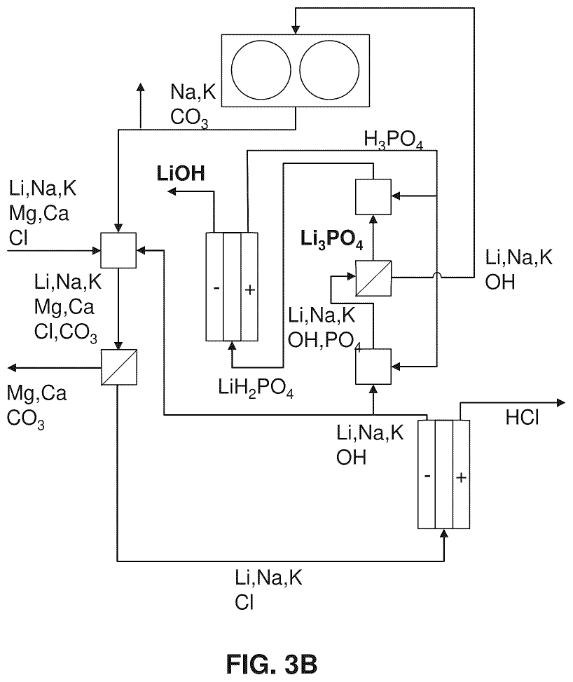

In some embodiments, the lithium solid-forming agent is a precipitant that can induce the formation of a lithium-containing precipitate (e.g., from aqueous solutions). As one non-limiting example, the lithium solid-forming agent may comprise phosphoric acid (H₃PO₄) and/or a phosphate anion (e.g., orthophosphate, PO₄³⁻). Exposure of lithium cations to phosphoric acid (e.g., under basic conditions) may result in the formation of Li₃PO₄, which has relatively low solubility (e.g., compared to phosphate salts of other non-lithium cations such as sodium phosphates and potassium phosphates). FIGS. 3A-9 show non-limiting examples of embodiments in which a lithium solid-forming agent comprises phosphoric acid and/or a phosphate. Other examples of precipitants that can be employed as a lithium selective agent include, but are not limited to, arsenate anions, carbonate anions, borate anions (e.g., orthoborate ions (BO₃³⁻), tetrahydroxyborates (B(OH)₄⁻), tetraborates (B₄O₇²⁻), and/or polyborates), and/or fluoride anions.

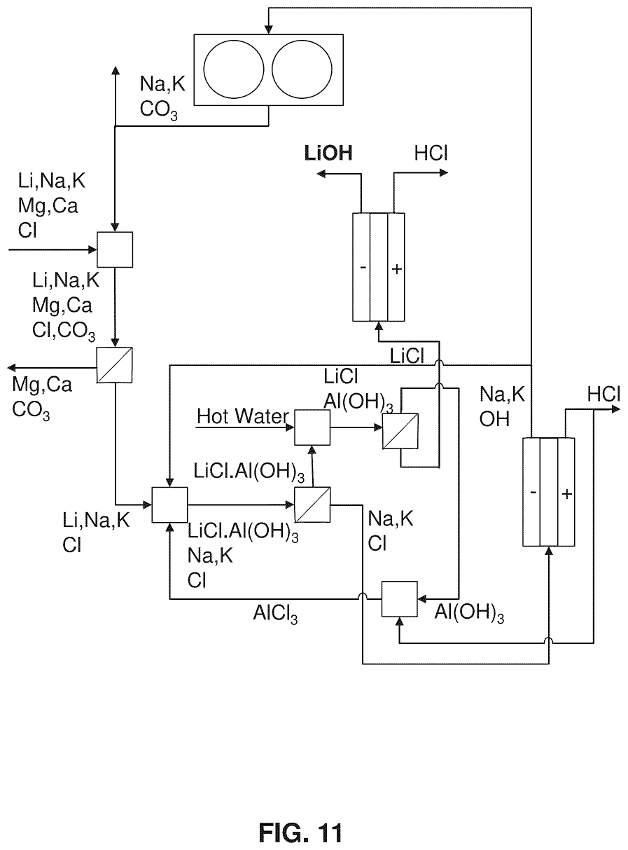

As another non-limiting example, the lithium solid-forming agent may comprise a solid sorbent. The solid sorbent may be any solid species (e.g., suspended in liquid, packed in an adsorption bed, and the like) that can adsorb dissolved lithium (e.g., via chemisorption and/or physisorption). As one non-limiting example, the lithium solid-forming agent may comprise aluminum hydroxide (Al(OH)₃) as a solid sorbent. Aluminum hydroxide has a high affinity for lithium. Exposure of lithium cations to Al(OH)₃ may result in the formation of a lithium salt aluminum hydroxide adduct as LiX·Al(OH)₃, where X is one of the anions (e.g., a halide such as chloride). FIGS. 11-13 show non-limiting examples of embodiments in which a lithium solid-forming agent comprises a solid sorbent comprising aluminum hydroxide. Other examples of solid sorbents that can be employed as a lithium selective agent include, but are not limited to, lithium ion battery cathode materials (e.g., lithium metal oxides and/or lithium metal intercalation compounds such as but not limited to LiCoO₂, LiFePO₄, LiMn₂O₄, and/or LiNiMnCoO₂), manganese oxides, mixed transition metal oxides (e.g., mixed aluminum+transition metal oxides), molecular sieves, ion exchange resins, ion exchange polymers, and/or metal-organic hybrid materials.

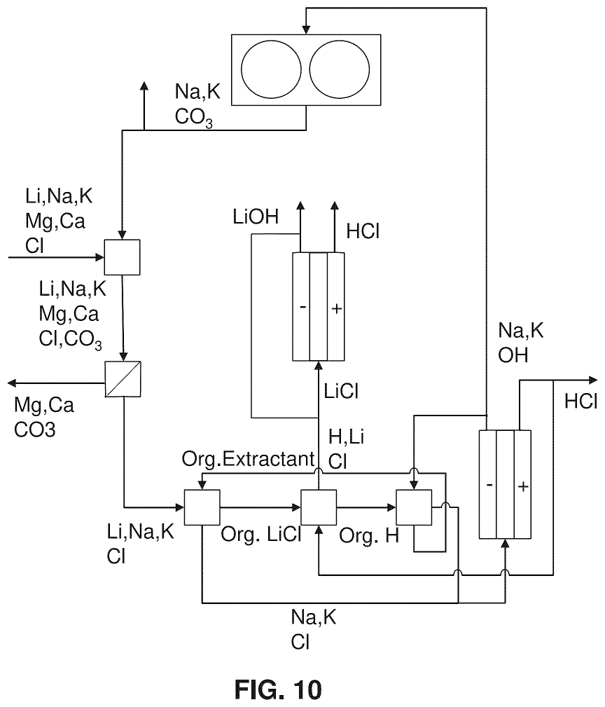

In some embodiments, the lithium selective agent comprises an organic liquid (e.g., for organic solvent extraction of lithium). The solubility of the lithium cations may be greater than the solubilities of the non-lithium metal cations present in the stream exposed to the organic liquid. In some embodiments, the organic liquid comprises a lithium-selective coordination molecule (e.g., a lithium chelator such as a crown ether). The organic liquid may be substantially (or completely) immiscible with water under the conditions of the method (e.g., at 298 K or at another temperature), which may facilitate separation between the organic and aqueous phases. Examples of organic liquids that may be employed as a lithium selective agent include, but are not limited to, alcohols (e.g., methanol, ethanol, n-propanol, isopropanol, 1-butanol, and/or higher-chain liquid alcohols), hydrocarbons (e.g., C₆-C₂₀ hydrocarbons or heavier and/or mixtures thereof such as n-hexane, benzene, up to kerosene or heavier), organic phosphates (e.g., tributyl phosphate), alkyl amines (e.g., trioctyl amine), ethers, and/or ketones. In some embodiments, the organic liquid is a mixture of two or more different liquids (e.g., two or more of the liquid described above). In some embodiments, one or more additives are present in the organic liquid (e.g., as a solute). The additive may promote a relatively fast lithium ion extraction rate and/or a relatively high lithium extraction selectivity (compared to aqueous solutions). Examples of the additives include, but are not limited to, salts, phosphates, nitrates, and/or organic additives (e.g., chelating agents). The lithium ions from the aqueous lithium source stream may be exposed to the organic liquid in any of a variety of mass transfer units (e.g., mixing vessels) capable of separating aqueous and non-aqueous phases. For example, one or more mixer-settlers may be employed. FIG. 10 shows a non-limiting example of an embodiment in which a lithium solid-forming agent comprises an organic liquid.

In some embodiments, exposure of the lithium cations from the aqueous lithium source stream results in the generation of a lithium-enrichment output. The lithium-enrichment output may comprise a lithium-rich phase, which may comprise at least some of the lithium cations that were exposed to the lithium selective agent. The lithium-enrichment output may be a single solution (e.g., stream) or may be multiple solutions (e.g., multiple streams). The solution(s) of the lithium-enrichment output may be homogeneous or include multiple phases (e.g., solids suspended in liquids and/or separate aqueous and organic phases). Referring again to FIGS. 1A-1D, exposure of the lithium selective agent in stream 202 to lithium cations in base-rich product solution in stream 103 may result in the generation of lithium-enrichment output in the form of stream 203, which may comprise, for example a lithium-rich solid material such as a lithium salt precipitate suspended in the stream.

In some embodiments where the lithium selective agent comprises a lithium solids-forming agent, the lithium-enrichment output comprises a lithium-rich solids-containing stream comprising the lithium-rich phase. In such embodiments, the lithium-rich phase may comprise a lithium-rich solid material comprising at least some of the lithium cations. In some embodiments, the lithium-rich solid material comprises a solid precipitate (e.g., amorphous and/or crystalline). As one specific example, when the lithium selective agent comprises phosphoric acid and/or a phosphate (e.g., orthophosphate), the lithium-enrichment output may comprise a lithium-rich solids-containing stream in the form of a stream comprising a lithium-rich solid material comprising Li₃PO₄ precipitate (e.g., suspended in the stream).

In some embodiments, the lithium-rich solid material comprises a lithium-adsorbed solid sorbent. As one specific example, when the lithium selective agent comprises aluminum hydroxide, the lithium-enrichment output may comprise a lithium-rich solids-containing stream in the form of a stream comprising a lithium-rich solid material comprising LiX·Al(OH)₃ (e.g., suspended in the stream), where X is one of the non-hydroxide anions (e.g., a halide such as chloride).

In some embodiments where the lithium selective agent comprises an organic liquid, the lithium-enrichment output comprises two or more streams. One of the streams may comprise an extract stream comprising the lithium-rich phase (a lithium-rich organic phase), where the lithium-rich phase comprises at least some of the organic liquid, at least some of the lithium cations (as dissolved ions in the organic liquid), and at. least some of the anions. Another of the streams of the lithium-enrichment output may comprise a lithium depleted stream (e.g., an aqueous lithium depleted stream) comprising at least some of the non-lithium metal cations and at least some of the anions from the lithium source stream.

In some embodiments, at least some of the lithium-rich phase from the lithium-enrichment output is removed (e.g., separated from a remainder of the lithium-enrichment output) to produce a lithium depleted stream. In the embodiments shown in FIGS. 1A-1D, lithium-rich phase is removed from lithium-enrichment output 203, thereby generating stream 204 comprising the lithium-rich phase, as well as generating lithium depleted stream 211. The lithium depleted stream may have a lower total concentration of lithium than the stream comprising the lithium-rich phase (e.g., stream 203).

In some embodiments, the ratio of the total molar concentration of lithium (including both dissolved lithium and lithium in the solid-phase, if any) in the stream comprising the removed lithium-rich phase (e.g., stream 204) to the total molar concentration of lithium (including both dissolved lithium and lithium in the solid-phase, if any) in the lithium enrichment output (e.g., stream 203) is greater than or equal to 1.05, greater than or equal to 1.1, greater than or equal to 1.2, greater than or equal to 1.5, greater than or equal to 2, greater than or equal to 5, greater than or equal to 10, greater than or equal to 20, greater than or equal to 50, greater than or equal to 100, and/or up to 200, up to 500, up to 1,000, up to 10,000, up to 100,000, up to 1,000.000, or greater.

The method of removal of the lithium-rich phase may depend on the nature of the lithium-rich phase. For example, in some embodiments where the lithium-rich phase comprises a lithium-rich solid (e.g., a lithium-containing precipitate and/or lithium- adsorbed solid sorbent) in a lithium solids-containing stream, the lithium-rich solid is removed from the stream via any of a variety of solid-liquid separation techniques (e.g., in a solid-separation vessel). For example, a clarifier (e.g., lamella clarifier) and/or filter may be employed. In some embodiments in which the lithium-rich phase comprises the lithium cations in organic liquid, the lithium-rich phase is simply a separate stream as the aqueous lithium depleted stream, each of which may be separated from each other due to being immiscible. Such a separation may be performed by a liquid-liquid decanter.

In some, but not necessarily all embodiments, the lithium depleted stream is free of any lithium cations (dissolved or otherwise). In some embodiments in which at least some lithium cations remain in the lithium depleted phase, the ratio of the total molar concentration of lithium (including both dissolved lithium and lithium in the solid-phase, if any) in the stream comprising the lithium-rich phase (e.g., the lithium-rich solids-containing stream or the extract stream) to the total molar concentration of lithium (including both dissolved lithium and lithium in the solid-phase, if any) in the lithium depleted stream is greater than or equal to 1.05, greater than or equal to 1.1, greater than or equal to 1.2, greater than or equal to 1.5. greater than or equal to 2, greater than or equal to 5, greater than or equal to 10, greater than or equal to 20, greater than or equal to 50, greater than or equal to 100, and/or up to 200, up to 500, up to 1,000, up to 10,000, up to 100,000, up to 1,000,000, or greater.

The lithium depleted stream may, in some instances, comprise at least some of the non-lithium metal cations (e.g., sodium cations, potassium cations). In some embodiments in which the lithium selective agent is exposed to at least a portion of the base-rich product solution, the lithium depleted stream comprises at least some of the basic species (e.g., hydroxide ions) generated in the electrolytic cell.

In some embodiments, in which a gas-liquid contact vessel is employed (e.g., for carbon dioxide capture), the contact vessel liquid inlet stream comprises at least a portion of the lithium depleted stream. For example, in FIGS. 1A-1D, contact vessel liquid inlet stream 106 comprises at least a portion of lithium depleted stream 211 generated upon removal of the lithium-rich phase from lithium-enrichment output 203.

In some, but not necessarily all embodiments, the methods of this disclosure comprise transporting an aqueous electrolysis input stream to an electrolytic cell. For example, referring back to FIGS. 1A-1D, aqueous electrolysis input stream 116 is transported to electrolysis assembly inlet 139 of electrolysis assembly 101 comprising electrolytic cell 102. In some embodiments, the aqueous electrolysis input stream comprises at least some of the dissolved non-lithium metal cations from the aqueous lithium source stream. In some embodiments, the aqueous electrolysis input stream comprises at least some of the dissolved anions from the aqueous lithium source stream. In some, but not necessarily all embodiments, the aqueous electrolysis input stream comprises at least some of the lithium cations from the aqueous lithium source stream.

The aqueous electrolysis input stream may comprise liquid water in an amount of greater than or equal to 40 weight percent (wt %), greater than or equal to 50 wt %, greater than or equal to 75 wt %, greater than or equal to 90 wt %, greater than or equal to 95 wt %, greater than or equal to 98 wt %, greater than or equal to 99 wt %, greater than or equal to 99.9 wt %, or more by weight of liquid in the aqueous electrolysis input stream.

The aqueous electrolysis input stream may include a relatively high concentration of dissolved salt. The salt may promote relatively high conductivity within the electrolytic cell (e.g., by promoting charge neutrality as electrochemical reactions occur at and/or near electrode surfaces). Alternatively or additionally, the salt may promote high conductivity within the electrolytic cell by promoting charge transport (e.g., by promoting ion transport).

In some embodiments, the aqueous electrolysis input stream comprises dissolved cations. Any of a variety of cations may be present. The cations may comprise monovalent cations (carrying a single positive charge). In some embodiments, the cations comprise metal cations. For example, the metal cations may comprise alkali metal ions. As a more specific example, the metal cations comprise sodium ions (Na⁺), lithium (Li⁺) ions, and/or potassium ions (K⁺). The presence and concentration of the lithium cations in the aqueous electrolysis input stream may depend, for example, on whether the exposure to the lithium selective agent to form the lithium-enrichment output (and subsequent removal of the formed lithium-rich phase) occurs to a stream upstream or downstream of the electrolysis assembly. In some embodiments, the aqueous electrolysis input stream comprises non-lithium metal cations. For example, the metal cations comprise sodium ions (Na⁺), and/or potassium ions (K⁺). In some embodiments, the cations comprise ammonium cations (e.g., NH₄⁺ or a derivative thereof such as an alkylammonium). In some embodiments, the metal cations are spectator ions with respect to the chemistries employed by the electrolysis assembly and/or other reactions performed in the methods and systems of this disclosure.

In some embodiments, some (e.g., at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol % at least 99.9 mol %,) or all of the cations in the aqueous electrolysis input stream are alkali metal ions.

In some embodiments, some (e.g., at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol % at least 99.9 mol %,) or all of the cations in the aqueous electrolysis input stream are lithium ions, sodium ions, and/or potassium ions.

In some embodiments, some (e.g., at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol % at least 99.9 mol %,) or all of the cations in the aqueous electrolysis input stream are sodium ions and/or potassium ions.

In some embodiments, some (e.g., at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol % at least 99.9 mol %,) or all of the cations in the aqueous electrolysis input stream are sodium ions.

In some embodiments, some (e.g., at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol % at least 99.9 mol %,) or all of the cations in the aqueous electrolysis input stream are potassium ions.

In some embodiments, some (e.g., at least 0.0005 mol %, at least 0.001 mol %, at least 0.01 mol %, at least 0.1 mol %, at least 0.2 mol %, at least 0.3 mol %, at least 1 mol %. at least 10 mol %, at least 20 mol %, at least 50 mol %, at least 75 mol %, at least 95 mol %, at least 98 mol %, at least 99 mol % at least 99.9 mol %, at least 99.99 mol %,) or all of the cations in the aqueous electrolysis input stream are lithium ions.

As noted above, the cations may be present in the aqueous electrolysis input stream at a relatively high concentration. In some embodiments, the dissolved cations are present in the aqueous electrolysis input stream at a concentration of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 7 M, up to 8 M, up to 10 M, up to 20 M, or greater. Combinations of these ranges (e.g., greater than or equal to 0.1 M and up to 20 M, greater than or equal to 0.1 M and up to 8 M, greater than or equal to 0.1 M and up to 6 M, greater than or equal to 1 M and up to 6 M) are possible. It has been observed that, in some embodiments, a concentration of the cations of greater than or equal to 1 M and less than or equal to 6 M can contribute to desirable conductivity when operating the electrochemical cell.

In some embodiments, the aqueous electrolysis input stream comprises dissolved anions. Any of a variety of anions may be present. In some embodiments, at least some of the anions are non-hydroxide anions. The anions may comprise monovalent anions (carrying a single negative charge). For example, the anions may comprise halide ions. As a more specific example, the anions may comprise chloride ions (Cl⁻), bromide ions (Br⁻), and/or iodide ions (I⁻). Other examples of monovalent anions include, but are not limited to, nitrates, nitrites, perchlorates, and/or hydrogen sulfate anions (HSO₄⁻). In some embodiments, the anions comprise oxyanions. In some embodiments, the anions comprise divalent ions (carrying a charge of −2). For example, the anions may comprise sulfate ions (SO₄²⁻). In some embodiments, the anions comprise trivalent anions (carrying a charge of −3), such as orthophosphate anions (PO₄³⁻). In some embodiments, the anions comprise phosphate ions (e.g., orthophosphate ions (PO₄³⁻), monohydrogen phosphate ions (HPO₄²⁻), and/or dihydrogen phosphate ions (H₂PO₄)). In some embodiments, the anions comprise borate ions (e.g., orthoborate ions (BO₃³⁻), tetrahydroxyborates (B(OH)₄⁻), tetraborates (B₄P₇²⁻), and/or polyborates). In some embodiments, the anions include the conjugate base of an organic acid (e.g., a carboxylate-containing organic compound). Examples of conjugate bases of organic acids include, but are not limited to, formate, acetate, lactate, oxalate, and/or citrate. Another example of an organic acid is benzoic acid. In some embodiments, the anions referenced here do not include carbonate ions and/or bicarbonate ions (though one or both of carbonate anions and bicarbonate anions may also be present in the aqueous electrolysis input stream in some embodiments). In some embodiments, the anions are conjugate bases of strong acids. However, in some embodiments, the anions (e.g., non-hydroxide anions) are conjugate bases of weak acids. In some embodiments, the anions are spectator ions with respect to the chemistries employed by the electrolysis assembly and/or other reactions performed in the methods and systems of this disclosure.

In some embodiments, some (e.g., at least 1 mole percent (mol %), at least 10 mol %, at least 20 mol %, at least 50 mol %, at least 75 mol %, at least 95 mol %, at least 98 mol %, at least 99 mol %) or all of the anions in the aqueous electrolysis input stream are chloride ions.

In some embodiments, some (e.g., at least 1 mol %, at least 10 mol %, at least 20 mol %, at least 50 mol %, at least 75 mol %, at least 95 mol %, at least 98 mol %, at least 99 mol %) or all of the anions in the aqueous electrolysis input stream are phosphate ions (e.g., monohydrogen phosphate ions, dihydrogen phosphate ions, and/or dihydrogen phosphate ions).

In some embodiments, some (e.g., at least 1 mole percent (mol %), at least 10 mol %, at least 20 mol %, at least 50 mol %, at least 75 mol %, at least 95 mol %, at least 98 mol %, at least 99 mol %) or all of the anions in the aqueous electrolysis input stream are sulfate ions (SO₄²⁻) and/or hydrogen sulfate ions (HSO₄).

In some embodiments, some (e.g., at least 1 mole percent (mol %), at least 10 mol %, at least 20 mol %, at least 50 mol %, at least 75 mol %, at least 95 mol %, at least 98 mol %, at least 99 mol %) or all of the anions in the aqueous electrolysis input stream are sulfate ions (SO₄²⁻).

As noted above, the anions may be present in the aqueous electrolysis input stream in a relatively high concentration. In some embodiments, the dissolved anions are present in the aqueous electrolysis input stream at a concentration of greater than or equal to 0.1 moles per liter (M), greater than or equal to 0.3 M, greater than or equal to 0.2 M, greater than or equal to 0.5 M, greater than or equal to 1 M, greater than or equal to 1.5 M, greater than or equal to 2 M, and/or up to 3 M, up to 5 M, up to 6, M, up to 7 M, up to 8 M, up to 10 M, up to 20 M, or greater. Combinations of these ranges (e.g., greater than or equal to 0.1 M and up to 20 M, greater than or equal to 0.1 M and up to 10 M, greater than or equal to 0.3 M and up to 6 M) are possible.

In some embodiments, a dissolved alkali metal chloride is present in the aqueous electrolysis input stream. For example, the aqueous electrolysis input stream may comprise a dissolved alkali metal chloride in an amount of greater than or equal to 0. 1moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, up to 20 M, or greater. Combinations of these ranges are possible.

In some embodiments, dissolved sodium chloride is present in the aqueous electrolysis input stream. For example, the aqueous electrolysis input stream may comprise dissolved sodium chloride in an amount of greater than or equal to 0.1 M, greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 7 M, or greater. Combinations of these ranges (e.g., greater than or equal to 0.1 M and less than or equal to 7 M, greater than or equal to 1 M and less than or equal to 6 M) are possible.

In some embodiments, dissolved potassium chloride is present in the aqueous electrolysis input stream. For example, the aqueous electrolysis input stream may comprise dissolved potassium chloride in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 8 M, or greater. Combinations of these ranges (e.g., greater than or equal to 0.1 M and less than or equal to 8 M, greater than or equal to 1 M and less than or equal to 5 M) are possible.

In some embodiments, dissolved lithium chloride is present in the aqueous electrolysis input stream. For example, the aqueous electrolysis input stream may comprise dissolved lithium chloride in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 8 M, or greater. Combinations of these ranges (e.g., greater than or equal to 0.1 M and less than or equal to 8 M, greater than or equal to 1 M and less than or equal to 5 M) are possible.

In some embodiments, a dissolved alkali orthophosphate (e.g., potassium orthophosphate and/or sodium orthophosphate) is present in the aqueous electrolysis input stream. For example, the aqueous electrolysis input stream may comprise dissolved alkali orthophosphate in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, or greater. Combinations of these ranges (e.g., greater than or equal to 0.1 M and less than or equal to 10 M, greater than or equal to 0.3 M and less than or equal to 6 M) are possible. In some embodiments, a dissolved alkali monohydrogen phosphate (e.g., potassium monohydrogen phosphate and/or sodium monohydrogen phosphate) is present in the aqueous electrolysis input stream. For example, the aqueous electrolysis input stream may comprise dissolved alkali monohydrogen phosphate in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, or greater. Combinations of these ranges (e.g., greater than or equal to 0.1 M and less than or equal to 10 M, greater than or equal to 0.3 M and less than or equal to 6 M) are possible. In some embodiments, a dissolved alkali dihydrogen phosphate (e.g., potassium dihydrogen phosphate and/or sodium dihydrogen phosphate) is present in the aqueous electrolysis input stream. For example, the aqueous electrolysis input stream may comprise dissolved alkali dihydrogen phosphate in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, or greater. Combinations of these ranges (e.g., greater than or equal to 0.1 M and less than or equal to 10 M, greater than or equal to 0.3 M and less than or equal to 6 M) are possible.

In some embodiments, dissolved carbonate anions are present in the aqueous electrolysis input stream in addition to the other anions discussed above. For example, the aqueous electrolysis input stream may comprise dissolved carbonate anions in an amount of greater than or equal to 0.005 M, greater than or equal to 0.01 M, greater than or equal to 0.02 M, greater than or equal to 0.05 M, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges (e.g., greater than or equal to 0.005 M and less than or equal to 3 M, greater than or equal to 0.05 M and less than or equal to 2 M) are possible.

In some embodiments, dissolved bicarbonate anions are present in the aqueous electrolysis input stream in addition to the other anions discussed above. For example, the aqueous electrolysis input stream may comprise dissolved bicarbonate anions in an amount of greater than or equal to 0.01 M, greater than or equal to 0.02 M, greater than or equal to 0.05 M, greater than or equal to 0.1 moles per liter (M), greater than or equal to 0.2 M, greater than or equal to 0.5 M, greater than or equal to 1 M, and/or up to 1.5 M, up to 2 M, up to 3 M, or greater. Combinations of these ranges (e.g., greater than or equal to 0.005 M and less than or equal to 3 M, greater than or equal to 0.05 M and less than or equal to 2 M) are possible.

The aqueous electrolysis input stream may have any of a variety of pH values, depending on the composition of the stream and the configuration of the system. The aqueous electrolysis input stream may have a relatively low pH (e.g., in instances where acid (electrogenerated or otherwise) is present). In some embodiments, the aqueous electrolysis input stream has a pH of less than or equal to 14, less than or equal to 12, less than or equal to 10, less than or equal to 8, less than or equal to 7, less than or equal to 6, less than or equal to 5, less than or equal to 4, less than or equal to 3, less than or equal to 2, or less. The aqueous electrolysis input stream may have a relatively high pH (e.g., in instances where base (electrogenerated or otherwise) is present). In some embodiments, the aqueous electrolysis input stream has a pH of greater than or equal to 1, greater than or equal to 3, greater than or equal to 5, greater than or equal to 7, greater than or equal to 8, greater than or equal to 9, greater than or equal to 10, greater than or equal to 11, greater than or equal to 12, or greater. Combinations of these ranges are possible.

The electrolysis assembly may have any of a variety of configurations, depending on, for example, the arrangement of the overall system and/or the desired electrochemistries to be employed in electrogenerating basic and/or acidic species. Upon transport to the electrolysis assembly, one or more components of the aqueous electrolysis input stream (e.g., dissolved species and/or solvent molecules such as water molecules) may undergo one or more electrochemically-induced reactions. The reactions may result, directly or indirectly, in the production of an acidic species and/or basic species. The acidic species and/or basic species may promote downstream capture and/or release of carbon dioxide, as well as in some instances generation of lithium containing-materials (e.g., lithium hydroxide, lithium carbonate).

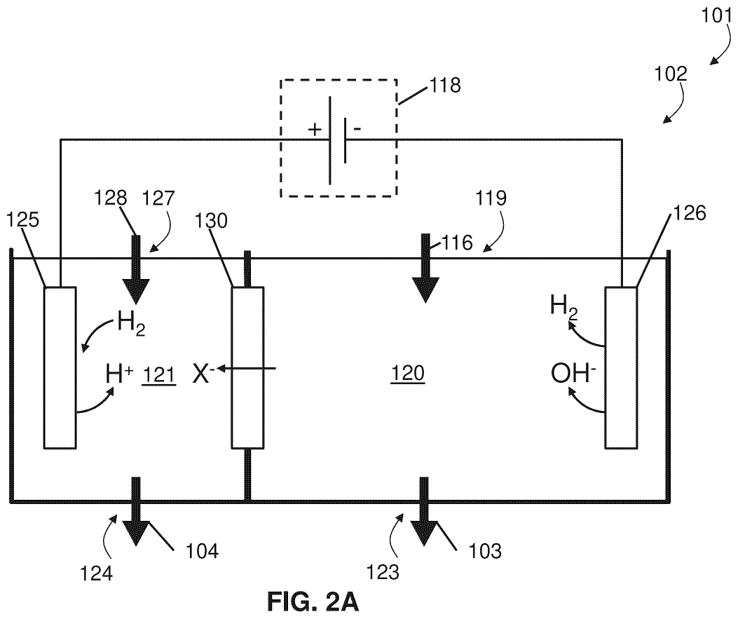

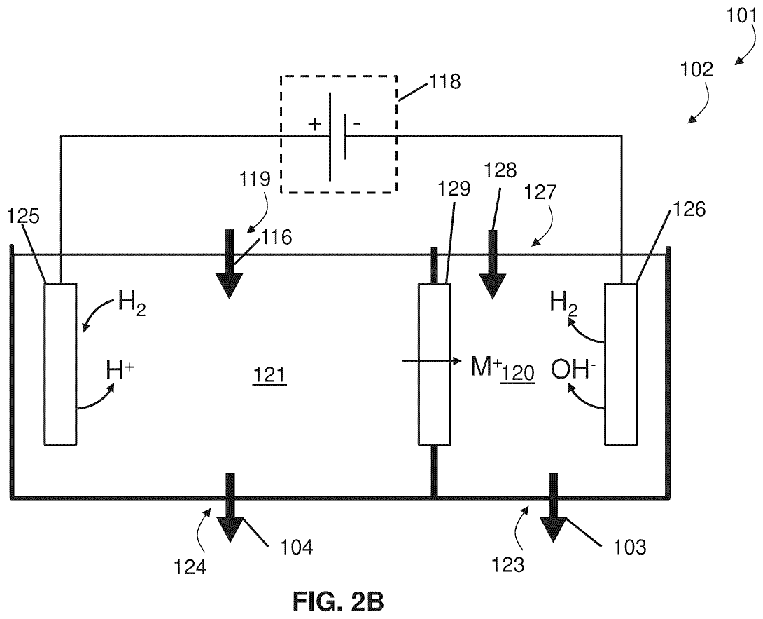

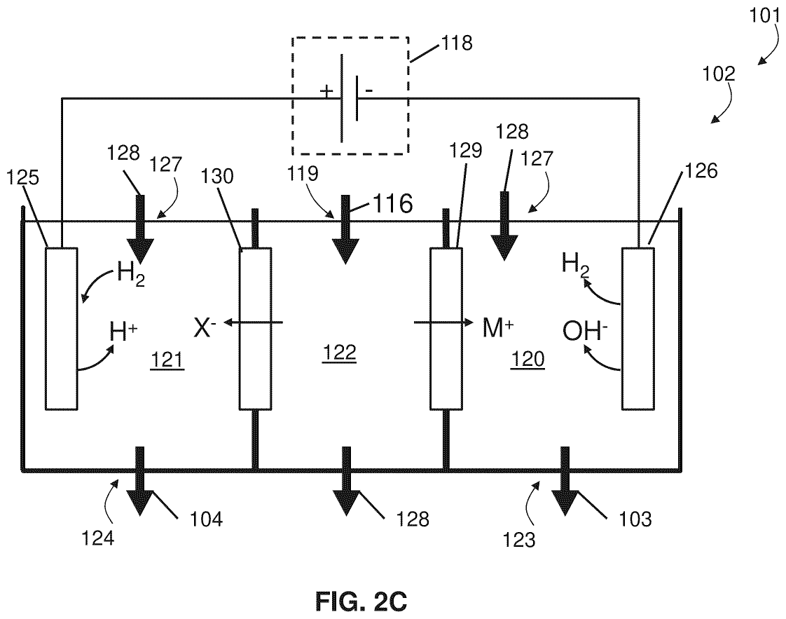

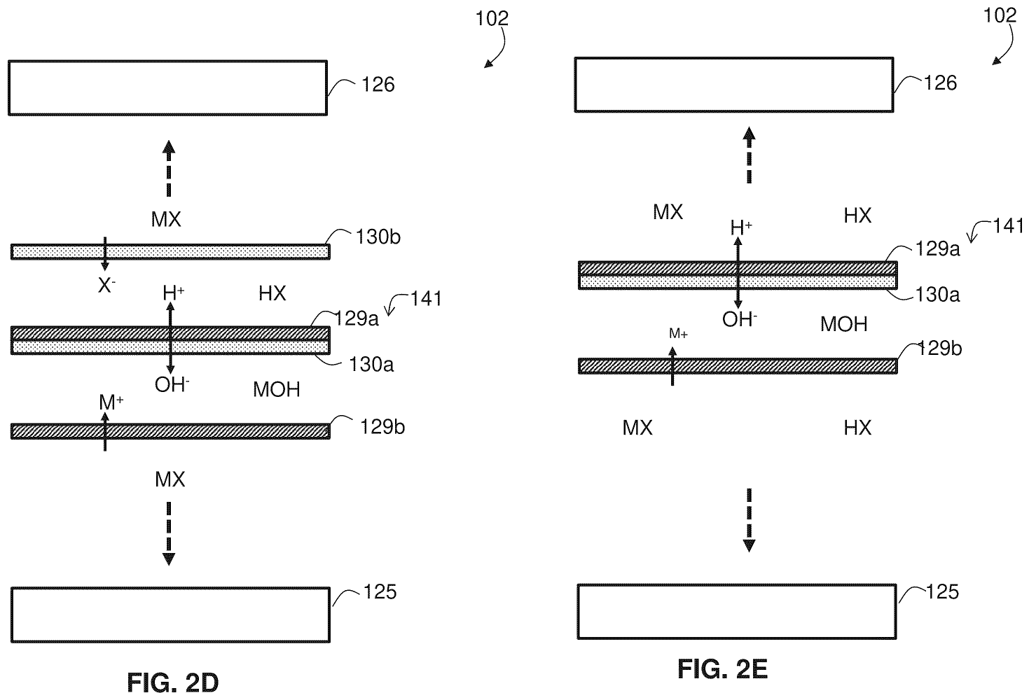

In some embodiments, the electrolysis assembly includes an electrolytic cell. FIGS. 2A-2C show cross-sectional schematic illustrations of non-limiting examples of embodiments of electrolysis assemblies 101 comprising electrolytic cell 102. An electrolytic cell generally comprises an anode and a cathode and is configured to use electrical energy to drive a chemical reaction that is thermodynamically non-spontaneous under the conditions of the reaction (e.g., temperature and pressure). The electrolytic cell may be a flow cell. The flow cell may be configured to receive one or more liquid streams (e.g., comprising reagents and/or electrolyte components). The flow cell may be configured to output one or more product streams comprising an electrogenerated product.

The embodiments in FIGS. 2A-2C use the hydrogen evolution and hydrogen reduction reactions as illustrative half reactions that can be employed in an overall chemical reaction that can be performed in the electrolytic cell. However, other chemistries (e.g., chloralkali chemistries) can also be employed in certain embodiments.

While the electrolysis assemblies shown in FIGS. 2A-2C have a single electrolytic cell, some electrolysis assemblies may include multiple electrolytic cells (e.g., at least 2 cells, at least 3 cells, at least 4 cells, at least 5 cells, at least 10 cells, at least 50 cells, at least 100 cells, at least 500 cells, at least 1,000 cells, at least 5,000 cells, at least 10,000 cells, at least 15,000 cells, at least 25,000 cells, at least 50,000 cells, at least 100.000 cells, and/or up to 200,000 cells, up to 250,000 cells, up to 500,000 cells, up to 1,000,000 cells, or more). Combinations of these ranges (e.g., at least 2 cells and less than or equal to 1,000,000 cells, at least 15,000 cells and less than or equal to 25,000cells) are possible. The multiple electrolytic cells may be fluidically arranged in parallel and/or in series.

The electrolytic cell may drive one or more reactions ultimately producing base-rich product solutions and acid-rich product solutions, as discussed below. The electrolytic cell may drive one or more of such reactions upon application of an electrical potential difference across the electrolytic cell. The potential difference may be applied across the anode and the cathode such that the thermodynamic barrier (and in some instances kinetic barrier) to the overall cell reaction is overcome, thereby initiating the cell reaction to occur via electron transfers that effect the respective half reactions. The magnitude of the electrical potential difference may be greater than or equal to 0.5 V, greater than or equal to 0.9 V, greater than or equal to 1.0 V, greater than or equal to 1.3 V, and/or up to 1.5 V, up to 1.8 V, up to 2 V, up to 2.5 V, up to 3 V, or higher. Combinations of these ranges (e.g., greater than or equal to 0.5 V and less than or equal to 3 V, greater than or equal to 0.9 and less than or equal to 1.5 V) are possible. In FIGS. 2A-2C, for example, electrical potential difference 118 is applied across electrolytic cell 102 to initiate the chemical reactions shown.

In some embodiments, the electrolysis assembly includes one or more (e.g., at least one, at least two, at least three, or more) liquid inlets. The aqueous electrolysis input stream may enter the electrolytic cell via one or more of these inlets. The liquid inlets may be configured to supply dissolved ions to the anode and/or the cathode. In some embodiments, one or more of the liquid inlets are part of the electrolytic cell itself, although in other embodiments, the liquid inlets are upstream of the cell (e.g., connected to a separate conduit that feeds the cell or an upstream unit operation within the assembly). In some embodiments, a single liquid inlet feeds both the anode and the cathode (and/or a third chamber between anolyte and catholyte chambers). However, in other embodiments, a first liquid inlet supplies dissolved ions to the cathode (e.g., as part of a catholyte solution) and a second liquid inlet supplies dissolved ions to the anode (e.g., as part of an anolyte solution). In some such embodiments, a third liquid inlet supplies dissolved ions to the third, middle chamber between the anolyte and catholyte chambers.

In the embodiment shown in FIG. 2A, aqueous electrolysis input stream 116 (e.g., comprising the dissolved cations and dissolved anions) is fed as catholyte into catholyte chamber 120 via liquid inlet 119 (and electrolyte solution 128 is fed as anolyte into anolyte chamber 121 via liquid inlet 127). In the embodiment shown in FIG. 2B, aqueous electrolysis input stream 116 (e.g., comprising the dissolved cations and dissolved anions) is fed as anolyte into anolyte chamber 121 via liquid inlet 119 (and electrolyte solution 128 is fed as catholyte into catholyte chamber 120 via liquid inlet 127). In the embodiment shown in FIG. 2C, aqueous electrolysis input stream 116 (e.g., comprising the dissolved cations and dissolved anions) is fed into electrolyte chamber 122 via liquid inlet 119 (and electrolyte solution 128 is fed as catholyte into catholyte chamber 120 via liquid inlet 127, and also electrolyte solution 128 is fed as anolyte into anolyte chamber 121 via liquid inlet 127).

In some embodiments, the electrolysis assembly includes two or more (e.g., at least two, at least three, or more) liquid outlets. The reaction products from one or more chemical reactions initiated by the application of the electrical potential difference may be output from the electrolysis assembly via these outlets. For example, the electrolysis assembly may include a first electrolysis assembly liquid outlet and a second electrolysis assembly liquid outlet.

The first electrolysis assembly liquid outlet may be configured to output a base-rich product solution (e.g., generated in a catholyte chamber). For example, the first electrolysis assembly liquid outlet may be in fluid communication with a catholyte chamber of the electrolytic cell. For example, in FIGS. 2A-2C, first liquid outlet 123 is in fluid communication with catholyte chamber 120 of electrolytic cell 102. At least a portion of base-rich product solution 103 generated by electrolysis assembly 101 may be output by first liquid outlet 123 (e.g., to a conduit to be transported to a downstream process and/or to be collected). It should be understood here and elsewhere that the terms “liquid inlet”, “liquid outlet”, “gas inlet”, and “gas outlet” are used for convenience in identifying various components of the system and to, generally, refer to states of matter most significantly contributing to the material that passes through them; these terms are not meant to imply that the material passing through these components must be completely single-phase (e.g., completely liquid with no gaseous component or vice versa).

The second electrolysis assembly liquid outlet may be configured to output an acid-rich product solution (e.g., generated in an anolyte chamber). For example, the second electrolysis assembly liquid outlet may be in fluid communication with an anolyte chamber of the electrolytic cell. For example, in FIGS. 2A-2C, second liquid outlet 124 is in fluid communication with anolyte chamber 121 of electrolytic cell 102. At least a portion of acid-rich product solution 104 generated by electrolysis assembly 101 may be output by second liquid outlet 124 (e.g., to a conduit to be transported to a downstream process and/or to be collected). While the liquid outlets are shown as being directly part of electrolytic cell 102 in FIGS. 2A-2C, other configurations are possible. For example, while in some embodiments, one or more of the liquid outlets are part of the electrolytic cell itself, in other embodiments, the liquid outlets are downstream of the cell (e.g., connected to a separate conduit that feeds the downstream processes such as chambers or reactors for further reactivity (e.g., as in a chloralkali assembly in which hydrogen gas and chlorine gas electrolytic products are reacted to form HCl to produce the acid-rich product solution)).

As mentioned above, the electrolytic cell may comprise an anode and a cathode. In an electrolytic cell, the anode, also referred to as the positive electrode, is used to promote an electrochemical oxidation half reaction. For example, in the embodiments shown in FIGS. 2A-2C, anode 125 is configured to perform the hydrogen oxidation reaction, in which hydrogen gas is oxidized to form protons: 1/2 H₂→H⁺+e⁻(with the electrons collected by anode 125 and transported to cathode 126 as part of the electrical circuit). In other words, in some embodiments, the anode comprises a hydrogen depolarization anode (HDA). Any of a variety of materials may be used for the anode, generally including an electronically conductive solid. In some embodiments, the anode comprises a conductive metal or metal alloy such as platinum, nickel, stainless steel, titanium, platinized titanium, silver, gold, or combinations thereof). In some embodiments, the anode is a gas diffusion electrode and/or comprises a gas diffusion layer (e.g., a carbon and/or metallic gas diffusion electrode and/or layer). In some embodiments, the anode comprises a catalyst configured to accelerate the reaction to occur at the anode (e.g., hydrogen oxidation).

In some embodiments, the electrolytic cell comprises an anolyte chamber. The anolyte chamber may be in fluid communication with at least a portion of the anode (e.g., the anode may be at least partially submerged in anolyte that is present in the anolyte chamber). At least a portion (or all) of the anode may be located within the anolyte chamber. In the embodiments shown in FIGS. 2A-2C, anode 125 is submerged in anolyte in anolyte chamber 121.

In an electrolytic cell, the cathode, also referred to as the negative electrode, is used to promote an electrochemical reduction half reaction. For example, in the embodiments shown in FIGS. 2A-2C, cathode 126 is configured to perform the hydrogen evolution reaction, in which hydrogen gas is generated by the reduction of water (or protons from water): 2H₂O+2e⁻→H₂+2OH⁻(with the electrons provided by cathode 126 after having been transported to cathode 126 from anode 125 as part of the electrical circuit). Any of a variety of materials may be used for the cathode, generally including an electronically conductive solid (e.g., a conductive metal or metal alloy such as platinum, nickel, ruthenium, stainless steel, or combinations thereof). As one example, the cathode may comprises nickel coated with a platinum group metal (e.g., platinum). However, in some embodiments, the cathode comprises a nickel substrate with a catalyst coating comprising a non-platinum group metal such as a non-platinum group transition metal. In some embodiments, the cathode comprises a catalyst configured to accelerate the reaction to occur at the cathode (e.g., hydrogen evolution).

In some embodiments where the hydrogen evolution reaction is performed at the cathode and the hydrogen oxidation reaction is performed at the anode, at least some of (that is, some or all of) the hydrogen gas reactant at the anode is supplied from the product hydrogen gas generated at the cathode. For example, a conduit may be configured to collect hydrogen gas produced in the catholyte chamber and transport the hydrogen gas to the anolyte chamber for consumption.

In some embodiments, the electrolytic cell comprises a catholyte chamber. The catholyte chamber may be in fluid communication with at least a portion of the cathode (e.g., the cathode may be at least partially submerged in catholyte that is present in the catholyte chamber). At least a portion (or all) of the cathode may be located within the catholyte chamber. In the embodiments shown in FIGS. 2A-2C, cathode 126 is submerged in catholyte in catholyte chamber 120.

In some embodiments, the catholyte chamber and the anolyte chamber are separated by at least one separator (e.g., comprising a membrane and/or diaphragm). In some embodiments, the separator is not ion-selective. For example, the separator may comprise a porous media and separate the electrolyte compartments by limiting convective flow and/or molecular diffusion, without substantial (or any) ion selectivity. However, in some embodiments, the separator is ion-selective. For example, in some embodiments, the catholyte chamber and the anolyte chamber are separated by at least one ion-selective membrane (e.g., at least one ion-selective membrane, at least two ion selective membranes, or more). In this context, the separation refers to the membrane limiting or preventing transport of at least one type of ion from the catholyte chamber to the anolyte chamber or vice versa. Any of a variety of ion-selective membranes may be used. For example, the membrane may be a semi-permeable membrane (e.g., a semi-permeable polymer membrane, ceramic membrane, or combination thereof).

In some embodiments, at least one ion-selective membrane in the electrolytic cell comprises a cation-selective membrane. In some such embodiments, the aqueous electrolysis input stream is transported to the anolyte chamber. For example, in the embodiment shown in FIG. 2B, aqueous electrolysis input stream 116 comprising dissolved salt MX (e.g., NaCl, KCl, and/or LiCl) is transported to anolyte chamber 121 via liquid inlet 119, and cations M+ (e.g., sodium ions, potassium ions, and/or lithium ions) migrate through cation-selective membrane 129 from anolyte chamber 121 to catholyte chamber 120. Cation M+helps maintain charge neutrality and can be expelled from catholyte chamber 120 as part of base-rich product solution 103 (e.g., as a counter-cation to electrogenerated basic species such as hydroxide ions).

In some embodiments, at least one ion-selective membrane in the electrolytic cell comprises an anion-selective membrane. In some such embodiments, the aqueous electrolysis input stream is transported to the catholyte chamber. For example, in the embodiment shown in FIG. 2A, aqueous electrolysis input stream 116 comprising dissolved salt MX (c.g., NaCl, KCl, and/or LiCl) is transported to catholyte chamber 120 via liquid inlet 119, and anions X⁻(e.g., halide ions such as chloride ions; sulfate ions; nitrate ions; phosphate ions) migrate through anion-selective membrane 130 from catholyte chamber 120 to anolyte chamber 121. Anion X helps maintain charge neutrality and can be expelled from anolyte chamber 121 as part of acid-rich product solution 104 (e.g., as a counter-anion to electrogenerated acidic species such as protons/hydronium ion or to other cations that may be present).

In some embodiments, the electrolytic cell further comprises an electrolyte chamber other than the catholyte chamber and the anolyte chamber. The electrolyte chamber may be separated from the catholyte chamber by a cation selective membrane. For example, in FIG. 2C, electrolyte chamber 122 is separated from catholyte chamber 120 by cation-exchange membrane 129, where cations M+ (e.g., sodium ions, potassium ions, and/or lithium ions) can migrate from electrolyte chamber 122 to catholyte chamber 120. In some embodiments, the electrolyte chamber is separated from the anolyte chamber by an anion exchange membrane. For example, in FIG. 2C, electrolyte chamber 122 is separated from anolyte chamber 121 by anion-exchange membrane 130, where anions X can migrate from electrolyte chamber 122 to anolyte chamber 121. In some embodiments in which there is an electrolyte chamber separated from the anolyte chamber and the catholyte chamber in the electrolytic cell, the aqueous electrolysis input stream comprising dissolved salt is transported to that electrolyte chamber (e.g., via one of the electrolysis assembly inlets). For example, in FIG. 2C, aqueous electrolysis input stream 116 comprising dissolved salt MX (e.g., NaCl, KCl, and/or LiCl) is fed to electrolyte chamber 122 via liquid inlet 119. In some embodiments, the electrolyte chamber is in fluid communication with a liquid outlet. For example, in some embodiments, an aqueous electrolysis input stream comprising concentrated dissolved salt MX is transported via a liquid inlet to the electrolyte chamber, and an electrolyte outlet stream is output from the electrolyte chamber via a liquid outlet, with the electrolyte outlet stream having a lower concentration of dissolved MX than the aqueous electrolysis input stream (e.g., by a factor of at least 1.01, at least 1.02, at least 1.05, at least 1.1, at least 1.2, at least, 1.5, at least 2, at least 5, at least 10, at least 20, and/or up to 50, up to 100, or more). Combinations of these ranges (e.g., at least 1.01 and less than or equal to 100, at least 1.01 and less than or equal to 5) are possible. As an illustrative example, if an electrolyte outlet stream has a concentration of dissolved MX of 0.2 M and the aqueous electrolysis input stream has a concentration of MX of 1.0 M, then the electrolyte outlet stream has a concentration of MX that is lower than that of the aqueous input stream by a factor of 5 because 0.2 M times 5 equals 1.0 M.

Non-limiting examples of suitable electrolysis assembly and electrolytic cell configurations for at least some embodiments are described in U.S. Pat. No. 7,790,012 by Kirk et al., issued Sep. 7, 2010, which is incorporated herein by reference in its entirety for all purposes.

While the hydrogen evolution and hydrogen oxidation half-cell reactions are described in detail above and below (and can present certain advantages), those reactions are illustrative, and other chemistries may be employed in certain embodiments. For example, the electrolytic assembly may be configured to perform water electrolysis, where the hydrogen evolution reaction at the cathode is coupled to the oxygen evolution reaction at the anode. As another example, the electrolytic assembly may be configured to perform the oxygen reduction reaction at the cathode and one or more of the hydrogen oxidation reaction, the chlorine gas (Cl2) evolution reaction, or the oxygen evolution reaction at the anode. As yet another example, the electrolytic assembly may be configured to perform a carbon dioxide reduction at the cathode and the oxygen evolution reaction at the anode.

In some embodiments, the electrolysis cell is configured to be operated as an electrodialysis cell. The cathode electrolysis and anode electrolysis half-reactions in an electrolytic cell configured as an electrodialysis cell may create electric fields that drive separation of cations and anions (e.g., using semi-permeable membranes such as ion-selective membranes). In some embodiments, the electrolytic cell comprises a cathode, an anode, and two or more semi-permeable membranes (e.g., two or more ion-selective membranes) separating the cathode and the anode. In some embodiments, the electrolysis cell comprises a bipolar membrane as at least one of the semi-permeable membranes. A bipolar membrane may comprise an anion-selective membrane layer and a cation-selective membrane layer configured to create a junction at an interface between the anion-selective membrane layer and the cation-selective membrane layer (e.g., upon being pressed together). The bipolar membrane may be configured to promote dissociation of water at the junction to form protons (e.g., as hydronium cations) and hydroxide anions. In some, but not necessarily all embodiments, the bipolar membrane comprises a water dissociation catalyst, which may enhance the rate of water dissociation.

FIG. 2D shows a schematic cross-sectional diagram of an embodiment in which electrolytic cell 102 is configured as an electrodialysis cell comprising bipolar membrane 141. Application of an electrical potential difference across electrolytic cell 102 may initiate a cathode electrolysis half reaction at cathode 126 and an anode half reaction at anode 125 of electrolytic cell 102. The cathode electrolysis half reaction may generate negative charge near cathode 126, thereby generating an electric field attracting cations. The anode electrolysis half reaction may generate positive charge near anode 125, thereby generating an electric field attracting anions. Bipolar membrane 141 comprises cation-selective membrane 129a and anion-selective membrane 130a configured to dissociate water into H⁺ and OH⁻. The dissociated H⁺ may diffuse from cation-selective membrane 129a of bipolar membrane 141 toward cathode 126, while the dissociated OH⁻ may diffuse from anion-selective membrane 130a toward anode 125. Additionally, anion-selective membrane 130b may separate cation-selective membrane 129a and cathode 126, thereby reducing or stopping transport of the diffusing H⁺ toward cathode 126 while permitting dissolved anion X⁻ from dissolved salt MX (e.g., NaCl) to cross anion-selective membrane 130b in the opposite direction. As a result, a product solution comprising dissolved HX may be formed in the space between anion-selective membrane 130b and cation-selective membrane 129a. Such a product solution may form some or all of an anolyte product stream (e.g., an acid-rich product solution) output by electrolytic cell 102.

Meanwhile, in FIG. 2D, cation-selective membrane 129b may separate anion-selective membrane 130a and anode 125, thereby reducing or stopping transport of the diffusing OH⁻ toward anode 125 while permitting dissolved metal cation M⁺ from dissolved salt MX (e.g., NaCl) to cross cation-selective membrane 129b in the opposite direction. As a result, a product solution comprising dissolved MOH may be formed in the space between cation-selective membrane 129b and anion-selective membrane 130a. Such a product solution may form some or all of the base-rich product solution output by electrolytic cell 102.

FIG. 2E shows a schematic cross-sectional illustration of another embodiment in which electrolytic cell 102 is configured as an electrodialysis cell, but without use of a separate anion-selective membrane in addition to that in bipolar membrane 141. As before, the dissociated H⁺ may diffuse from cation-selective membrane 129a of bipolar membrane 141 toward cathode 126, while the dissociated OH− may diffuse from anion-selective membrane 130a toward anode 125. The diffusing H⁺ may become exposed to solution comprising X⁻ from dissolved salt MX (e.g., NaH₂PO₄). As a result, a product solution comprising dissolved HX (e.g., H₃PO₄) may be formed on the side of cation-selective membrane 129a closest to cathode 126. Such a product solution may form some or all of a product stream (e.g., an acid-rich product solution) output by electrolytic cell 102.

Meanwhile, in FIG. 2E, cation-selective membrane 129b may separate anion-selective membrane 130a and anode 125, thereby reducing or stopping transport of the diffusing OH toward anode 125 while permitting dissolved metal cation M₊ from dissolved salt MX (e.g., NaH₂PO₄) to cross cation-selective membrane 129b in the opposite direction. As a result, a product solution comprising dissolved MOH (e.g., NaOH) may be formed in the space between cation-selective membrane 129b and anion-selective membrane 130a. Such a product solution may form some or all of the base-rich product solution output by electrolytic cell 102.

The arrangements of ion-selective membranes shown in FIGS. 2D-2E may be repeated any of a variety of times to form a stack between the cathode, which may be at one end of a stack, and the anode, which may be at the opposite end of the stack.

In some embodiments, the cathode electrolysis half reaction of the electrodialysis cell is the hydrogen evolution reaction. In some embodiments, the cathode electrolysis half reaction of the electrodialysis cell is the oxygen reduction reaction. In some embodiments, the cathode electrolysis half reaction of the electrodialysis cell is a carbon dioxide reduction reaction. In some embodiments, the anode electrolysis half reaction of the electrodialysis cell is the hydrogen oxidation reaction. In some embodiments, the anode electrolysis half reaction of the electrodialysis cell is the oxygen evolution reaction. In some embodiments, the cathode electrolysis half reaction of the electrodialysis cell is the hydrogen evolution reaction and the anode electrolysis half reaction is the oxygen evolution reaction. In some embodiments, the cathode electrolysis half reaction of the electrodialysis cell is the hydrogen evolution reaction and the anode electrolysis half reaction is the hydrogen oxidation reaction. In some embodiments, the cathode electrolysis half reaction of the electrodialysis cell is the oxygen reduction reaction and the anode electrolysis half reaction is the oxygen evolution reaction. In some embodiments, the cathode electrolysis half reaction of the electrodialysis cell is a carbon dioxide reduction reaction and the anode electrolysis half reaction is the oxygen evolution reaction. In some embodiments, the cathode electrolysis half reaction of the electrodialysis cell is the oxygen reduction reaction and the anode electrolysis half reaction is the hydrogen oxidation reaction.

In some embodiments, the cathode electrolysis half reaction of the electrolytic cell (e.g., in the catholyte chamber) is the hydrogen evolution reaction. In some embodiments, the cathode electrolysis half reaction of the electrolytic cell (e.g., in the catholyte chamber) is the oxygen reduction reaction. In some embodiments, the cathode electrolysis half reaction of the electrolytic cell (e.g., in the catholyte chamber) is a carbon dioxide reduction reaction. In some embodiments, the anode electrolysis half reaction of the electrolytic cell (e.g., in the anolyte chamber) is the hydrogen oxidation reaction. In some embodiments, the anode electrolysis half reaction of the electrolytic cell (e.g., in the anolyte chamber) is the oxygen evolution reaction. In some embodiments, the cathode electrolysis half reaction of the electrolytic cell (e.g., in the catholyte chamber) is the hydrogen evolution reaction and the anode electrolysis half reaction (e.g., in the anolyte chamber) is the oxygen evolution reaction. In some embodiments, the cathode electrolysis half reaction of the electrolytic cell (e.g., in the catholyte chamber) is the hydrogen evolution reaction and the anode electrolysis half reaction (e.g., in the anolyte chamber) is the hydrogen oxidation reaction. In some embodiments, the cathode electrolysis half reaction of the electrolytic cell (e.g., in the catholyte chamber) is the oxygen reduction reaction and the anode electrolysis balf reaction (e.g., in the anolyte chamber) is the oxygen evolution reaction. In some embodiments, the cathode electrolysis half reaction of the electrolytic cell (e.g., in the catholyte chamber) is a carbon dioxide reduction reaction and the anode electrolysis half reaction (e.g., in the anolyte chamber) is the oxygen evolution reaction. In some embodiments, the cathode electrolysis half reaction of the electrolytic cell (e.g., in the catholyte chamber) is the oxygen reduction reaction and the anode electrolysis half reaction (e.g., in the anolyte chamber) is the hydrogen oxidation reaction. In some such embodiments, employing the oxygen reduction reaction and the hydrogen oxidation reaction as the respective half-reactions in the cathode and anode can facilitate the generation of electricity in a system capable of capturing and in some instances releases carbon dioxide.

As discussed above, a base-rich product solution may be formed as a result of the one or more reactions performed via the electrolytic cell. For example, in FIGS. 1A-1D, at least a portion of base-rich product solution is output from electrolysis assembly 101 as stream 103. The base-rich product solution may be formed, for example, in the catholyte chamber of the electrolytic cell. The base-rich product solution may be formed using a batch, semi-batch, or continuous process involving the electrolytic cell.

The base-rich product solution may comprise electrogenerated basic species. The electrogenerated basic species may be dissolved in an aqueous solution. The electrogenerated basic species may be a direct or indirect product of the one or more chemical reactions performed in the electrolysis assembly. The electrogenerated basic species may be a source of alkalinity for the solution. For example, the electrogenerated basic species may be a species whose conjugate acid has a relatively high pKa. The basic species may have a conjugate acid having a pKa of greater than or equal to 10, greater than or equal to 10.3, greater than or equal to 10.5, greater than or equal to 11, greater than or equal to 12, greater than or equal to 14, greater than or equal to 15, and/or up to 15.7, up to 16, or greater in water at a temperature of 298 K. Combinations of these ranges are possible. In some embodiments, the electrogenerated basic species comprises hydroxide ions (OH⁻). One way in which the hydroxide ions may be generated is from the hydrogen evolution reaction (e.g., in the catholyte chamber). As another example, the electrogenerated species may comprise carbonate ions (CO₃²⁻). The carbonate ions may be generated from deprotonation of dissolved carbonic acid (from dissolved carbon dioxide) by electrogenerated hydroxide ions, either in the catholyte chamber or in a different component of the system.

When a specific type of molecule or ion (e.g., a basic species) is described as being “generated” from or “electrogenerated from” a particular material and/or stream via a chemical reaction (e.g., a chemical reaction as described above), the specific ions/molecules (e.g., of the basic species) contained within a different material (e.g., a base-rich product solution) may not be literally the exact same ions/molecules of the basic species directly produced by the chemical reaction (e.g., the electrochemical reactions discussed above), as those generated (e.g., electrogenerated) ions/molecules may undergo, for example, one or more proton transfers with other species in solution to create equivalent species. For example, a first hydroxide ion generated at an electrode of the electrochemical cell may later deprotonate a first neutral water molecule in the base-rich product solution to generate a second hydroxide ion and a second neutral water molecule, and so the composition of the base-rich product solution would be unchanged. If the second, equivalent hydroxide ion (or a third, equivalent hydroxide ion from yet another proton transfer, and so on) then participated in a later step of the process (e.g., if the second, equivalent hydroxide ion was exposed to carbon dioxide from an input gas stream), then that would still be considered participation of the generated (e.g., electrogenerated) species in the later step of the process (e.g., exposure of an electrogenerated hydroxide ion to the carbon dioxide).

The basic species (e.g., hydroxide ions) may be present in the base-rich product solution in a relatively high concentration (which may promote effective carbon dioxide capture, lithium hydroxide production, and/or metal cation impurity removal elsewhere in the system). It should be understood that the name “base-rich product solution” is used for convenience in identifying the solution, and is not meant to imply any particular absolute or relative concentration of base in the solution. In some embodiments, the basic species (e.g., hydroxide ions) is present in the base-rich product solution at a concentration of greater than or equal to 0.1 M, greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, or greater. Combinations of these ranges (e.g., greater than or equal to 0.1 M and less than or equal to 10 M, or greater than or equal to 1 M and less than or equal to 10 M) are possible.

In some embodiments, the molar ratio of the concentration of the basic species (e.g., hydroxide ions) in the base-rich product solution to the concentration of the basic species in the stream fed to the catholyte compartment (e.g., the aqueous electrolysis input stream or a different electrolyte stream) is at least 1.005, at least 1.01, at least 1.05, at least 1.1, at least 1.2, at least 1.5, at least 2, at least 5, at least 10, at least 50, at least 100, at least 1000, at least 10,000, at least 100,000, at least 1,000,000, at least 10,000,000, and/or up to 100,000,000, up to 1,000,000.000, or more. Combinations of these ranges (e.g., at least 1.005 and less than or equal to 1,000,000,000, or at least 1.01 and less than or equal to 1.000,000) are possible.

In some embodiments, the base-rich product solution has a relatively high pH. For example, in some embodiments, the base-rich product solution has a pH of greater than or equal to 8, greater than or equal to 9, greater than or equal to 10, greater than or equal to 11, greater than or equal to 12, greater than or equal to 13, greater than or equal to 14, and/or up to 15, up to 16, or greater. Combinations of these ranges are possible.

In some embodiments, the base-rich product solution comprises at least some of the cations (e.g., the metal cations and/or ammonium cations discussed above). In some embodiments, the base-rich product solution comprises at least some of the non-lithium metal cations (e.g., sodium ions and/or potassium ions). In some embodiments, the base-rich product solution comprises at least some of the lithium cations (e.g., either as the sole cations or in combination with other cations such as the non-lithium metal cations). The cations (e.g., non-lithium metal cations and/or lithium cations) may be from the aqueous electrolysis input stream. The cations in the base-rich product solution may constitute at least a portion (e.g., at least 0.05 mol %, at least 0.1 mol %, at least 0.5 mol %, at least 1 mol %, at least 2 mol %, at least 5 mol %, at least 10 mol %, at least 25 mol %, and/or up 50 mol %, up 75 mol %, up 90 mol %, up to 95 mol %, up to 98 mol %, up to 99 mol %, or more) of the cations in the aqueous electrolysis input stream. For example, an aqueous input solution comprising dissolved MX (e.g., NaCl, KCl, and/or LiCl) may be transported to the electrolytic cell, and a base-rich product solution comprising dissolved MOH (e.g., NaOH, KOH, and/or LiOH) may be produced by the electrolytic cell.

At least a portion (e.g., at least 1 wt %, at least 2 wt %, at least 5 wt %, at least 10 wt %, at least 25 wt %, at least 50 wt %, at least 75 wt %, at least 90 wt %, at least 95 wt %, at least 98 wt %, at least 99 wt %, at least 99.9 wt %, or all) of the base-rich product solution may be transported (directly or indirectly) to the gas-liquid contact vessel. For example, the base-rich product solution may form at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of the contact vessel liquid inlet.

In the embodiment shown in FIGS. 1A-1D, for example, a liquid outlet of electrolysis assembly 101l (e.g., first liquid outlet 123 in FIGS. 2A-2C) is fluidically connected (e.g., directly or indirectly) to contact vessel liquid inlet 164) such that base-rich product solution 103 can be transported to contact vessel 131 as part of contact vessel liquid inlet stream 106.

As discussed above, an acid-rich product solution may be formed as a result of the one or more reactions performed via the electrolytic cell. For example, in FIGS. 1A-1D, at least a portion of acid-rich product solution is output from electrolysis assembly 101 as stream 104. The acid-rich product solution may be formed, for example, in the anolyte chamber of the electrolytic cell. The acid-rich product solution may be formed using a batch, semi-batch, or continuous process involving the electrolytic cell. The acid-rich product solution may comprise electrogenerated acidic species. The electrogenerated acid species may be produced directly at an electrode of the electrolytic cell or may be produced indirectly as the result of a chemical reaction induced by one or more electrochemical reactions (e.g., a hydronium cation generated at an electrode as the result of a hydrogen oxidation half-reaction may diffuse and protonate an anion present in an anolyte, thereby forming electrogenerated an acidic species). The electrogenerated acidic species may be dissolved in an aqueous solution. The electrogenerated acidic species may be a direct or indirect product of the one or more chemical reactions performed in the electrolysis assembly. The electrogenerated acidic species may be a source of acidity for the solution. For example, the electrogenerated acidic species may have a relatively low pKa. The acidic species may have a pKa of less than or equal to 7, less than or equal to 6, less than or equal to 5, less than or equal to 4, less than or equal to 3, less than or equal to 2.5, less than or equal to 2, less than or equal to 1. less than or equal to 0, less than or equal to −1, and/or as low as −1.7, as low as −2, or less in water at a temperature of 298 K. Combinations of these ranges are possible. In some embodiments, the electrogenerated acidic species comprises hydronium ions (H₃O⁺). One way in which the hydronium ions may be generated is from the hydrogen oxidation reaction (e.g., in the anolyte chamber). The protons generated by the hydrogen oxidation reaction protonate water molecules, thereby forming the hydronium ions. As another example, the electrogenerated acidic species may comprise a weak acid. The weak acid may be, for example, an organic weak acid. Examples of organic weak acids include, but are not limited to acetic acid, acrylic acid, benzoic acid, chloroacetic acid, citric acid, dichloroacetic acid, formic acid, hexanoic acid, maleic acid, malic acid, malonic acid, heptanoic acid, octanoic acid, oxalic acid, phthalic acid, picric acid, succinic acid, and/or trichloroacetic acid. In some embodiments, the weak acid is an inorganic weak acid. Examples of inorganic weak acids include, but are not limited to boric acid, chromic acid, perchloric acid, periodic acid, phosphoric acid, dihydrogen phosphate (e.g., as dissolved alkali dihydrogen phosphate such as dissolved potassium dihydrogen phosphate), pyrophosphoric acid, sulfurous acid, and/or tetraboric acid.

The weak acid may be a weak Bronsted Lowry acid present in its protonated form but with a sufficiently high acidity to ultimately drive acid-base equilibria for carbon dioxide release (e.g., in a downstream process). For example, the acidic species may comprise phosphoric acid (H₃PO₄). The phosphoric acid may be generated from protonation of dissolved dihydrogen phosphate by electrogenerated hydronium ions, either in the anolyte chamber or in a different component of the system. As another example, the acidic species may comprise dihydrogen phosphate (H₂PO₄). The dihydrogen phosphate may be generated from protonation of dissolved monohydrogen phosphate by electrogenerated hydronium ions, either in the anolyte chamber or in a different component of the system. As yet another example, the acidic species may comprise boric acid (H₃BO₃). The boric acid may be generated from protonation of dissolved dihydrogen borate by electrogenerated hydronium ions, either in the anolyte chamber or in a different component of the system. As yet another example, the acidic species may comprise acetic acid. The acetic acid may be generated from protonation of dissolved acetate by electrogenerated hydronium ions, either in the anolyte chamber or in a different component of the system. As yet another example, the acidic species may comprise benzoic acid. The benzoic acid may be generated from protonation of dissolved benzoate by electrogenerated hydronium ions, either in the anolyte chamber or in a different component of the system. As yet another example, the acidic species may comprise formic acid. The formic acid may be generated from protonation of dissolved formate by electrogenerated hydronium ions, either in the anolyte chamber or in a different component of the system.

The acidic species (e.g., hydronium ions) may be present in the acid-rich product solution in a relatively high concentration. It should be understood that the name “acid-rich product solution” is used for convenience in identifying the solution, and is not meant to imply any particular absolute or relative concentration of acid in the solution. In some embodiments, the acidic species (e.g., hydronium ions) is present in the acid-rich product solution at a concentration of greater than or equal to 0.000001 M, greater than or equal to 0.00001 M, greater than or equal to 0.0001 M, greater than or equal to 0.001 M, greater than or equal to 0.01 M, greater than or equal to 0.02 M greater than or equal to 0.05 M, greater than or equal to 0.1 M, greater than or equal to 0.2 M, greater than or equal to 0.5 M, greater than or equal to 1 M, and/or up to 1.5 M, up to 2 M, up to 3 M, or greater. In some embodiments, the acidic species (e.g., hydronium ions) is present in the acid-rich product solution at a concentration of greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges (e.g., greater than or equal to 0.05 M and less than or equal to 3 M, greater than or equal to 0.1 and less than or equal to 2 M) are possible. Another example of a combination of these ranges is greater than or equal to 0.000001 M and less than or equal to 3 M. In some embodiments, the molar ratio of the concentration of the acidic species (e.g., hydronium ions) in the acid-rich product solution to the concentration of the acidic species in the stream fed to the anolyte compartment (e.g., the aqueous electrolysis input stream or a different electrolyte stream) is at least 1.005, at least 1.01, at least 1.05, at least 1.1, at least 1.5, at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges (e.g., at least 1.005 and less than or equal to 1,000,000,000, or at least 1.01 and less than or equal to 1,000,000) are possible.

In some embodiments, the acid-rich product solution has a relatively low pH. For example, in some embodiments, the acid-rich product solution has a pH of less than or equal to 6, less than or equal to 5, less than or equal to 4, less than or equal to 3, less than or equal to 2, less than or equal to 1, less than or equal to 0, and/or as low as −1, as low as −2, or lower. Combinations of these ranges are possible.

In some embodiments, the acid-rich product solution comprises at least some of the anions (e.g., non-hydroxide anions such as the halide, sulfate, nitrate, and/or phosphate anions discussed above). The anions may be from the aqueous electrolysis input stream (and in some instances, ultimately from the aqueous lithium source stream). For example, the anions in the acid-rich product solution may constitute at least a portion (e.g., at least 0.05 mol %, at least 0.1 mol %, at least 0.5 mol %, at least 1 mol %, at least 2 mol %, at least 5 mol %, at least 10 mol %, at least 25 mol %, and/or up 50 mol %, up 75 mol %, up 90 mol %, up to 95 mol %, up to 98 mol %, up to 99 mol %, or more) of the anions in the aqueous electrolysis input stream. For example, an aqueous input solution comprising dissolved MX (e.g., NaCl, KCl, and/or LiCl) may be transported to the electrolytic cell, and an acid-rich product solution comprising dissolved HX (e.g., HCl) may be produced by the electrolytic cell.

As noted above, at least a portion of the base-rich product solution may be exposed to carbon dioxide. In some such embodiments, such as those in which the lithium depleted stream comprises at least a portion of the base-rich product solution, the exposure of at least a portion of the base-rich stream to carbon dioxide comprises exposing at least a portion of the lithium depleted stream to the carbon dioxide (e.g., by transporting at least a portion of the lithium depleted stream to the gas-liquid contact vessel that receives carbon dioxide). The carbon dioxide may be captured via one or more acid-base equilibrium reactions to form carbonate anions and/or bicarbonate anions, e.g., based on exposure to basic species. In some, but not necessarily all embodiments, at least some of the basic species are electrogenerated (e.g., directly or indirectly). Electrical generation of basic species (e.g., hydroxide ions) may advantageously involve inexpensive and/or environmentally friendly reagents and/or relatively low energetic inputs. However, in some embodiments, at least some of the basic species are provided without use of an electrochemical process. For example, the basic species may be provided as chemical reagents acquired separately (e.g., commercially) and/or generated from one or more other processes (e.g., chemical processes performing thermal rather than electrochemical reactions).

The basic species (e.g., in the base-rich product solution and/or lithium depleted stream) may be exposed to carbon dioxide from an input gas stream in a gas-liquid contact vessel. This exposure may result in the capture of the carbon dioxide and, in some instances, formation of a carbon dioxide-lean output gas stream and a capture stream comprising carbonate anions formed from the captured carbon dioxide. The capture stream may further comprise hydroxide anions, such as hydroxide ions not neutralized during the conversion of carbon dioxide to carbonate (e.g., due to stoichiometric excess or thermodynamic/kinetic factors). The capture stream may form some or all of the metal cation impurity salt precipitation stream, as discussed below.

In some embodiments, carbon dioxide from an input gas stream is captured. The capture of the carbon dioxide may be induced by exposure of the carbon dioxide to a relatively high pH solution (e.g., due to the presence of the basic species). In some embodiments, at least some (e.g., at least 5 mol %, at least 10 mol %, at least 25 mol %, at least 50 mol %, at least 75 mol %, at least 90 mol %, at least 95 mol %, at least 98 mol %, at least 99 mol %, or more) of the basic species (e.g., electrogenerated basic species) from a base-rich product solution are exposed to carbon dioxide from the input gas stream. As an example, in FIGS. 1A-1D, contact vessel liquid inlet stream 106 comprising basic species and input gas stream 105 are each input into gas-liquid contact vessel 131, where the presence of the basic species, via one or more acid-base equilibrium reactions, induces the removal of carbon dioxide from input gas stream 105 to form the carbon dioxide-lean output gas stream 107 and capture stream 108. In some embodiments, the contact vessel liquid inlet stream comprises at least a portion (e.g., at least 1 mol %, at least 2 mol %, at least 5 mol %, at least 10 mol %, at least 25 mol %, at least 50 mol %, at least 75 mol %, at least 90 mol %, at least 95 mol %, at least 98 mol %, at least 99 mol %, at least 99.9 mol % or more, or all) of the base-rich product solution. For example, in the embodiment shown in FIGS. 1A-1D, contact vessel liquid inlet stream 106 comprising at least a portion of base-rich product solution 103 (e.g., via one or more intermediate treatment steps) and input gas stream 105 are each input into gas-liquid contact vessel 131, where the presence of the electrogenerated basic species induces, via one or more acid-base equilibrium reactions, the removal of carbon dioxide from input gas stream 105 to form the carbon dioxide-lean output gas stream 107 and capture stream 108.

In some embodiments, the contact vessel liquid inlet stream comprises at least a portion (e.g., at least 1 mol %, at least 2 mol %, at least 5 mol %, at least 10 mol %, at least 25 mol %, at least 50 mol %, at least 75 mol %, at least 90 mol %, at least 95 mol %, at least 98 mol %, at least 99 mol %, at least 99.9 mol % or more, or all) of the lithium depleted stream formed by the removal of the lithium-rich phase. For example, in the embodiment shown in FIGS. 1A-1D, contact vessel liquid inlet stream 106 comprising at least a portion of lithium depleted stream 211 (e.g., comprising non-lithium metal cations such as sodium cations and/or potassium cations) and input gas stream 105 are each input into gas-liquid contact vessel 131, where the presence of the electrogenerated basic species (e.g., hydroxide ions) in lithium depleted stream 211 induces, via one or more acid-base equilibrium reactions, the removal of carbon dioxide from input gas stream 105 to form the carbon dioxide-lean output gas stream 107 and capture stream 108

The acid-base equilibria driving removal of carbon dioxide via exposure of carbon dioxide to the basic species may proceed as follows:

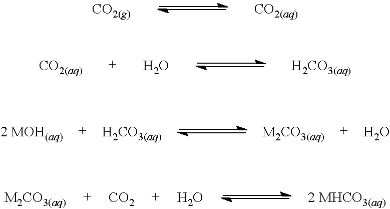 [SMILES: O ; "H2CO3(aq)" ; O ; "CO2" ; O]

where MOH corresponds to dissolved cation and hydroxide. Here, the hydroxide drives deprotonation of carbonic acid to form carbonate ions thereby converting carbon dioxide from a gas to a dissolved species in a liquid solution. It should be understood that while the chemical reactions shown above include double arrows for equilibrium reactions and are referred to in various places of this disclosure as acid-base equilibria, the methods described in this disclosure may be operated under conditions such that some or all of these reactions proceed without being at chemical equilibrium (e.g., due to mass transfer of species between different phases).

Any of a variety of gas streams may be employed as the input gas stream. In some embodiments, the input gas stream is or is derived from air (e.g., ambient air). In such a way, the methods and systems of this disclosure may be used to perform direct air capture of carbon dioxide (and in some instances couple that direct air capture to the production of a lithium containing material such as lithium hydroxide and/or lithium carbonate). In some embodiments, the input gas is from a point source of carbon dioxide (e.g., industrial effluent). The point source of carbon dioxide may be a single location (e.g., a power plant, factory, and/or industrial facility) that emits carbon dioxide, as opposed to diffuse, atmospheric carbon dioxide present in ambient air. For example, the input gas stream may comprise or be derived from flue gas. In such a way, the methods and systems of this disclosure may be used to perform direct carbon capture. In some embodiments, the point source comprises a power plant, a cement production facility, a steel production facility, an aluminum production facility, a steam methane reforming facility, an autothermal reforming facility, a natural gas wellhead, a natural gas pipeline, a paper mill, and/or a Haber-Bosch facility (which catalytically produces NH3 from H₂ and N₂). While the input gas stream may be referred to as a stream, this is not to imply any particular flow rate or type of flow path for the stream. For example, the system may intake gas (e.g., ambient air) surrounding the system, and/or or gas may be flowed (e.g., at ambient or an elevated pressure) through a conduit into, for example, the gas-liquid contact vessel.

In some embodiments, the input gas stream comprises carbon dioxide in an amount of less than or equal to 200,000 ppm. In some embodiments, the input gas stream comprises carbon dioxide in an amount of less than or equal to 500,000 ppm, less than or equal to 200,000 ppm, less than or equal to 100,000 ppm, less than or equal to 50,000 ppm, less than or equal to less than or equal to 20,000 ppm, less than or equal to 10,000 ppm, less than or equal to 5,000 ppm, less than or equal to 1,000 ppm, less than or equal to 600 ppm, less than or equal to 500 ppm, and/or as low as 400 ppm, as low as 300 ppm, as low as 100 ppm, or less by volume. Combinations of these ranges (e.g., less than or equal to 100,000 ppm and as low as 100 ppm, or less than or equal to 1.000 ppm and as low as 100 ppm) are possible.

In some embodiments (e.g., where the method is performed for direct air capture), the input gas stream comprises carbon dioxide at a partial pressure of less than or equal to 0.5 bar, less than or equal to 0.2 bar, less than or equal to 0.1 bar, less than or equal to 0.05 bar, less than or equal to 0.02 bar, less than or equal to 0.01 bar, less than or equal to 0.005 bar, less than or equal to 0.002 bar, less than or equal to 0.001 bar. and/or as low as 0.0005 bar, as low as 0.0002 bar, as low as 0.0001 bar, or less. Combinations of these ranges (e.g., less than or equal to 0.5 bar and as low as 0.0001 bar) are possible. In some embodiments (e.g., where the method is performed for point source carbon capture), the input gas stream comprises carbon dioxide at a partial pressure of greater than or equal to 0.002 bar, greater than or equal to 0.005 bar, greater than or equal to 0.01 bar, greater than or equal to 0.02 bar, greater than or equal to 0.05 bar, greater than or equal to 0.1 bar, greater than or equal to 0.2 bar, greater than or equal to 0.5 bar, greater than or equal to 1 bar, greater than or equal to 2 bar, greater than or equal to 5 bar, greater than or equal to 10 bar, and/or up to 20 bar, up to 30 bar, up to 40 bar, or more. Combinations of these ranges (e.g., greater than or equal to 0.002 bar and less than or equal to 40 bar) are possible.

In some embodiments, the input gas stream comprises carbon dioxide at a partial pressure of less than or equal to 40 bar, less than or equal to 30 bar, less than or equal to 20 bar, less than or equal to 10 bar, less than or equal to 5 bar, less than or equal to 2 bar, less than or equal to 1.5 bar, less than or equal to 1 bar, less than or equal to 0.5 bar, less than or equal to 0.2 bar, less than or equal to 0.1 bar, less than or equal to 0.05 bar, less than or equal to 0.002 bar, less than or equal to 0.001 bar, and/or as low as 0.0005 bar, as low as 0.0002 bar, as low as 0.0001 bar, or less. Combinations of these ranges (e.g., less than or equal to 40 bar and as low as 0.0001 bar) are possible.

As noted above, the interaction between the carbon dioxide and the basic species (e.g., via one or more acid-base equilibrium reactions) may produce a carbon dioxide-lean output gas stream. For example, in FIGS. 1A-1D, carbon dioxide-lean output gas stream 107 may be output from contact vessel gas outlet 132 of gas-liquid contact vessel 131. The carbon dioxide-lean output gas stream may have a relatively low concentration of carbon dioxide, which may be desirable (e.g., for reducing the carbon dioxide output of the lithium production process). In some embodiments, the carbon dioxide-lean output gas stream comprises carbon dioxide in an amount of less than or equal to 50,000 ppm, less than or equal to 25,000 ppm, less than or equal to 20,000 ppm, less than or equal to 10,000 ppm, less than or equal to 5,000 ppm, less than or equal to 1,000 ppm. less than or equal to 600 ppm, less than or equal to 500 ppm, less than or equal to 400 ppm, less than or equal to 300 ppm, less than or equal to 200 ppm, less than or equal to 100 ppm, less than or equal to 50 ppm. less than or equal to 20 ppm, less than or equal to ppm, less than or equal to 5 ppm, less than or equal to 1ppm, and/or as low as 0.5 ppm, as low as 0.1 ppm, as low as 0.01 ppm, or less by volume. Combinations of these ranges (e.g., greater than or equal to 0.01 ppm and less than or equal to 50,000 ppm, or greater than or equal to 1 ppm and less than or equal to 25,000 ppm) are possible.

The carbon dioxide-lean output gas stream may have a lower concentration of carbon dioxide than the input gas stream. In some embodiments, a relatively high percentage of carbon dioxide in the input gas stream is removed in forming the carbon dioxide-lean output gas stream. For example, in some embodiments, a molar ratio of the concentration of carbon dioxide in the input gas stream to the concentration of carbon dioxide in the carbon dioxide-lean output gas stream is at least 1.1, at least 1.3, at least 1.5, at least 2, at least 2.5, at least 5, at least 10, and/or up to 20, up to 50, up to 100, up to 1000, up to 10,000, up to 100,000, up to 1,000,000, up to 5,000,000, or more. Combinations of these ranges (e.g., at least 1.1 and less than or equal to 5,000,000, or at least 1.3 and less than or equal to 100) are possible. In some embodiments, a ratio of the number of moles of carbon dioxide in the input gas stream to the number of moles of carbon dioxide in the carbon dioxide-lean output gas stream is at least 1.1, at least 1.3, at least 1.5, at least 2, at least 2.5, at least 5, at least 10, and/or up to 20, up to 50, up to 100, up to 1000, up to 10,000, up to 100,000, up to 1,000,000, up to 5,000,000, or more. Combinations of these ranges (e.g., at least 1.1 and less than or equal to 5,000,000, or at least 1.3 and less than or equal to 100) are possible.

In some embodiments, the carbon dioxide-lean output gas stream is discharged from the system. However, in other embodiments, the carbon dioxide-lean output gas stream is transported to a different component of the system for further treatment (e.g., removal of additional contaminants and/or combination with other streams).

In some embodiments, the interaction between the carbon dioxide and the basic species (e.g., via one or more acid-base equilibrium reactions) produces a capture stream. For example, in FIGS. 1A-1D, capture stream 108 may be output from contact vessel liquid outlet 133 of gas-liquid contact vessel 131. The capture stream may comprise captured carbon dioxide in the form of, for example, dissolved carbonate anions formed from carbon dioxide (e.g., upon exposure to electrogenerated alkalinity in the form of basic species). The capture stream may have a relatively high concentration of dissolved carbonate anions and/or bicarbonate anions. For example, in some embodiments, the capture stream comprises dissolved carbonate anions at a concentration of greater than or equal to 0.1 M, greater than or equal to 0.2 M, greater than or equal to 0.5 M, greater than or equal to 1 M, and/or up to 1.5 M, up to 2 M, up to 3 M, up to 5 M or greater. Combinations of these ranges (greater than or equal to 0.1 M and less than or equal to 5 M, or greater than or equal to 0.5 M and less than or equal to 2 M) are possible. As another example, in some embodiments, the capture stream comprises dissolved bicarbonate anions at a concentration of greater than or equal to 0.1 M, greater than or equal to 0.2 M, greater than or equal to 0.5 M, greater than or equal to 1 M, and/or up to 1.5 M, up to 2 M, up to 3 M, up to 5 M or greater. Combinations of these ranges (greater than or equal to 0.1 M and less than or equal to 5 M, or greater than or equal to 0.5 M and less than or equal to 2 M) are possible. In some, but not necessarily all embodiments, the base-rich product solution is free of carbonate anions while the capture stream comprises carbonate anions. In some embodiments in which the base-rich product solution comprises carbonate anions, the molar ratio of the concentration of carbonate anions in the capture stream to the concentration of carbonate anions in the stream to which the carbon dioxide is exposed (e.g., the contact vessel liquid inlet stream, which may be formed from at least a portion of the base-rich product solution) is at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges are possible.

The capture stream may have a relatively high concentration of dissolved hydroxide anions. The hydroxide anions may be residual hydroxide anions not neutralized during conversion of carbon dioxide to carbonate anions and/or bicarbonate anions. In some embodiments, the capture stream comprises dissolved hydroxide anions at a concentration of greater than or equal to 0.0001 M, greater than or equal to 0.001 M, greater than or equal to 0.01 M, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges (greater than or equal to 0.0001 M and less than or equal to 3 M) are possible. In some embodiments, the molar ratio of the concentration of hydroxide anions in the stream to which the carbon dioxide is exposed (e.g., the contact vessel liquid inlet stream, which may be formed from at least a portion of the base-rich product solution and/or lithium depleted stream) to the concentration of hydroxide anions in the capture stream is at least 1.1, at least 1.5, at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges are possible.

In some embodiments, the capture stream has a relatively high pH. For example, in some embodiments, the capture stream has a pH of greater than or equal to 7, greater than or equal to 8. greater than or equal to 9, greater than or equal to 10, greater than or equal to 11. greater than or equal to 12, and/or up to 13, up to 14, or greater. Combinations of these ranges are possible.

In some embodiments, the capture stream comprises at least some non-proton cations (e.g., the metal cations and/or ammonium cations discussed elsewhere). In some embodiments, the capture stream comprises at least some of the non-lithium metal cations (e.g., sodium ions and/or potassium ions). The cations (e.g., non-lithium metal cations) may be from the base-rich product solution (e.g., from an electrolytic process, as described below). For example, the cations in the capture stream may constitute at least a portion (e.g., at least 25 mol %, at least 50 mol %, at least 75 mol %, at least 90 mol %, at least 95 mol %, at least 98 mol %, at least 99 mol %, or more) of the cations in the base-rich product solution and/or the lithium depleted stream. For example, a contact vessel inlet stream comprising dissolved MOH (e.g., NaOH) may be transported to the contact vessel, and a capture stream comprising dissolved M₂CO₃ (e.g., Na₂CO₃) may be produced by the contact vessel upon interaction (e.g., contacting and/or mixing) with the input gas stream.

In some embodiments, at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of the capture stream is transported out of the gas-liquid contact vessel. For example, in FIGS. 1A-1D, capture stream 108 is transported out of contact vessel liquid outlet 133 of gas-liquid contact vessel 131. In some embodiments, the capture stream transported out of the contact vessel forms at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of the metal cation impurity salt precipitation stream, as discussed below.

In some embodiments, the basic species (e.g., electrogenerated basic species) and the carbon dioxide from the input gas stream are exposed to each other in a gas-liquid contact vessel. For example, in FIGS. 1A-1D, gas-liquid contact vessel 131 receives (a) input gas stream 105 comprising carbon dioxide and (b) contact vessel liquid inlet stream 106, which comprises at least a portion of lithium depleted stream 211 (e.g., comprising at least a portion base-rich product solution 103) comprising basic species, such that the basic species can interact with the carbon dioxide as described above. In some embodiments in which the basic species is electrogenerated, at least a portion of the base-rich product solution is transported from an electrolysis assembly (described above) to the contact vessel by forming at least a portion of the contact vessel liquid inlet stream (e.g., via a fluidic connection between the first electrolysis assembly liquid outlet and the contact vessel liquid inlet). The input gas stream may be transported to the contact vessel via the contact vessel gas inlet. In some embodiments, the gas-liquid contact vessel is separate from the electrolysis assembly (e.g., separate from the electrolytic cell). This may permit the interaction between the carbon dioxide and the electrogenerated basic species to occur in a location separate from the electrolysis assembly (e.g., after expulsion of basic species from the electrolysis assembly).

Any of a variety of gas-liquid contact vessels may be employed. The gas-liquid contact vessel may comprise a gas-liquid contactor configured to promote mass and in some instances heat transfer between gas-phase species and liquid-phase species. In some embodiments, the contact vessel comprises a differential gas-liquid contactor. In other embodiments, the contact vessel comprises a stepwise gas-liquid contactor. Examples of types of gas-liquid contact vessels include, but are not limited to bubble columns, spray towers, cooling towers, packed columns, agitated vessels, plate columns, rotating disc contactors, Venturi tubes, and/or hollow fiber gas-liquid contactors. In some embodiments, the gas-liquid contact vessel comprises an interior volume in fluid communication with the gas inlet and the liquid inlet. The interior volume may permit contact between the input gas stream and the contact vessel inlet liquid stream. Contact between carbon dioxide from the input gas stream and liquid from the inlet liquid stream may result in the dissolution of at least some of the gaseous carbon dioxide. The dissolved carbon dioxide may then undergo the acid-base equilibria described above.

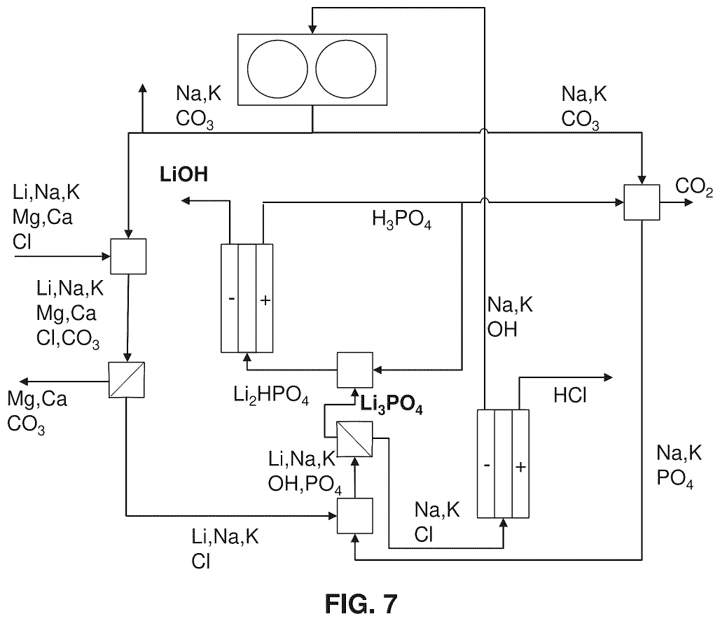

In embodiments involving the electrolysis of the aqueous electrolysis input stream (e.g., to generate the acid-rich product solution and the base-rich product solution), the exposure of the lithium ions from the aqueous lithium source stream to the lithium selective agent may occur upstream and/or downstream of the electrolysis. For example, referring back to FIGS. 1A-1D, the exposure of the lithium ions to the lithium selective agent is downstream of the electrolysis, with the lithium selective agent in stream 202 being exposed to lithium cations in the base-rich product stream 103 output by electrolytic cell 102 of electrolysis assembly 101. The embodiments in FIG. 7 and FIGS. 10-13 show non-limiting examples where exposure to the lithium selective agent occurs upstream of the electrolysis assembly such that a product stream from the exposure of the lithium selective agent to the lithium cations (e.g., comprising non-lithium metal cations but free of lithium cations or having a diminished concentration of lithium cations) is then transported to the electrolysis block.

In some embodiments, the aqueous electrolysis input stream comprises at least some of the lithium cations from the aqueous lithium source stream. For example in FIGS. 1A-1D, aqueous electrolysis input stream 116 comprises at least a portion of aqueous lithium source stream 201, in accordance with some embodiments. In some embodiments, the base-rich product solution produced by the electrolytic cell comprises at least some of the lithium cations from the aqueous lithium source stream. In some embodiments, the aqueous electrolysis input stream and the base-rich product solution each comprises at least some of the lithium cations from the aqueous lithium source stream. The lithium cations in the base-rich source stream may include at least some of the lithium cations in the aqueous electrolysis input stream (e.g., in instances where the aqueous electrolysis input stream is fed to the catholyte chamber and/or where the aqueous input stream is fed to a different chamber but the lithium cations are transported through a cation exchange membrane into the catholyte chamber where the base-rich product solution may be produced).

In some embodiments, the exposure of the lithium cations from the aqueous lithium source stream to the lithium selective agent (e.g., phosphate/phosphoric acid, a solid sorbent, and/or an organic liquid) comprises exposing at least a portion of the base-rich product solution to the lithium selective agent. As noted above, FIGS. 1A-1D show non-limiting examples where base-rich product solution (e.g., comprising lithium cations, non-lithium cations, and basic species such as hydroxide anions) in stream 103 is exposed to (e.g., mixed with) lithium selective agent in stream 202, thereby producing stream 203 comprising the lithium-rich phase (a lithium-enrichment output), which may subsequently be at least partially removed, thereby producing stream 204 comprising the removed lithium-rich phase and also producing lithium depleted stream 211. In some embodiments, the non-lithium cations are non-lithium metal cations. Accordingly, in some embodiments, the lithium depleted stream comprises at least a portion of the base-rich product solution.

In some embodiments, the aqueous input electrolysis comprises at least a portion of the lithium depleted stream. Some such embodiments involve those in which the exposure of the lithium cations in the aqueous lithium depleted stream to the lithium selective agent is performed upstream of the electrolysis assembly. For example, in FIG. 7, the stream comprising Li, Na, K, and Cl ions is exposed to the lithium selective agent (phosphate) to produce Li₃PO₄, which is removed to form the lithium depleted stream in the form of the stream comprising Na, K, Cl ions, which then forms the aqueous electrolysis input stream. FIGS. 10-13, described in more detail below, also show examples of embodiments in which the aqueous electrolysis input stream comprises at least a portion of the lithium depleted stream.

In some embodiments, one or more reactions are performed with the lithium-rich phase to produce (a) dissolved lithium cations and (b) regenerated lithium selective agent. For example, in some embodiments in which the lithium selective agent is H₃PO₄ and the lithium-rich phase is Li₃PO₄, the LiaPO₄ may be treated (e.g., with acid) to generate dissolved LiH₃PO₄ (thereby producing dissolved lithium cations). The dissolved LiH₂PO₄ may subsequently be further treated (e.g., electrolytically) to produce a dissolved lithium salt (e.g., in a first stream) and regenerated H₃PO₄ (e.g., in a second stream). FIGS. 3A-3B, FIG. 5, and FIG. 6 show examples of specific embodiments where such reactions are performed. As another example, in some embodiments in which the lithium selective agent is Al(OH)₃ and the lithium-rich phase is LiX·Al(OH)₃, the LiX·Al(OH)₃ may be treated with a solvent (e.g., water such as hot water, an organic solvent such as an alcohol (e.g., methanol), and/or an acidic solvent) to form dissolved LiX and Al(OH)₃ residue. The Al(OH)₃ residue may then be dissolved in HX solution to form AlX₃, which may be further treated with basic species such as hydroxide from the base-rich stream to regenerated Al(OH)₃. FIGS. 11-13 show examples of specific embodiments where such reactions are performed.

As another example, in some embodiments in which the lithium selective agent is an organic liquid and the lithium-rich phase is lithium cations dissolved in the organic liquid, organic liquid comprising the dissolved lithium cations may be treated with an acidic aqueous solution (e.g., comprising acidic species from the acid-rich product solution) to form (1) an aqueous stream comprising at least some of the dissolved lithium cations and (2) an organic liquid comprising at least some of the acidic species. The organic liquid comprising the acidic species may then be treated with an aqueous basic solution (e.g., comprising at least a portion of the base-rich product solution) to regenerate organic liquid that can be further employed as a lithium selective agent. FIG. 10 shows an example of a specific embodiment where such reactions are performed.

In some embodiments, at least some of the lithium selective agent used to generate the lithium-enrichment stream is regenerated lithium selective agent. The ability to regenerate lithium selective agent (e.g., using the processes described below) may increase system efficiency and reduce capital expenditures for the system (e.g., by reducing or eliminating the need to input fresh lithium selective agent into the system during operation). As one example, in FIGS. 1B-1D, lithium-rich phase (e.g., H₃PO₄) in stream 204 (the lithium-rich phase having been removed from stream 203) may be exposed to additional lithium selective agent (e.g., H₃PO₄) in stream 202, thereby generating a product in stream 205. Stream 205 may be fed as a second aqueous electrolysis input stream to second electrolytic cell 220, which may then generate dissolved lithium cations (e.g., dissolved lithium hydroxide) in stream 206 and regenerated lithium selective agent (e.g., H₃PO₄) in stream 202 such that the regenerated lithium selective agent can induce formation of further lithium-rich phase upon exposure to base-rich product solution in stream 103 output by first electrolytic cell 102.

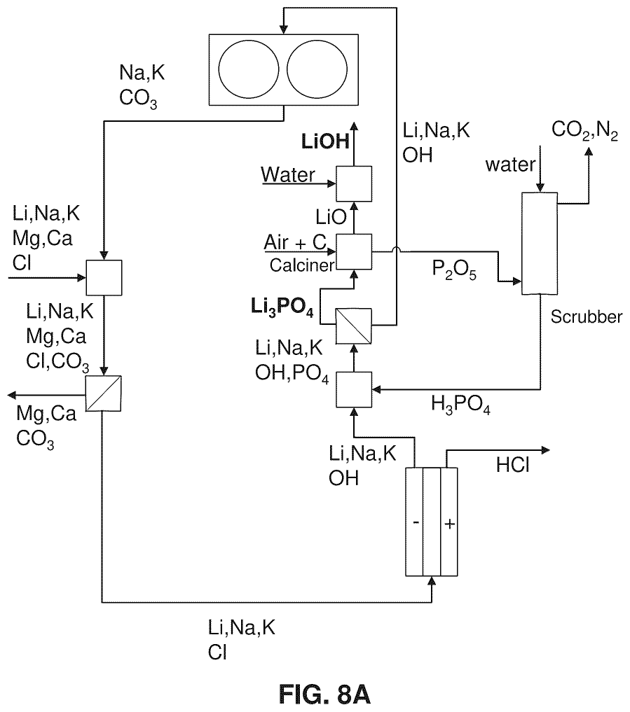

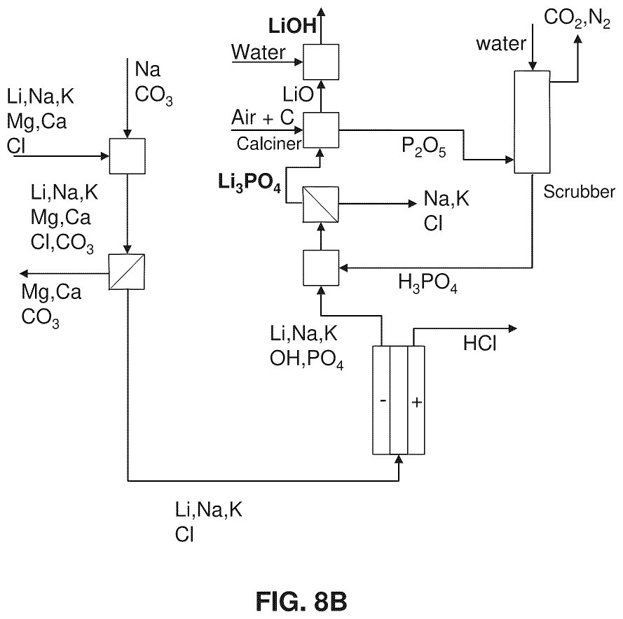

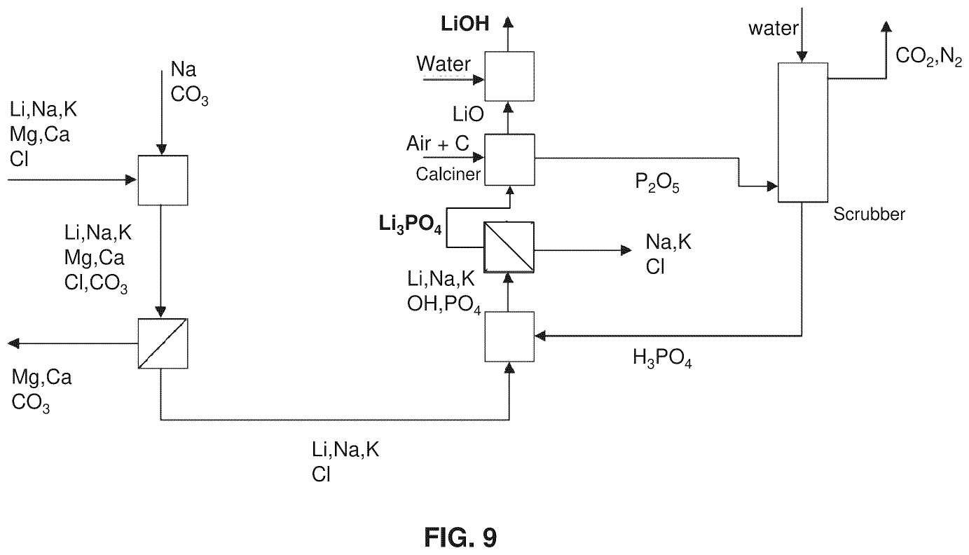

Any of a variety of techniques may be employed to regenerate lithium selective agent from the lithium-rich phase. In some embodiments, the one or more reactions performed to produce the dissolved lithium cations and the regenerated lithium selective agent comprise one or more electrolysis steps. In some such embodiments, a second electrolysis assembly comprising a second electrolytic cell may be employed. The second electrolytic cell may have the same or different configuration (e.g., compartment architecture, electrode types) as the earlier-described electrolytic cell (the “first” electrolytic cell), such as those described in FIGS. 2A-2C. In some embodiments, the one or more reactions performed to produce the dissolved lithium cations and the regenerated lithium selective agent comprise thermal steps (e.g., thermal steps combined with electrolysis steps, or in some instances solely thermal steps). One example of a thermal regeneration process for a lithium selective agent is where LiaPO₄ is calcined over carbon to form lithium oxide (LiO) and P₂O₅ gas. The LiO which may be converted to dissolved lithium hydroxide upon exposure to water, while the P₂O₅ gas may be exposed to water to regenerate phosphoric acid as a lithium selective agent. FIGS. 8A-8B and FIG. 9 show examples of specific embodiments where such reactions are performed.

As noted above, in some embodiments, lithium hydroxide (in solid and/or liquid-dissolved form) may be generated according to the methods of this disclosure. In some such embodiments, the lithium hydroxide comprises at least some of the lithium cations from the removed lithium-rich phase (e.g., the removed Li₃PO₄, the removed LiX·Al(OH)₃, and/or the removed extract stream comprising the organic liquid and the dissolved lithium cations). In some embodiments in which the lithium hydroxide is generated as a dissolved salt (e.g., in an aqueous solution), solid lithium hydroxide (e.g., lithium hydroxide monohydrate) may be obtained by removing at least some of the liquid (e.g., at least some of the water). One way to remove the liquid is to evaporate the liquid using any of a variety of known techniques. For example, the liquid may be removed via evaporation, filtering, and/or membrane-based separation.

In some embodiments, multiple electrolysis cells (e.g., as part of multiple electrolysis assemblies) are employed. In some such embodiments, the second electrolytic cell is operated to produce a second base-rich product solution comprising dissolved lithium cations. As one example, the second electrolytic cell may be operated to produce a second base-rich product solution comprising dissolved lithium cations and dissolved hydroxide anions (e.g., as dissolved LiOH salt). As specific non-limiting examples, in FIGS. 1B-1D, stream 205 comprising at least some of the lithium cations from the removed lithium-rich phase may form some or all of a second aqueous electrolysis input stream that enters second electrolytic cell 220. Application of an electrical potential difference across cell 220 may result in the formation of stream 206 comprising a second base-rich product solution comprising dissolved LiOH. As mentioned above, the second electrolytic cell may have the same or different configuration (e.g., compartment architecture, electrode types) as the earlier-described electrolytic cell (e.g., electrolytic cell 102), such as those described in FIGS. 2A-2C. In some embodiments, the second base-rich product solution output from the second electrolytic cell is free of non-metal lithium cations or has a relatively low concentration of non-metal lithium cations. For example, in some embodiments, at least 50 mol %, at least 75 mol %, at least 95 mol %, at least 98 mol %, at least 99 mol %) or all of the cations in the second base-rich product solution are lithium ions.

In some embodiments, the second electrolytic cell is operated to produce an acid-rich product solution. For example, application of the electrical potential difference across the second electrolytic cell may facilitate performance of one or more reactions to produce a second acid-rich product solution comprising regenerated lithium selective agent. Referring back to FIGS. 1B-1D, for example, applying an electrical potential difference across electrodes of electrolytic cell 220 may result in the production of stream 202 comprising an acid-rich product solution comprising regenerated lithium selective agent (e.g., regenerated phosphoric acid).

In some embodiments, at least a portion of the lithium hydroxide (e.g., dissolved aqueous LiOH) produced is converted to lithium carbonate. For example, in some embodiments, aqueous lithium hydroxide is exposed to carbon dioxide and/or carbonate anions, thereby generating lithium carbonate, which may be water-insoluble under the conditions of the method (such that it can be separated from the rest of the solution using known solid-liquid separation techniques).

One way in which the lithium hydroxide may be converted to lithium carbonate is by exposing the lithium cations and hydroxide ions of the dissolved lithium hydroxide to carbon dioxide and/or carbonate anions in a liquid-gas contact vessel. For example, in FIGS. 1C-1D, stream 206 comprising the base-rich product solution comprising dissolved lithium hydroxide may be transported to an inlet of second contact vessel 221, which may also receive second input gas stream 222 comprising carbon dioxide. Within contact vessel 221, the alkalinity provided by the hydroxide ions from the second base-rich product solution in stream 206 may induce formation of carbonate and/or bicarbonate anions. The carbonate anions may subsequently form solid lithium carbonate upon exposure to the dissolved lithium cations (e.g., as a precipitate and/or crystal). For example, in FIGS. 1C-1D, solid lithium carbonate may be output from second contact vessel 221 as part of solids-containing stream 207. The second gas-liquid contact vessel may have the same or different configuration as that described above for the first contact vessel (e.g., first contact vessel 131).

As noted above, in some embodiments, a preliminary aqueous lithium source stream is treated as part of the formation of the aqueous lithium source stream (e.g., as a pre-treatment step). The preliminary aqueous lithium source stream may be or be derived from any of a variety of streams, such as, but not limited to a brine (e.g., a natural brine, a geothermal brine, an oil-field brine), wastewater (e.g., industrial wastewater, oil-field wastewater), streams for recycling materials (e.g., battery material recycling streams), mining effluent, groundwater, sewage, seawater, acidulated/digested minerals, salt flats, and/or industrial process streams (e.g., electroplating baths, cooling water). For example, the methods of this disclosure may be employed to increase the efficiency of a downstream lithium separation/extraction process, such as removing magnesium and/or calcium when recovering lithium from natural brines.

The preliminary aqueous lithium source stream may comprise liquid water in an amount of greater than or equal to 40 weight percent (wt %), greater than or equal to 50 wt %, greater than or equal to 75 wt %, greater than or equal to 90 wt %, greater than or equal to 95 wt %, greater than or equal to 98 wt %, greater than or equal to 99 wt %, greater than or equal to 99.9 wt %, or more by weight of liquid in the metal cation impurity-rich source stream.

The preliminary aqueous lithium source stream may include a relatively high concentration of dissolved metal cation impurities. For example, the preliminary aqueous lithium source stream may comprise dissolved metal cation impurity salts.

The term “metal cation impurity” refers to a metal cation species for which the methods and systems of this disclosure are employed to remove at least some of the species from the preliminary aqueous lithium source stream, and is not intended to imply any particular relative or absolute amount of the species in a stream or any particular commercial value (or lack thereof) of the species. As an illustrative example, if the aqueous metal cation impurity-rich stream contains dissolved lithium ions, potassium cations, sodium cations, and calcium cations, and one or more steps of the methods of this disclosure are employed to remove some or all of the calcium cations (e.g., as a calcium carbonate precipitate), then the calcium cations would be considered to be metal cation impurities.

Any of a variety of metal cation impurities may be present. In some, but not necessarily all embodiments, the carbonate salt of the metal cation impurity has a relatively low solubility in pure water. Having a low solubility may promote an ability to use carbonate anions (e.g., from dissolved carbon dioxide) as a precipitant to remove the metal cation impurity. In some embodiments, the carbonate salt of the metal cation impurity has a solubility in pure water of less than or equal to 0.1 g/100 mL, less than or equal to 0.05 g/100 mL, less than or equal to 0.02 g/100 mL, less than or equal to 0.01 g/100 mL, less than or equal to 0.005 g/100 mL, less than or equal to 0.002 g/100 mL, less than or equal to 0.001 g/100 mL, less than or equal to 0.0001 g/100 mL, less than or equal to 0.00001, less than or equal to 0.000001, or less at 298 K.

In some, but not necessarily all embodiments, the hydroxide salt of the metal cation impurity has a relatively low solubility in pure water. Having a low solubility may promote an ability to use hydroxide anions (e.g., produced as part of the base-rich product solution or otherwise) as a precipitant to remove the metal cation impurity. In some embodiments, the hydroxide salt of the metal cation impurity has a solubility in pure water of less than or equal to 0.1 g/100 mL, less than or equal to 0.05 g/100 mL, less than or equal to 0.02 g/100 mL, less than or equal to 0.01 g/100 mL, less than or equal to 0.005 g/100 mL, less than or equal to 0.002 g/100 mL, less than or equal to 0.001 g/100 mL, less than or equal to 0.0001 g/100 mL, or less at 298 K.

In some embodiments, the metal cation impurities comprises alkaline earth metals, transition metals, and/or heavy metals. In some embodiments, some (e.g., at least 1 mole percent (mol %), at least 2 mol %, at least 5 mol % at least 10 mol %, at least 25 mol %, at least 50 mol %, at least 75 mol %, at least 95 mol %, at least 98 mol %, at least 99 mol %) or all of the metal cation impurities are alkaline earth metal cations. The alkaline earth metal cations may comprise magnesium cations (Mg²⁺), calcium cations (Ca²⁺), strontium cations (Sr²⁺), and/or barium cations (Ba²⁺). In some embodiments, some (e.g., at least 1 mol %, at least 2 mol %, at least 5 mol % at least 10 mol %, at least 25 mol %, at least 50 mol %, at least 75 mol %, at least 95 mol %, at least 98 mol %, at least 99 mol %) or all of the alkaline earth metal cations are magnesium cations or calcium cations. In some embodiments, some (e.g., at least 1 mol %, at least 2 mol %, at least 5 mol % at least 10 mol %, at least 25 mol %, at least 50 mol %, at least 75 mol %, at least 95 mol %, at least 98 mol %, at least 99 mol %) or all of the alkaline earth metal cations are magnesium cations. In some embodiments, some (e.g., at least 1 mol %, at least 2 mol %, at least 5 mol % at least 10 mol %, at least 25 mol %, at least 50 mol %, at least 75 mol %. at least 95 mol %, at least 98 mol %, at least 99 mol %) or all of the alkaline earth metal cations are calcium cations.

In some embodiments, some (e.g., at least 1 mol %, at least 2 mol %, at least 5 mol % at least 10 mol %, at least 25 mol %, at least 50 mol %, at least 75 mol %, at least 95 mol %, at least 98 mol %, at least 99 mol %) or all of the metal cation impurities are transition metal cations. Examples of transition metal cations that may be metal cation impurities in this disclosure include, but are not limited to scandium cations (e.g., Sc³⁺), titanium cations (e.g., Ti²⁺), vanadium cations (e.g., V²⁺, V⁴⁺), chromium cations (e.g., Cr³⁺), manganese cations (e.g., Mn²⁺, Mn³⁺), iron cations (e.g., Fe²⁺, Fe³⁺), cobalt cations (e.g., Co²⁺, Co³⁺), copper cations (e.g., Cu²⁺), and/or nickel cations (e.g., Ni²⁺).

In some embodiments, some (e.g., at least 1 mol %, at least 2 mol %, at least 5 mol % at least 10 mol %, at least 25 mol %, at least 50 mol %, at least 75 mol %, at least 95 mol %, at least 98 mol %, at least 99 mol %) or all of the metal cation impurities are heavy metal cations. Examples of heavy metal cations that may be metal cation impurities in this disclosure include, but are not limited to zinc cations (e.g., Zn²⁺), aluminum cations (e.g., Al³⁺), cadmium cations (e.g., Cd²⁺), tin cations (e.g., Sn⁺, Sn⁴⁺), lead cations (e.g., Pb³⁺, Pb⁴⁺), bismuth cations (e.g., Bi³⁺), and/or arsenic cations (e.g., As³⁺).

As noted above, the dissolved metal cation impurities may be present in the preliminary aqueous lithium source stream at a relatively high concentration. In some embodiments, the dissolved metal cation impurities are present in the preliminary aqueous lithium source stream at a total concentration of greater than or equal to 0.001 mg/L, greater than or equal to 0.01 mg/L, greater than or equal to 0.1 mg/L, greater than or equal to 0.5 mg/L, greater than or equal to 1 mg/L, greater than or equal to 5 mg/L, greater than or equal to 10 mg/L, greater than or equal to 20 mg/L, greater than or equal to 50 mg/L, greater than or equal to 100 mg/L, greater than or equal to 500 mg/L, greater than or equal to 1,000 mg/L, greater than or equal to 5,000 mg/L., greater than or equal to 10,000 mg/L, and/or up to 50,000 mg/L, up to 100,000 mg/L, up to 250,000 mg/L, or more. Combinations of these ranges (e.g., greater than or equal to 0.001 mg/L and less than or equal to 250,000 mg/L, greater than or equal to 1 mg/L and less than or equal to 100,000 mg/L) are possible. In some embodiments, at least one metal cation impurity is present in the preliminary aqueous lithium source stream is present in one of the aforementioned concentration ranges. For example, in some embodiments, the concentration of calcium cations and/or the concentration of magnesium cations in the preliminary aqueous lithium source stream are each in one of the aforementioned concentration ranges.

In some embodiments, dissolved magnesium cations are present in the preliminary aqueous lithium source stream at a concentration of greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges are possible.

In some embodiments, dissolved calcium cations are present in the preliminary aqueous lithium source stream at a total concentration of greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges are possible.

In some embodiments, the preliminary aqueous lithium source stream comprises dissolved anions. Any of a variety of anions may be present. The anions may comprise monovalent anions (carrying a single negative charge). For example, the anions may comprise halide ions. As a more specific example, the anions may comprise chloride ions (Cl⁻), bromide ions (Br⁻), and/or iodide ions (I⁻). Other examples of monovalent anions include, but are not limited to, nitrates, nitrites, hydrogen sulfate ions, and/or perchlorates. In some embodiments, the anions comprise oxyanions. In some embodiments, the anions comprise divalent ions (carrying a charge of −2). For example, the anions may comprise sulfate ions (SO₄²⁻). In some embodiments, the anions comprise trivalent anions (carrying a charge of −3), such as orthophosphate anions (PO₄³⁻). In some embodiments, the anions comprise phosphate ions (e.g., orthophosphate ions (PO₄³⁻), monohydrogen phosphate ions (HPO₄²⁻), and/or dihydrogen phosphate ions (H₂PO₄⁻). In some embodiments, the anions comprise borate ions (e.g., orthoborate ions (BO₃³⁻), tetrahydroxyborates (B(OH)₄⁻), tetraborates (B₄O₇²⁻), and/or polyborates). In some embodiments, the anions are conjugate bases of strong acids. However, in some embodiments, the anions are conjugate bases of weak acids. In some embodiments, the anions are spectator ions with respect to the chemistries employed to remove the metal cation impurities and/or other reactions performed in the methods and systems of this disclosure. In some embodiments, some (e.g., at least 50 mole percent (mol %), at least 75 mol %, at least 95 mol %, at least 98 mol %, at least 99 mol %) or all of the anions are chloride ions.

As noted above, the anions may be present in the preliminary aqueous lithium source stream in a relatively high concentration. In some embodiments, the dissolved anions are present in the preliminary aqueous lithium source stream at a concentration of greater than or equal to 0.001 mg/L, greater than or equal to 0.01 mg/L, greater than or equal to 0.1 mg/L, greater than or equal to 0.5 mg/L, greater than or equal to 1 mg/L, greater than or equal to 5 mg/L, greater than or equal to 10 mg/L, greater than or equal to 20 mg/L, greater than or equal to 50 mg/L, greater than or equal to 100 mg/L, greater than or equal to 500 mg/L, greater than or equal to 1,000 mg/L, greater than or equal to 5,000 mg/L, greater than or equal to 10.000 mg/L, and/or up to 50,000 mg/L, up to 100,000 mg/L, up to 200,000 mg/L, up to 450,000 mg/L, or more. Combinations of these ranges (e.g., greater than or equal to 0.001 mg/L and less than or equal to 450,000 mg/L, greater than or equal to 1 mg/L and less than or equal to 200,000 mg/L) are possible.

In some embodiments, dissolved magnesium chloride (MgCl₂) is present in the preliminary aqueous lithium source stream (in addition to the lithium cations). For example, the preliminary aqueous lithium source stream may comprise dissolved magnesium chloride in an amount of greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. In some embodiments, dissolved calcium chloride (CaCl₂) is present in the preliminary aqueous lithium source stream (in addition to the lithium cations). For example, the preliminary aqueous lithium source stream may comprise dissolved calcium chloride in an amount of greater than or equal to greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges are possible.

In some embodiments, dissolved magnesium sulfate (MgSO₄) is present in the preliminary aqueous lithium source stream (in addition to the lithium cations). For example, the preliminary aqueous lithium source stream may comprise dissolved magnesium sulfate in an amount of greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. In some embodiments, dissolved calcium sulfate (CaSO₄) is present in the preliminary aqueous lithium source stream (in addition to the lithium cations). For example, the preliminary aqueous lithium source stream may comprise dissolved calcium sulfate in an amount of greater than or equal to greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges are possible.

In some embodiments, a dissolved magnesium borate is present in the preliminary aqueous lithium source stream (in addition to the lithium cations). For example, the preliminary aqueous lithium source stream may comprise a dissolved magnesium borate in an amount of greater than or equal to I mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. In some embodiments, a dissolved calcium borate is present in the preliminary aqueous lithium source stream (in addition to the lithium cations). For example, the preliminary aqueous lithium source stream may comprise a dissolved calcium borate in an amount of greater than or equal to greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges are possible.

In some embodiments, a dissolved magnesium phosphate is present in the preliminary aqueous lithium source stream (in addition to the lithium cations). For example, the preliminary aqueous lithium source stream may comprise a dissolved magnesium phosphate in an amount of greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. In some embodiments, a dissolved calcium phosphate is present in the preliminary aqueous lithium source stream (in addition to the lithium cations). For example, the preliminary aqueous lithium source stream may comprise a dissolved calcium phosphate in an amount of greater than or equal to greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges are possible.

Other species may be present in the preliminary aqueous lithium source stream. For example, the preliminary aqueous lithium source stream may also comprise non-lithium alkali metal cations in addition to the lithium cations (e.g., sodium cations, potassium cations, cesium cations, and/or rubidium cations). In some embodiments, the aqueous metal cation impurity-rich stream comprises rare earth metal cations (e.g., scandium cations, lanthanum cations, cerium cations, praseodymium cations, neodymium cations, promethium cations, samarium cations, europium cations, gadolinium cations, terbium cations, dysprosium cations, holmium cations, and/or erbium cations). In some embodiments, the aqueous metal cation impurity-rich source stream comprises uranium cations.

The preliminary aqueous lithium source stream may have any of a variety of pH values, depending on the composition of the stream and the configuration of the system. The preliminary aqueous lithium source stream may have a relatively low pH. In some embodiments, the preliminary aqueous lithium source stream has a pH of less than or equal to 14, less than or equal to 12, less than or equal to 10, less than or equal to 8, less than or equal to 7, less than or equal to 6, less than or equal to 5, less than or equal to 4, less than or equal to 3, less than or equal to 2, or less. The preliminary aqueous lithium source stream may have a relatively high pH. In some embodiments, the preliminary aqueous lithium source stream has a pH of greater than or equal to 0, greater than or equal to 1, greater than or equal to 3. greater than or equal to 5, greater than or equal to 7, greater than or equal to 8, greater than or equal to 9, greater than or equal to 10, greater than or equal to 11, greater than or equal to 12, or greater. Combinations of these ranges are possible.

In some embodiments, the preliminary aqueous lithium source stream is exposed to a metal cation impurity salt precipitation stream. For example, in FIG. 1D, aqueous metal cation impurity-rich source stream 208 is contacted with metal cation impurity salt precipitation stream 212. In some embodiments, the aqueous metal cation impurity-rich source stream comprises at least a portion of the capture stream discussed above. For example, metal cation impurity salt precipitation stream 212 in FIG. 1D comprises at least a portion of capture stream 108. The name “metal cation impurity salt precipitation stream” is used for convenience in referring to the stream and its function of inducing precipitation of metal cation impurities, and is not meant to imply that metal cation impurity salts or precipitates thereof are necessarily present in the stream. In some embodiments, the metal cation impurity salt precipitation stream is a homogenous liquid solution. The metal cation impurity salt precipitation stream may be an aqueous solution (e.g., a homogeneous aqueous solution).

The metal cation impurity salt precipitation stream may comprise precipitating agents, such as carbonate anions, that can induce the formation of a solid salt of a metal cation impurity. For example, upon mixture with the preliminary aqueous lithium source stream, the carbonate anions in the metal cation impurity salt precipitation stream may form a precipitate comprising a solid alkaline earth metal carbonate salt. As a specific example, upon mixture with the preliminary aqueous lithium source stream, the carbonate anions in the metal cation impurity salt precipitation stream may precipitate out calcium cations from the preliminary aqueous lithium source stream as solid calcium carbonate (CaCO₃). As another example, upon mixture with the preliminary aqueous lithium source stream, the carbonate anions in the metal cation impurity salt precipitation stream may precipitate strontium cations from the preliminary aqueous lithium source stream as solid strontium carbonate (SrCO₃).

In some embodiments, the metal cation impurity salt precipitation stream comprises dissolved carbonate anions at a concentration of greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges are possible.

In some, but not necessarily all embodiments, the metal cation impurity salt precipitation stream comprises dissolved hydroxide anions at a relatively high concentration. In some embodiments, the dissolved hydroxide anions are sourced directly or indirectly from the base-rich product solution output by the first electrolytic cell. The presence of the hydroxide anions may be due, for example, to incomplete neutralization of hydroxide ions during formation of carbonate anions in the basic-species driven capture of carbon dioxide in the gas-liquid contact vessel. Alternatively, in some, but not necessarily all embodiments, the hydroxide anions are present due to the metal cation impurity salt precipitation stream comprising at least a portion of the base- rich product solution produced by the first electrolytic cell. FIG. 3B shows one such embodiment, where the base-rich product solution comprising dissolved lithium cations, sodium, cations, potassium cations, and hydroxide anions are transported back from the catholyte outlet of the first electrolytic cell in the bottom right of the figure to mix with the preliminary aqueous lithium source stream.

It has been realized in the context of this disclosure that the presence of hydroxide anions in the metal cation impurity salt precipitation stream instead of or in addition to the carbonate anions can provide, in some instances, an improved ability to remove some metal cation impurities compared to metal cation impurity salt precipitation streams lacking the hydroxide anions. For example, in instances where magnesium is present as a metal cation impurity, hydroxide ions in the metal cation impurity salt precipitation stream may induce formation of solid magnesium hydroxide (Mg(OH)₂), which has a low water solubility, in addition to (or even instead of) solid magnesium carbonate, which has a comparatively higher water solubility. In some embodiments, the metal cation impurity salt precipitation stream comprises dissolved hydroxide anions at a concentration of greater than or equal to 0.0001 M, greater than or equal to 0.001 M, greater than or equal to 0.01 M, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges are possible.

The preliminary aqueous lithium source stream may be exposed to the metal cation impurity salt precipitation stream in any of a variety of manners. For example. both streams may be fed into a common conduit (e.g., tube) and mixed accordingly. As another example, the metal cation impurity-rich source stream and the metal cation impurity salt precipitation stream may be fed to a vessel (e.g., tank) where they may be mixed passively (e.g., by convection) or actively (e.g., by agitation such as stirring). As one example, in FIG. 1D, preliminary aqueous lithium source stream 208 is transported to mixing vessel 157 via first mixing vessel inlet 158, and metal cation impurity salt precipitation stream 212 is transported to mixing vessel 157 via second mixing vessel inlet 159. The preliminary aqueous lithium source stream and the metal cation impurity salt precipitation stream may be mixed in a continuous, batch, or semi-batch manner.

The metal cation impurity salt precipitation stream may be formed at least in part by the capture of carbon dioxide (e.g., in a gas-liquid contact vessel). In some embodiments, the metal cation impurity salt precipitation stream comprises at least a portion of the capture stream. In some embodiments, the capture stream described above, which may include dissolved carbonate anions from captured carbon dioxide, may form at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of the metal cation impurity salt precipitation stream. The embodiment shown in FIG. 1D shows one such way in which the metal cation impurity salt precipitation stream may include captured carbon dioxide, where second inlet 159 of mixing vessel 157 is fluidically connected to contact vessel liquid outlet 133 such that at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of capture stream 108 can be transported from gas-liquid contact vessel 131 to mixing vessel 157 by forming at least a portion of metal cation impurity salt precipitation stream 212.

The exposure of the metal cation impurities to the carbonate anions may cause the formation of the metal cation impurity solids-containing stream. For example, in FIG. 1D, metal cation impurity solids-containing stream 209 is output from mixing vessel 157. The metal cation impurity solids-containing stream may comprise a solid salt comprising at least some (e.g., at least 10 mol %, at least 25 mol %, at least 50 mol %, at least 75 mol %, at least 90 mol %, at least 95 mol %, at least 98 mol %, at least 99 ml %, at least 99.9 mol %, or all) of the at least one of the metal cation impurities from the preliminary aqueous lithium source stream. In some embodiments in which magnesium cations and calcium cations are present as metal cation impurities, the solid salt may comprise, for example, magnesium carbonate and/or calcium carbonate. In some such embodiments, solid magnesium hydroxide may also be formed (e.g., due to the present of hydroxide anions in some embodiments). The salt solid may be formed by precipitation and/or crystallization.

In some embodiments, at least a portion of the solid salt comprising the metal cation impurities is in the form of an amorphous solid (e.g., an amorphous powder). In some embodiments, at least a portion of the solid salt is in the form of a crystalline solid.

The metal cation impurity solids-containing stream may comprise a liquid component (e.g., an aqueous solution) and a solid component, the latter comprising the solid salt comprising the metal cation impurities. At least a portion of the solid component may be suspended in the liquid component. The solid component may be distributed essentially homogeneously throughout the liquid component of the stream or may be at least partially phase-separated. In some embodiments, the metal cation impurity solids-containing stream is a slurry comprising water mixed with the solid salt comprising at least some of the metal cation impurities.

The formation of the solid salt may be associated with the removal of a relatively high percentage of dissolved metal cation impurities from the liquid solution phase. This may advantageously permit the resulting liquid solution phase (e.g., the liquid component of the metal cation impurity solids-containing stream) to be used in applications for which dissolved metal cation impurities are undesirable (e.g., lithium-containing material extraction/production).

In some embodiments, at least a portion of the solid salt is separated from the metal cation impurity solids-containing stream. For example, at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of the metal cation impurity solids-containing stream may be transported to a solid separation vessel. The solids separation vessel may receive the metal cation impurity solids-containing stream via an inlet (e.g., fluidically connected to an outlet of the mixing vessel) and provide a location that permits the separation (e.g., active separation or passive separation) of solids from liquids. For example, in FIG. 1D, at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of metal cation impurity solids-containing stream 209 may be transported to solids separation vessel 160 via inlet 161 fluidically connected to outlet 162 of mixing vessel 157.

In the solids separation vessel, at least a portion of the solid salt comprising the metal cation impurities may be removed to form a metal cation impurity-lean liquid stream. For example, metal cation impurity-lean liquid stream 213 may be output from solids separation vessel 160. In some embodiments, the aqueous lithium source stream comprises at least a portion of the metal cation impurity-lean liquid stream. For example, referring again to FIG. 1D, aqueous lithium source stream 201 may comprise at least a portion of metal cation impurity-lean liquid stream 213. Meanwhile, removed salt 210 in FIG. 1D may be discharged from the system and/or subjected to further processing.

In some embodiments, the solids separation vessel is a gravity-based settling vessel. In some embodiments, the gravity-based settling device comprises a clarifier. In some embodiments, the clarifier is a lamella clarifier. A lamella clarifier generally refers to a vessel comprising a plurality of inclined plates. In operation, a stream may enter the lamella clarifier, and solids within the stream may settle on one or more of the inclined plates of the lamella clarifier.

The solids separation vessel need not necessarily be a clarifier, and may be any of a variety of other type of solids separation vessel known in the art. For example, the solids separation vessel may comprise a hydrocyclone, a corrugated plate interceptor, an adsorption media filter, a coalescing media filter, a membrane filter, an induced gas flotation (IGF) separator, a dewatering filter press, a centrifuge, and/or a skimmer.

In some embodiments, at least some of the metal cation impurity solids-containing stream is treated with one or more reagents to promote effective solid-liquid separation. The metal cation impurity solids-containing stream may be exposed to the reagent before and/or during transportation of the metal cation impurity solids-containing stream to the solids separation vessel. In some embodiments, the reagent comprises a coagulant and/or flocculant. Examples of coagulants and/or flocculants include, but are not limited to, inorganic species (e.g., aluminum sulfate, aluminum chloride, aluminum chlorohydrate, ferric chloride, and/or ferric sulfate) and/or organic species (e.g., polymers such as polyacrylamide, polyacrylates, polyoxyethylene, polyvinylamine, and/or polyvinyl sulfate).

As noted above, in some embodiments, an aqueous electrolysis input stream comprising at least a portion of an aqueous lithium source stream is transported to the electrolytic cell, where the aqueous lithium source stream comprises dissolved lithium cations and dissolved non-hydroxide anions (e.g., halides, sulfate, a phosphate). In some embodiments, the aqueous lithium source stream comprises a dissolved lithium halide salt (e.g., dissolved lithium chloride). In some embodiments, the aqueous lithium source stream comprises dissolved lithium sulfate. The dissolved salt of lithium and a non- hydroxide anion may be derived from a solid mineral source of lithium (e.g., hard rock, such as hard rock granitic pegmatites and/or hard rock spodumenes), e.g., via acid-leach (such as with sulfuric acid). In some, but not necessarily all embodiments, at least 1 mol %, at least 2 mol %, at least 5 mol %, at least 10 mol %, at least 25 mol %, at least 50 mol %, at least 75 mol %, at least 95 mol %, at least 98 mol %, at least 99 mol %) or all of the cations in the aqueous electrolysis input stream are lithium ions.

The aqueous lithium source stream in some instances is prepared by dissolving a solid lithium salt comprising the lithium cations and non-hydroxide anions to form at least a portion of the aqueous lithium source stream. In some such embodiments, the solid salt comprises a lithium halide such as lithium chloride (LiCl).

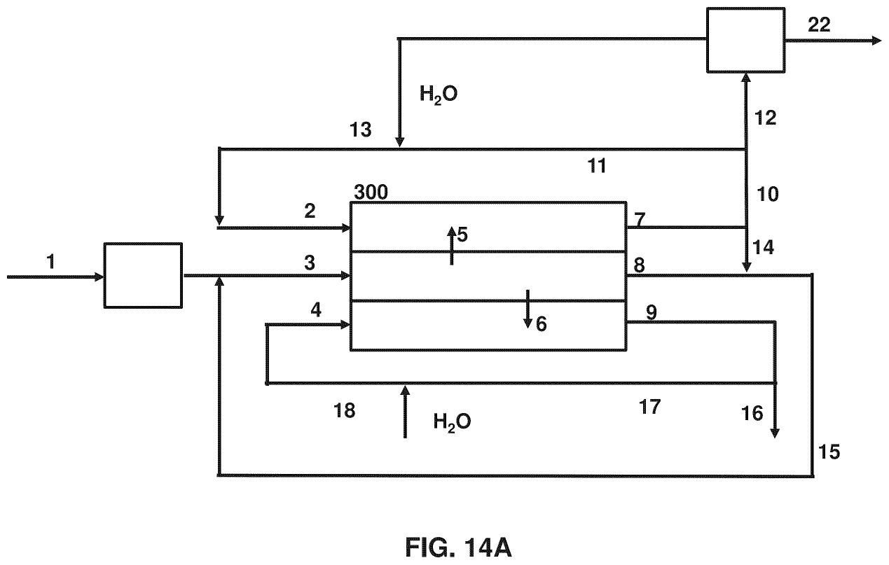

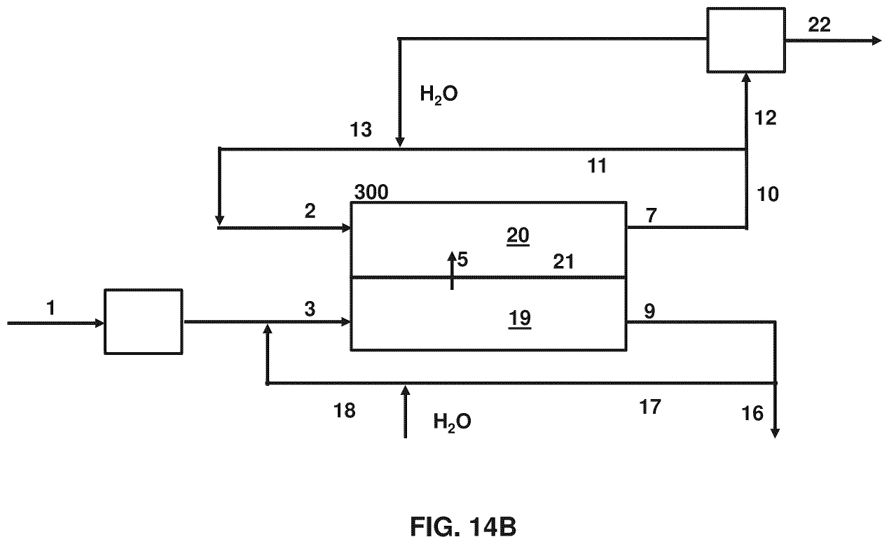

FIG. 14A shows an example of an embodiment where aqueous electrolysis input stream 3 comprising lithium cations and non-hydroxide anions, sourced from aqueous lithium source stream 1, is fed to the electrolyte chamber (middle chamber) of electrolytic cell 300. Lithium cations 5 are transported through a cation exchange membrane to a catholyte chamber where basic species such as hydroxide anions are electrogenerated, thereby forming stream 7 comprising a base-rich product solution comprising at least some of the lithium cations and at least some of the basic species (e.g., dissolved lithium hydroxide). Meanwhile, non-hydroxide anions 6 are transported through an anion exchange chamber from the electrolyte (middle) chamber to the anolyte chamber where acidic species such as hydronium ions are electrogenerated (e.g., via hydrogen oxidation at a hydrogen depolarization anode), thereby forming stream 9 comprising an acid-rich product solution comprising at least some of the non-hydroxide anions and acidic species (e.g., the dissolved conjugate acid of the non-hydroxide anion, such as hydrochloric acid and/or sulfuric acid). Output stream 8 exits the electrolyte (middle) chamber and is free of the lithium cations or comprises the lithium cations at a concentration that is lower than the concentration of lithium cations in aqueous electrolysis input stream 3.

In some, but not necessarily all embodiments, two or more of the compartments of the electrolytic cell receive an aqueous electrolysis input stream. For example, the catholyte chamber may receive a catholyte input stream, the anolyte chamber may receive an anolyte input stream, and/or the electrolyte (middle) chamber may receive an electrolyte input stream. In some embodiments, the catholyte input stream comprises at least a portion of the base-rich product solution. For example, referring back to FIG. 14A, stream 7 comprising base-rich product solution may be split into stream 10 and stream 14, with stream 10 being further split into stream 11 and stream 12. Catholyte input stream 2 may comprise at least a portion of stream 11, which may in some instances be diluted with a dilution stream (e.g., water) to form diluted base-rich product stream 13 having a lower concentration of the electrogenerated basic species (and/or other solute) than in stream 11. In such a way, this recirculation of at least a portion of the base-rich product solution may result in the catholyte chamber of electrolytic cell 300 being fed with a catholyte input solution comprising dissolved lithium cations and dissolved basic species (e.g., dissolved lithium hydroxide). Of course, it should be understood that this recirculation is optional and in some embodiments no such recirculation is performed. The two-chamber electrolytic cell embodiment in FIG. 14B described below is an example other than that in FIG. 14A in which an aqueous input stream comprises at least a portion of a base-rich product solution (e.g., in some embodiments at least a portion of a diluted base-rich product solution).

Stream 12 comprising lithium cations and basic species may be concentrated (e.g., via any of a variety of known techniques), thereby producing a concentrated aqueous solution of the lithium cations and basic species (e.g., concentrated lithium hydroxide). The concentrated aqueous solution may then be discharged from the system (e.g., as stream 22 as shown in FIGS. 14A-14B), dried to form solid lithium-containing material, and/or converted to lithium carbonate (e.g., upon exposure to carbon dioxide and/or carbonate anions, such as in a gas-liquid contact vessel). For example, in some embodiments, at least a portion of the base-rich product solution is exposed to carbon dioxide and/or carbonate anions to form lithium carbonate comprising at least some of the lithium cations from the base-rich product solution.

As noted above, in some embodiments, the electrolytic cell of the system that receives the aqueous electrolysis input stream may be a two-chamber electrolytic cell. FIG. 14B shows an example of an embodiment that is similar in operation to the embodiment in FIG. 14B, but where aqueous electrolysis input stream 3 comprising lithium cations and non-hydroxide anions, sourced from an aqueous lithium source stream 1, is fed to anolyte chamber 19 of electrolytic cell 300. The anolyte chamber and catholyte chamber may be separated by an ion-selective membrane such as a cation- selective membrane, which may in some embodiments be the sole ion-selective membrane in the cell. For example, in some embodiments, lithium cations 5 are transported through cation exchange membrane 21 to catholyte chamber 20 where basic species such as hydroxide anions are electrogenerated, thereby forming stream 7 comprising a base-rich product solution comprising at least some of the lithium cations and at least some of the basic species (e.g., a dissolved lithium hydroxide). As described above, in some embodiments, an acid-rich product solution is produced upon application of an electrical potential difference across the electrolytic cell. For example, meanwhile in FIG. 14B, non-hydroxide anions are supplied to the anolyte chamber via aqueous input stream 3. In the anolyte chamber, product species such as but not limited to acidic species (e.g., hydronium ions) are electrogenerated (e.g., via hydrogen oxidation at a hydrogen depolarization anode and/or via the oxygen evolution reaction), thereby forming stream 9 comprising an acid-rich product solution. In some embodiments, the acid-rich product solution comprises at least some of the non-hydroxide anions and/or conjugate acids of at least some of the non-hydroxide anions (e.g., formed via protonation of the non-hydroxide anions caused by the anode electrolysis half-reaction performed in the anolyte chamber). It has been observed in the context of this disclosure that certain chemistries, including some involving use of weak acids as the acidic species and/or conjugate bases of weak acids as the non-hydroxide anions, may permit beneficially high Paradaic efficiencies for the electrochemical processes described above, which may be advantageous when employing, for example a two-compartment electrolytic cell (e.g., with a cation-selective membrane separating the catholyte and anolyte chambers).

In some embodiments, one or more input stream of the electrolytic cell (e.g., the anolyte input stream) comprises at least a portion of the acid-rich product solution. For example, in some embodiments, the stream fed to the anolyte chamber of the electrolytic cell comprises at least a portion of the at least a portion of an acid-rich product solution. The stream fed to the anolyte chamber may be the aqueous electrolysis input stream (e.g., comprising lithium cations and non-hydroxide anions) in some embodiments (e.g., employing a two-chamber electrolytic cell). The embodiment shown in FIG. 14B is one such embodiment. In such a case the aqueous electrolysis input stream comprising the cations (e.g., lithium cations) and the non-hydroxide anions is the same as the anolyte input stream. However, in some embodiments, the stream fed to the anolyte chamber is the anolyte input stream, and the aqueous electrolysis input stream (e.g., comprising lithium cations and non-hydroxide anions) is fed to a different chamber of the electrolytic cell. For example in some such embodiments, the aqueous electrolysis input stream (e.g., comprising lithium cations and non-hydroxide anions) is fed to an electrolyte chamber (middle chamber) of a three-chamber electrolytic cell). As such, in some embodiments, at least a portion of the acid-rich product solution is recirculated back to the electrolytic cell. For example, referring back to FIG. 14A, stream 9 comprising acid-rich product solution may be split into stream 16 (which is discharged from the system) and stream 17. Anolyte input stream 4 may comprise at least a portion of stream 17, which may in some instances be diluted with a dilution stream (e.g., water) to form a diluted acid-rich product solution in the form of diluted acid-rich product stream 18 having a lower concentration of electrogenerated product species (e.g., electrogenerated acidic species (and/or other solute)) than in stream 17. As another example, as shown in FIG. 14B, aqueous input stream 3 may comprise at least a portion of stream 17, which may in some instances be diluted with a dilution stream (e.g., water) to form diluted acid-rich product stream 18 having a lower concentration of electrogenerated acidic species (and/or other solute) than in stream 17. In such a way, this recirculation of at least a portion of the acid-rich product solution may result in the anolyte chamber of electrolytic cell 300 being fed with an anolyte input solution comprising dissolved acid such as hydrochloric acid and/or sulfuric acid. Recirculation of acid produced by the process may reduce or eliminate the need to introduce fresh acid, which may increase efficiency and cost-effectiveness of the system. Of course, it should be understood that this recirculation is optional and in some embodiments no such recirculation is performed.

As noted elsewhere, the acid-rich product solution may comprise electrogenerated acidic species. The acidic species may comprise, for example, hydronium ions and/or other acidic species such as those generated by protonating the non-hydroxide anions to form, for example, weak acids. In some embodiments in which the acid-rich product solution comprises electrogenerated acidic species, the concentration of the acidic species in the acid-rich product solution is greater than the concentration of the acidic species in the stream fed to the anolyte chamber (e.g., the aqueous input stream or a separate anolyte input stream). In some embodiments in which the stream fed to the anolyte chamber also comprises the acidic species, a molar ratio of the concentration of the acidic species in the anolyte acid-rich product solution to the concentration of the acidic species in the stream fed to the anolyte chamber is at least 1.005, at least 1.01, at least 1.05, at least 1.1, at least 1.5, at least 2, at least 5, at least 10, at least 50, at least 100, at least 1000, at least 10,000, at least 100,000, at least 1,000,000, at least 10,000,000, and/or up to 100.000,000, up to 1,000,000,000, or more. Combinations of these ranges (e.g., at least 1.005 and less than or equal to 1,000,000,000, or at least 1.01 and less than or equal to 1,000,000) are possible.

In FIG. 14A, at least a portion of stream 8, which may be free of the dissolved lithium cations or comprise a lower concentration of lithium cations (e.g., as a dilute lithium brine solution comprising lithium cations and non-hydroxide anions such as lithium chloride and/or lithium sulfate), may be recirculated back as stream 15 to form at least some of aqueous electrolysis input stream 3.

FIGS. 3A-3B show non-limiting example embodiments involving obtaining a lithium-containing material using a lithium selective agent. The process starts with a preliminary aqueous lithium source stream in the form of an inlet brine, which contains dissolved alkali ions (Li, Na, K,) and metal cation impurities such as alkaline earth (Mg, Ca,) metal cations. This stream is contacted with an alkali metal (Na, K) carbonate stream exiting a contact vessel in the form of an air contactor. The reaction of the alkaline earth metals with the carbonate stream results in the precipitation of their respective carbonates.

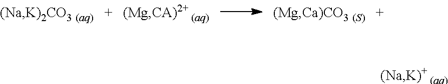

As shown in FIG. 3B, it is also possible (optionally) to contact the inlet stream with an alkali metal hydroxide stream (resulting from the base-rich product solution produced by the first electrolysis assembly) first, to precipitate magnesium in the form of Mg(OH)₂ followed by contacting this resulting stream with the carbonate stream from the air contactor.

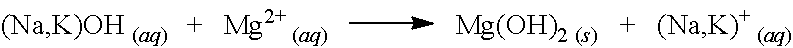

Other configurations are possible. For example, in some embodiments the inlet stream is instead contacted with the carbonate stream from the air contactor, followed by contacting the resulting stream with an alkali metal hydroxide stream (resulting from the base-rich product solution produced by the first electrolysis assembly) to precipitate a magnesium salt (e.g., MgOH)₂). As another example, the inlet stream may be contacted with the alkali metal hydroxide stream (resulting from the base-rich product solution produced by the first electrolysis assembly) and the carbonate stream simultaneously.

The resulting metal cation impurity solids-containing stream in the form of a slurry stream is filtered to remove the precipitates of the alkaline earth metals in their carbonate (and optionally hydroxide) forms, thereby forming a metal cation impurity-lean liquid stream as the filtrate, which serves as the aqueous lithium source stream. It should be understood that the alkaline metal cation removal step in FIGS. 3A-3B are optional, and in some instances the method begins with the aqueous lithium source stream being fed to the electrolysis assembly without such pretreatment. It should also be understood that while the electrolysis assembly in FIGS. 3A-3B (and other figures below) are shown as three-compartment electrolysis cells, other configurations are possible, such as two-compartment electrolysis cells. Any of the configurations in FIGS. 2A-2C may be used, for example. The filtrate is now mostly soluble alkali metal cations. This filtrate stream is fed as an aqueous electrolysis input stream into an electrolysis assembly (first electrolysis assembly) where it is electrolyzed into an acid stream that comprises anions fed into electrolysis assembly as the conjugate base, and a base stream comprising the hydroxides of alkali metals. The base stream is then mixed with a stream of the lithium selective agent in the form of phosphoric acid, which results in the neutralization of a portion of the base (hydroxide anions) and the precipitation of at least some (in some instances most or all) of the lithium cations in the form of tri-lithium phosphate.

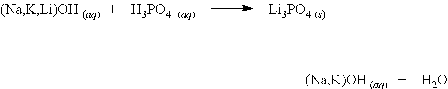

This stream, a lithium-rich solids-containing stream, is filtered to separate the tri-lithium phosphate precipitate from the base stream filtrate (a lithium depleted stream), which in turn is fed into an air contactor to react with carbon dioxide in air (or a contactor which brings the base stream in contact with a CO₂-rich gas effluent/stream).

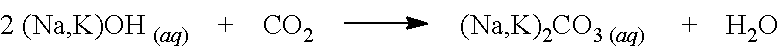

This reaction results in the formation of an alkali metal carbonate stream, part of which may be removed from the process and is in some instances allowed to evaporate and yield alkali metal carbonate solids (crystals). The second part is contacted with the inlet brine to precipitate alkaline earth cations, as described earlier in the context of FIGS. 3A-3B. The tri-lithium phosphate residue (e.g., filter cake) is brought in contact with more phosphoric acid to form water-soluble lithium dihydrogen phosphate.

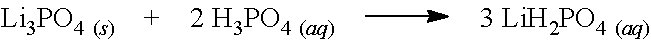

The solution of lithium dihydrogen phosphate is fed into a second electrolysis assembly, where it is electrolyzed to a lithium hydroxide LiOH base stream that is evaporated to form lithium hydroxide monohydrate LiOH·H₂O solid product, and a stream of regenerated phosphoric acid that is recycled to the tri-lithium phosphate precipitation and lithium dihydrogen phosphate formation steps.

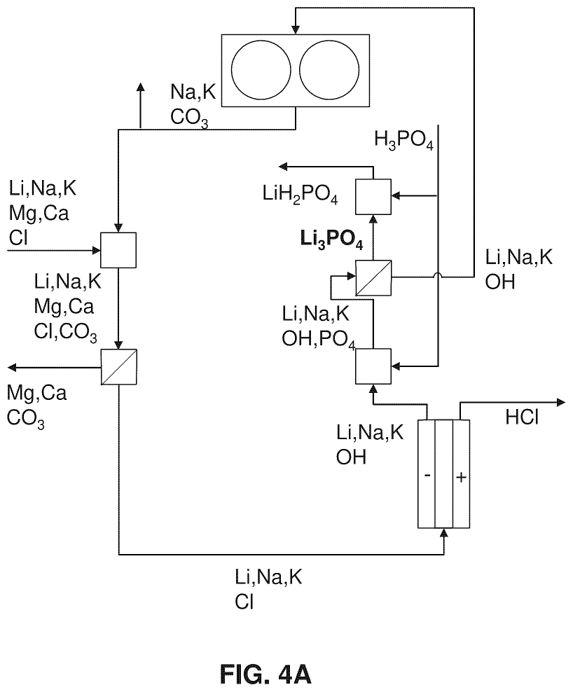

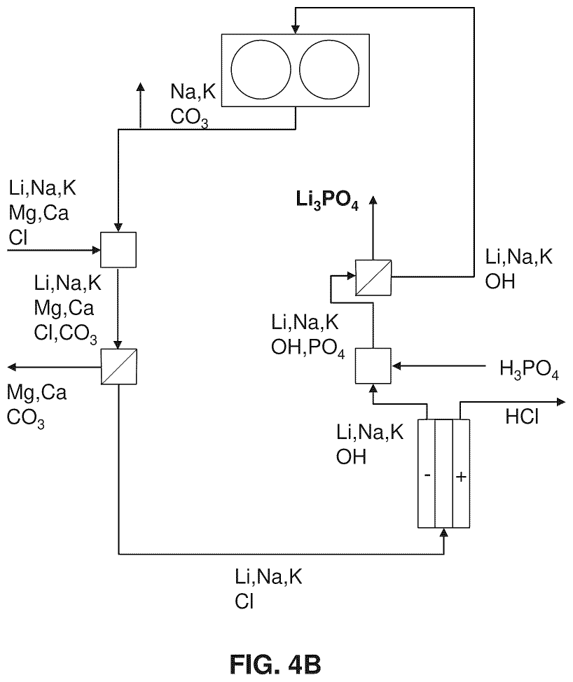

It is possible to perform variations of the embodiments in FIGS. 3A-3B in which lithium dihydrogen phosphate LiH₂PO₄ is recovered (FIG. 4A) and/or where tri-lithium phosphate Li₃PO₄ is recovered (FIG. 4B) as products, which may permit the elimination of the second electrolysis step shown in FIGS. 3A-3B. In these instances, make up phosphoric acid is needed.

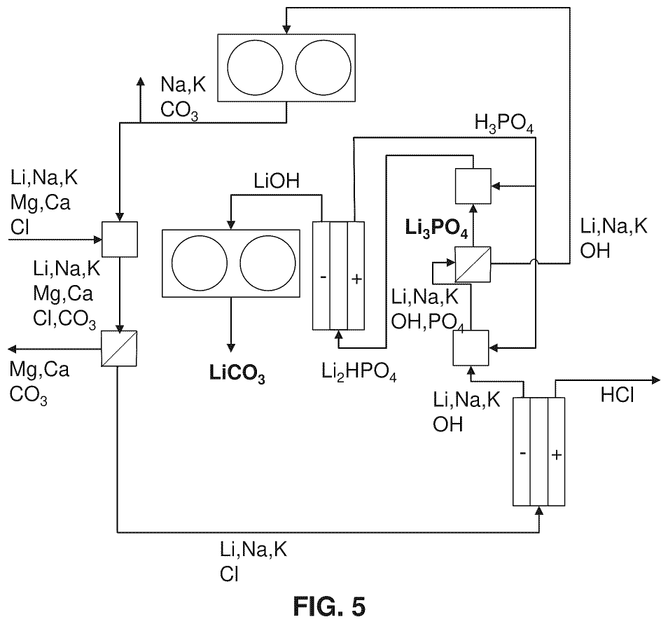

FIG. 5 shows an example of an embodiment that is a variation of that shown in FIGS. 3A-3B, but where lithium hydroxide base stream resulting from the second electrolysis assembly is fed into a second contactor (air, or otherwise) to allow the reaction of lithium hydroxide with a CO₂-rich stream to form a lithium carbonate stream. This may then evaporated to form a lithium carbonate solid product.

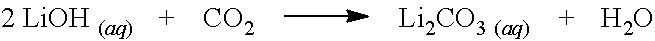

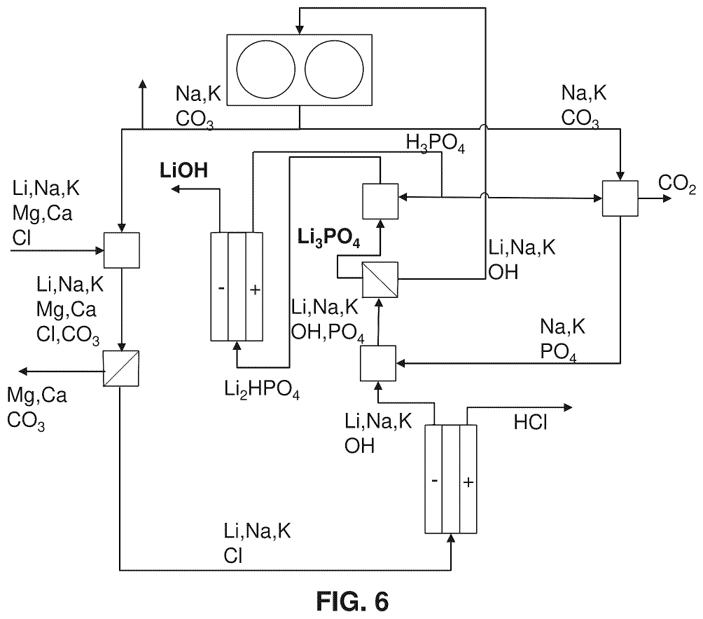

FIG. 6 shows an example of an embodiment that is a variation of that shown in FIGS. 3A-3B, but where alkali metal phosphates rather than phosphoric acid are employed as lithium selective agents for the precipitation of tri-lithium phosphate from the alkali metal base stream exiting the first electrolysis assembly.

In this iteration, a portion of the alkali metal carbonate stream exiting the air contactor is mixed with a portion of the phosphoric acid stream exiting the second electrolyzer. This results in a reaction whereby pure carbon dioxide is released as a useful product for downstream utilization or sequestration, as well as a solution of alkali metal phosphates.

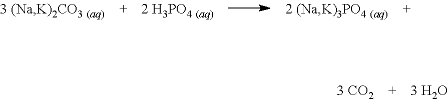

This in turn is mixed with the alkali metal base stream exiting the first electrolysis assembly resulting in the precipitation of lithium phosphate, just as before.

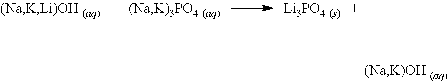

One example of a benefit of this approach is the retention of the hydroxide anions in the base stream rather than neutralizing them, as is the case with phosphoric acid precipitation. This allows for more carbon capture in the contactor. However, the amount of alkali metal carbonate utilized downstream as product and brine inlet additive for alkaline earth metal precipitation is the same, since a portion of the carbonate stream exiting the contactor is diverted to form the alkali metal phosphates.

FIG. 7 shows an example of an embodiment in which exposure of the lithium cations from the aqueous lithium source stream to the lithium selective agent is performed upstream of the electrolysis assembly. In FIG. 7, alkali metal phosphates are produced from the alkali metal carbonate stream exiting the contactor and the phosphoric acid exiting the second electrolyzer, just as in FIG. 6. However, this phosphate stream is mixed with the stream of the alkali metals prior to its entry into the first electrolysis assembly, resulting in the precipitation of the tri-lithium phosphate which carries through the process as before.

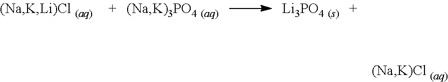

Meanwhile, the filtrate of soluble alkali metals, now free (or substantially free) of lithium ions, continues into the first electrolysis assembly as the aqueous electrolysis input stream to generate the acid stream and the alkali metal base stream that enters the contactor.

FIGS. 8A-8B show examples of embodiments in which the lithium selective agent is regenerated thermally rather than electrolytically. In these embodiment, the second electrolyzer, where product lithium hydroxide is generated and the phosphoric acid is regenerated, is replaced with a thermal process. Here, the precipitation of tri-lithium phosphate with phosphoric acid proceeds as before, however, the filtered precipitate is charged into a calciner rather than being converted into soluble lithium dihydrogen phosphate for the second electrolysis. The calciner is charged with the lithium phosphate precipitate and carbon (coke), which allows for the reduction of lithium phosphate into phosphorus and lithium oxide, and carbon monoxide is generated in the process. Air in the calciner then oxidizes carbon monoxide into carbon dioxide and phosphorus into phosphorus pentoxide, which along with the inert gases in the incoming air, leave the calciner in a gas stream. Heat in the calciner can be achieved using fuels, oxidation heat, electrical heating, or a combination.

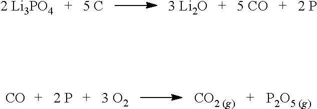

This stream of hot gases is introduced into a contactor (scrubber) where water reacts with the phosphorus pentoxide regenerating the phosphoric acid.

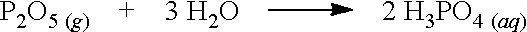

Solid residue from the calciner, mostly lithium oxide, is reacted with water in a slaker to form a solution of lithium hydroxide which can be evaporated to form lithium hydroxide monohydrate.

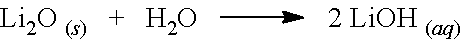

FIG. 9 shows an example of a fully non-electrochemical embodiment, but where lithium selective agent is regenerated. In FIG. 9 the second electrolysis assembly is replaced with the thermal process (calciner/slaker) as in FIGS. 8A-8B; however, the first electrolysis assembly is also eliminated. Here, sodium carbonate (soda ash) Na₂CO₃—and optionally calcium hydroxide Ca(OH)₂—from an external source (not regenerated) is mixed with the inlet brine for the precipitation of the alkaline earth metals in their carbonate (and hydroxide) form. Other than the alkaline earth metal carbonate (and hydroxide) precipitates discussed in the previous sentence, there is no carbonate product stream exiting the process; rather, a lithium-free and essentially carbonate-free alkali metals reject stream with balancing anions.

FIG. 10 shows an example of an embodiment in which an organic liquid is employed as the lithium selective agent. The optional pretreatment of a preliminary aqueous lithium source stream (e.g., brine) for the removal of alkaline earth metals proceeds as in FIGS. 3A-3B. The alkaline earth metal free brine now is brought into contact with a second liquid phase (organic phase) that has extractant (and optionally co-extractants) dissolved. The extractant is selective to lithium ions and extracts them from the aqueous phase. This can occur over a single step or multiple steps in mixer-settler units or other similar mass transfer units. The aqueous phase leaves the last step almost free of lithium ions and enters the first electrolysis assembly to yield an acid stream and an alkali metal base stream free of lithium, which goes into the contactor. The organic phase, now rich in lithium, leaves the last step and is brought in contact with the acid stream leaving the first electrolysis assembly to strip the lithium from the organic extractant. The protonated organic phase is then contacted with a portion of the base stream exiting the first electrolysis assembly, resulting in the neutralization of the base to its corresponding salt solution, which is fed into the first electrolyzer. As for the stripping solution, it now contains the lithium salt released from the extractant and the excess acid. This stream is neutralized by a portion of the lithium hydroxide base stream leaving the second electrolysis assembly, and is fed into the second electrolyzer to be electrolyzed into an acid stream and a lithium hydroxide base stream.

FIG. 11 shows an example of an embodiment in which aluminum hydroxide is employed as a lithium selective agent comprising a solid sorbent. The optional pretreatment of the preliminary aqueous lithium source stream (e.g., brine) for the removal of alkaline earth metals proceeds as before. The alkaline earth metal free brine now is brought into contact with aluminum chloride and a slipstream of the lithium-free hydroxide base stream generated at the cathode of the first electrolysis assembly. The aluminum chloride reacts with the hydroxide to form an insoluble aluminum hydroxide which has a high affinity to lithium. Thus, at least some (e.g., most or all) soluble lithium chloride is physisorbed/chemisorbed by the aluminum hydroxide to form the lithium-rich phase (a lithium-adsorbed solid material), resulting in a lithium-free brine and a lithium-rich solid phase.

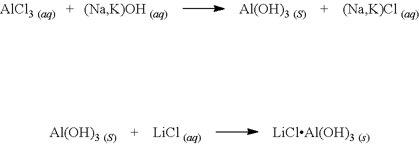

The lithium-aluminum hydroxide complex is filtered. The soluble brine filtrate is fed into the electrolysis assembly. The residue solid phase is contacted with hot water (e.g., >80° C.), which dissolves the sorbed lithium chloride. The solution is filtered and the soluble lithium chloride is fed into the second electrolysis assembly to generate the lithium hydroxide product at the cathode. The aluminum hydroxide residue is dissolved in the hydrochloric acid stream generated by the first electrolysis assembly (or optionally the second) to form soluble aluminum chloride.

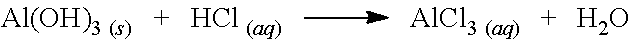

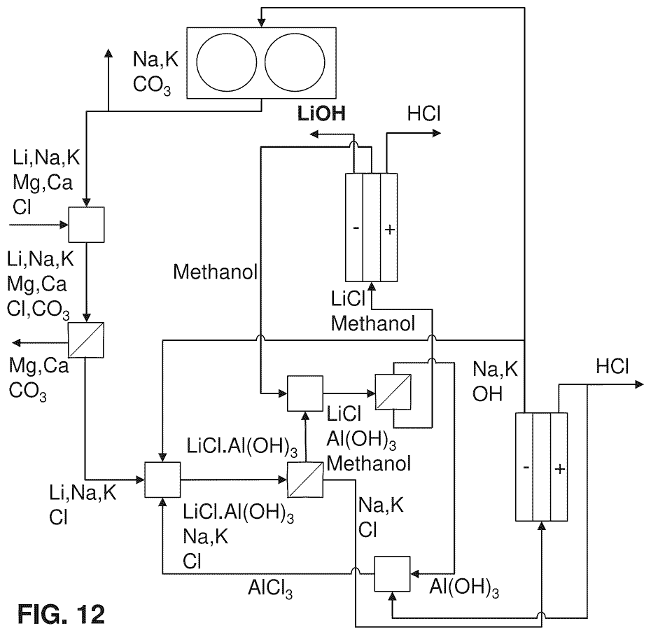

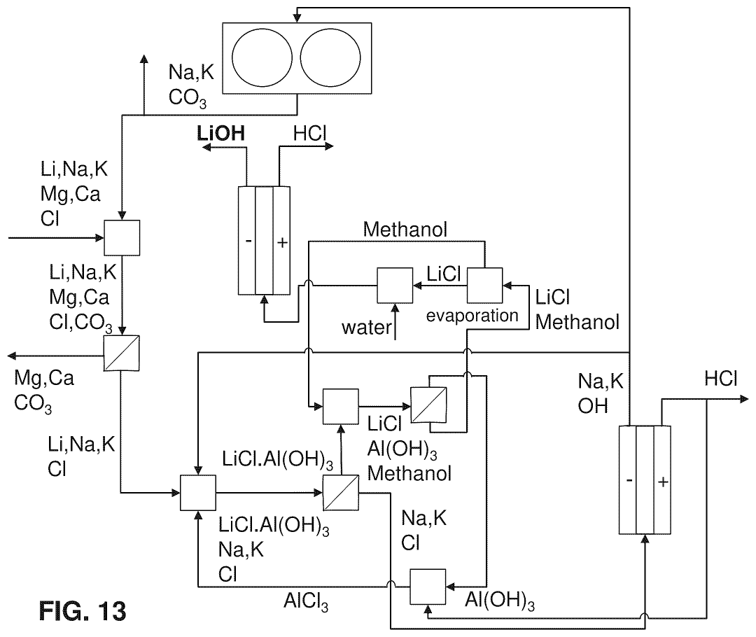

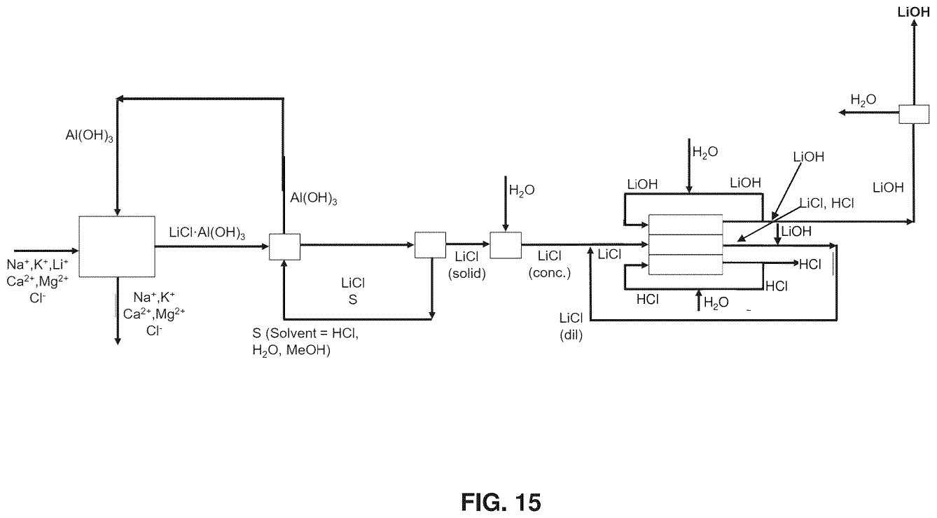

FIGS. 12-13 shows examples of variations of the embodiment in FIG. 11 but where methanol is used as the solvent to dissolve LiCl from the LiCl·AI(OH)₃ complex. Here, the filtration proceeds as before, and the solid aluminum hydroxide is dissolved in hydrochloric acid to produce soluble aluminum chloride. Meanwhile, the methanol solution of lithium chloride is either fed into the second electrolysis assembly for the electrolysis of the salt with partial or complete depletion (FIG. 12), or is evaporated for the recovery of methanol which is then recycled and solid lithium chloride which is dissolved in water and fed into the second electrolysis assembly (FIG. 13). FIG. 15 shows an example of an embodiment involving the configuration shown in FIG. 14A. In this example, Al(OH)₃ is first used to treat a preliminary aqueous lithium stream comprising sodium, potassium, lithium, calcium, and magnesium cations and chloride anions, thereby selectively adsorbing lithium to form LiCl·Al(OH)₃ as a lithium-rich phase in a lithium-enriched output. Aqueous lithium chloride is then formed by exposing the LiCl·Al(OH)₃ to a solvent such as water, HCl, and/or an alcohol such as methanol. This also regenerates the Al(OH)₃, which can either be directly recycled back to the beginning of the process or used for one or more additional processes (not shown). The aqueous LiCl may then be converted to solid LiCl (e.g., by evaporation, regenerating the solvent). The LiCl may then be dissolved (e.g., in water) to form an aqueous lithium source stream comprising dissolved LiCl in water. The aqueous LiCl may then be fed to the electrolysis assembly (e.g., in a middle compartment of a three-compartment cell). Following the example scheme described in more detail in FIG. 14A, electrolysis in the electrolysis assembly may result in the electrogenerated of aqueous LiOH as a base-rich product solution (e.g., via a hydrogen evolution reaction) output from the catholyte compartment, diluted aqueous LiCl output from the electrolyte (middle) compartment, and aqueous HCl as an acid-rich product solution (e.g., via a hydrogen oxidation reaction at a hydrogen depolarization anode) output from the anolyte compartment. The LiOH stream may be split, with a portion concentrated to form concentrated LiOH, another portion recirculated back to enter the catholyte compartment (with a dilution stream in the form of water added for dilution), and a third portion combined with the dilute LiCl output from the electrolyte (middle) compartment and recirculated as dilute LiCl back to the aqueous electrolysis input of LiCl. Meanwhile, the aqueous HCl stream may be recirculated back to the anolyte input (with a dilution stream in the form of water added for dilution).

As used herein, two elements are in fluidic communication with each other (or, equivalently, in fluid communication with each other) when fluid may be transported from one of the elements to the other of the elements without otherwise altering the configurations of the elements or a configuration of an element between them (such as a valve). Two conduits connected by an open valve (thus allowing for the flow of fluid between the two conduits) are considered to be in fluidic communication with each other. In contrast, two conduits separated by a closed valve (thus preventing the flow of fluid between the conduits) are not considered to be in fluidic communication with each other.

As used herein, two elements are fluidically connected to each other when they are connected such that, under at least one configuration of the elements and any intervening elements, the two elements are in fluidic communication with each other. Two components connected by a valve and conduits that permit flow between the components in at least one configuration of the valve would be said to be fluidically connected to each other. To further illustrate, two components that are connected by a valve and conduits that permit flow between the components in a first valve configuration but not a second valve configuration are considered to be fluidically connected to each other both when the valve is in the first configuration and when the valve is in the second configuration. In contrast, two components that are not connected to each other (e.g., by a valve, another conduit, or another component) in a way that would permit fluid to be transported between them under any configuration would not be said to be fluidically connected to each other. Elements that are in fluidic communication with each other are always fluidically connected to each other, but not all elements that are fluidically connected to each other are necessarily in fluidic communication with each other.

Various components are described herein as being fluidically connected. Fluidic connections may be either direct fluidic connections or indirect fluidic connections. Generally, a direct fluidic connection exists between a first region and a second region (and the two regions are said to be directly fluidically connected to each other) when they are fluidically connected to each other and when the composition of the fluid at the second region of the fluidic connection has not substantially changed relative to the composition of the fluid at the first region of the fluidic connection (i.e., no fluid component that was present in the first region of the fluidic connection is present in a weight percentage in the second region of the fluidic connection that is more than 5% different from the weight percentage of that component in the first region of the fluidic connection). As an illustrative example, a stream that connects first and second unit operations, and in which the pressure and temperature of the fluid is adjusted but the composition of the fluid is not altered, would be said to directly fluidically connect the first and second unit operations. If, on the other hand, a separation step is performed and/or a chemical reaction is performed that substantially alters the composition of the stream contents during passage from the first component to the second component, the stream would not be said to directly fluidically connect the first and second unit operations. In some embodiments, a direct fluidic connection between a first region and a second region can be configured such that the fluid does not undergo a phase change from the first region to the second region. In some embodiments, the direct fluidic connection can be configured such that at least 50 wt % (or at least 75 wt %, at least 90 wt %, at least 95 wt %, or at least 98 wt %) of the fluid (e.g., liquid) in the first region is transported to the second region via the direct fluidic connection. Any of the fluidic connections described herein may be, in some embodiments, direct fluidic connections. In other cases, the fluidic connections may be indirect fluidic connections.

U.S. Provisional Patent Application No. 63/687,669, filed Aug. 27, 2024, and entitled “Lithium Production Coupled to Acid and Base Production,” is incorporated herein by reference in its entirety for all purposes.

The following examples are intended to illustrate certain embodiments of the present invention, but do not exemplify the full scope of the invention.

### Example 1

This Example describes operation of an electrolytic cell using aqueous electrolysis input streams described in this disclosure to produce base-rich product solutions comprising electrogenerated basic species and lithium cations, as well as acid-rich product solutions usable in various of the embodiments for obtaining lithium-containing materials discussed in this disclosure. Specifically, a three-compartment electrolytic cell was employed to treat a lithium chloride input solution sent to the electrolyte (middle) chamber.

The electrolytic cell had the configuration shown in FIG. 2C, employing a platinum-coated Ni mesh cathode, a platinum/carbon gas diffusion anode, and three liquid chambers. The catholyte chamber and the middle electrolyte “brine” chamber were separated by a Nafion™M sulfonated tetrafluoroethylene based fluoropolymer-copolymer cation exchange membrane. The anolyte chamber and middle electrolyte “brine” chamber were separated by a commercially-available hydrocarbon-based anion exchange membrane. The catholyte was an aqueous solution of 16 wt % dissolved LiOH. The “brine” solution fed to the middle electrolyte chamber was an aqueous solution of 20 wt % dissolved LiCl. The anolyte was an aqueous solution of 20 wt % dissolved LiCl. The electrolytic cell was operated at 100 mA/cm² current density with a voltage of 1.61 V, which is corresponded to 0.09 g/br of LiOH production per cm² of electrode area at an energy consumption of 1.8 MWh/ton_{LiOH}. The experimentally observed production rate and energy efficiency indicated that the embodiments discussed in this disclosure could perform efficient and cost effective lithium hydroxide and, ultimately lithium carbonate production using electrolytically generated basic species and acidic species.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

As used herein in the specification and in the claims, the phrases “at least a portion” and “at least some” mean some or all. “At least a portion” or “at least some” may mean, in accordance with certain embodiments, at least 1 wt %, at least 2 wt %, at least 5 wt %, at least 10 wt %, at least 25 wt %, at least 50 wt %, at least 75 wt %, at least 90 wt %, at least 95 wt %, or at least 99 wt %, and/or, in certain embodiments, up to 100 wt %. The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless clearly indicated to the contrary, concentrations and percentages described herein are on a mass basis.

As used herein, “wt %” is an abbreviation of weight percentage. As used herein, “at %” is an abbreviation of atomic percentage. As used herein, “mol %” is an abbreviation of mole percentage. As used herein, “vol %” is an abbreviation of volume percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for obtaining a lithium-containing material, comprising:
exposing at least some lithium cations from an aqueous lithium source stream to a lithium selective agent to generate a lithium-enrichment output comprising a lithium-rich phase comprising at least some of the lithium cations, wherein the aqueous lithium source stream comprises dissolved lithium cations, dissolved non-lithium metal cations, and dissolved anions;
removing at least some of the lithium-rich phase from the lithium-enrichment output to produce a lithium depleted stream;
transporting an aqueous electrolysis input stream to an electrolytic cell, the aqueous electrolysis input stream comprising at least some of the dissolved non-lithium metal cations and at least some of the dissolved anions from the aqueous lithium source stream;
applying an electrical potential difference across the electrolytic cell and performing one or more reactions to produce:
a base-rich product solution comprising electrogenerated basic species and at least some of the non-lithium metal cations; and
an acid-rich product solution comprising electrogenerated acidic species and at least some of the anions; and
exposing at least some of the electrogenerated basic species from the base-rich product solution to carbon dioxide from an input gas stream to generate:
a carbon dioxide-lean output gas stream having a lower concentration of carbon dioxide than the input gas stream; and
a capture stream comprising:
at least some of the non-lithium metal cations, and
dissolved carbonate anions and/or dissolved bicarbonate anions formed from the dissolved carbon dioxide.

2. A method for obtaining a lithium-containing material, comprising:
exposing at least some lithium cations from an aqueous lithium source stream to a lithium selective agent to generate a lithium-enrichment output comprising a lithium-rich phase comprising at least some of the lithium cations, wherein the aqueous lithium source stream comprises dissolved lithium cations, dissolved non-lithium metal cations, and dissolved anions;
removing at least some of the lithium-rich phase from the lithium-enrichment output to produce a lithium depleted stream; and
performing one or more reactions with the removed lithium-rich phase to produce (a) dissolved lithium cations and (b) regenerated lithium selective agent, wherein at least some of the lithium selective agent used to generate the lithium-enrichment stream is regenerated lithium selective agent.

3. A method for obtaining a lithium-containing material, comprising:
transporting an aqueous electrolysis input stream to an electrolytic cell, the aqueous electrolysis input stream comprising at least a portion of an aqueous lithium source stream comprising lithium cations and non-hydroxide anions; and
applying an electrical potential difference across the electrolytic cell and performing one or more reactions to produce:
a base-rich product solution comprising electrogenerated basic species and at least some of the lithium cations from the aqueous lithium source stream; and
an acid-rich product solution produced by a hydrogen oxidation half-reaction, the acid-rich product solution comprising electrogenerated acidic species and at least some of the non-hydroxide anions from the aqueous lithium source stream.

4. The method of claim 1, wherein the lithium selective agent comprises a lithium solid-forming agent, wherein the lithium-enrichment output comprises a lithium-rich solids-containing stream comprising the lithium-rich phase, and wherein the lithium-rich phase comprises a lithium-rich solid material comprising at least some of the lithium cations.

5. The method of claim 4, wherein the lithium solid-forming agent comprises phosphoric acid and/or a phosphate, and wherein the lithium-rich solid material comprises Li₃PO₄.

6. The method of claim 4, wherein the lithium solid-forming agent comprises solid sorbent, and wherein the lithium-rich solid material comprises a lithium-adsorbed solid sorbent.

7. The method of claim 6, the solid sorbent comprises aluminum hydroxide.

8. The method of claim 1, wherein the lithium selective agent comprises an organic liquid, wherein the lithium-enrichment output comprises:
an extract stream comprising the lithium-rich phase, where the lithium-rich phase comprises at least some of the organic liquid, at least some of the lithium cations, and at least some of the anions; and
a lithium depleted stream comprising at least some of the non-lithium metal cations and at least some of the anions.

9. The method of claim 1, wherein the aqueous electrolysis input stream and the base-rich product solution each comprises at least some of the lithium cations from the aqueous lithium source stream, and wherein the exposing the at least some lithium cations from an aqueous lithium source stream to the lithium selective agent comprises exposing at least a portion of the base-rich product solution to the lithium selective agent.

10. The method of claim 1, wherein the exposing at least some of the electrogenerated basic species from the base-rich product solution to the carbon dioxide comprises exposing at least a portion of the lithium depleted stream to the carbon dioxide.

11. The method of claim 1, wherein the aqueous electrolysis input stream comprises at least a portion of the lithium depleted stream.

12. The method of claim 1, further comprising performing one or more reactions with the lithium-rich phase to produce (a) dissolved lithium cations and (b) regenerated lithium selective agent.

13. The method of claim 1, further comprising generating lithium hydroxide comprising at least some of the lithium cations from the removed lithium-rich phase.

14. The method of claim 13, further comprising exposing at least a portion of the lithium hydroxide to carbon dioxide and/or carbonate anions to form lithium carbonate comprising at least some of the lithium cations from the lithium hydroxide.

15. The method of claim 1, wherein the dissolved anions comprise halide ions, oxyanions, and/or conjugate bases of organic acids.

16. The method of claim 1, wherein the dissolved anions comprise conjugate bases of weak acids.

17. The method of claim 1, wherein the dissolved anions comprise halide ions, sulfate ions, nitrate ions, and/or phosphate ions.

18. The method of claim 1, wherein the dissolved anions comprise chloride ions.

19. The method of claim 1, wherein the dissolved anions comprise phosphate ions.

20. The method of claim 19, wherein the phosphate ions comprise orthophosphate ions (PO₄³⁻), monohydrogen phosphate ions (HPO₄²⁻), and/or dihydrogen phosphate ions (H₂PO₄⁻).

21. The method of claim 1, wherein the acidic species comprises hydronium ions.

22. The method of claim 1, wherein the acidic species comprises acetic acid.

23. The method of claim 1, wherein the acidic species comprises benzoic acid.

24. The method of claim 1, wherein the acidic species comprises formic acid.

25. The method of claim 1, wherein the acidic species comprises phosphoric acid (H₃PO₄).

26. The method of claim 1, wherein the acidic species comprises dihydrogen phosphate ions (H₂PO₄⁻).

27. The method of claim 1, wherein the acidic species comprises boric acid (H₃BO₃).

28. The method of claim 1, wherein the electrolytic cell is a first electrolytic cell, the aqueous electrolysis input stream is a first aqueous electrolysis input stream, the base-rich product solution is a first base-rich product solution, and the method further comprises:
transporting a second aqueous electrolysis input stream to a second electrolytic cell, the second aqueous electrolysis input stream comprising at least some of the lithium cations from the removed lithium-rich phase; and
applying an electrical potential difference across the second electrolytic cell and performing one or more reactions to produce a second base-rich product solution comprising dissolved lithium cations and dissolved hydroxide anions.

29. The method of claim 28, wherein the acid-rich product solution is a first acid-rich product solution, and the applying the electrical potential difference across the second electrolytic cell and performing the one or more reactions produces a second acid-rich product solution comprising regenerated lithium selective agent.

30. The method of claim 1, wherein the method further comprises exposing a preliminary aqueous lithium source stream to a metal cation impurity salt precipitation stream to produce a metal cation impurity solids-containing stream comprising a solid salt comprising at least some of the metal cation impurities, and removing at least some of the solid salt comprising at least some of the metal cation impurities from the metal cation impurity solids-containing stream to produce a metal cation impurity-lean liquid stream, wherein the aqueous lithium source stream comprises at least a portion of the metal cation impurity-lean liquid stream.

31. The method of any one of claim 30, wherein the metal cation impurity salt precipitation stream comprises at least a portion of the capture stream.

32. The method of claim 30, wherein at least some of the metal cation impurities are alkaline earth metal cations.

33. The method of claim 1, wherein at least some of the non-lithium metal cations comprise non-lithium alkali metal cations.

34. The method of claim 1, wherein the electrolytic cell comprises a catholyte chamber and an anolyte chamber separated by at least one ion-selective membrane.

35. The method of claim 34, wherein the at least one ion-selective membrane comprises a cation-selective membrane, and wherein the aqueous electrolysis input stream is transported to the anolyte chamber.

36. The method of claim 34, wherein the at least one ion-selective membrane comprises an anion-selective membrane, and wherein the aqueous electrolysis input stream is transported to the catholyte chamber.

37. The method of claim 34, wherein the electrolytic cell further comprises an electrolyte chamber separated from the catholyte chamber by a cation selective membrane and separated from the anolyte chamber by an anion exchange membrane, and wherein the aqueous input stream is transported to the electrolyte chamber.

38. The method of claim 34, wherein the performing the one or more reactions comprises performing the hydrogen oxidation reaction in the anolyte chamber and performing the hydrogen evolution reaction in the catholyte chamber.

39. The method of claim 34, wherein the performing the one or more reactions comprises performing the hydrogen oxidation reaction in the anolyte chamber and performing the oxygen reduction reaction in the catholyte chamber.

40. The method of claim 34, the performing the one or more reactions comprises performing the oxygen evolution reaction in the anolyte chamber and performing the oxygen reduction reaction in the catholyte chamber.

41. The method of claim 1, wherein the acid-rich product solution is produced by a hydrogen oxidation reaction.

42. The method of claim 1, wherein the base-rich product solution is produced by a hydrogen evolution reaction.

43. The method of claim 1, wherein the method comprises dissolving a solid lithium salt comprising lithium cations and non-hydroxide anions to form at least a portion of the aqueous lithium source stream.

44. The method of claim 3, wherein at least a portion of the acid-rich product solution is recirculated back to the electrolytic cell.

45. The method of claim 3, further comprising exposing at least a portion of the base-rich product solution to carbon dioxide and/or carbonate anions to form lithium carbonate comprising at least some of the lithium cations from the base-rich product solution.

46. The method of claim 3, further combining at least a portion of the base-rich product solution with a dilution stream, thereby forming a diluted base-rich product solution, wherein the aqueous input stream comprises at least a portion of the diluted base-rich product solution.

47. The method of claim 1, wherein the electrolytic cell is operated as an electrodialysis cell.

48. The method of claim 1, wherein the electrolytic cell comprises a bipolar membrane.

49. (canceled)

50. A system for obtaining a lithium-containing material, the system comprising an electrolysis assembly, the electrolysis assembly comprising:
an electrolytic cell comprising an anode and a cathode;
one or more electrolysis assembly liquid inlets configured to supply dissolved ions to the anode and/or the cathode;
a first electrolysis assembly liquid outlet; and
a second electrolysis assembly liquid outlet;
wherein:
the anode comprises a hydrogen depolarization anode; and
the one or more electrolysis assembly liquid inlets is fluidically connected to a source of an aqueous lithium source stream.
